(19) United States
(12) Patent Application Publication
(10) Pub. No.: US 2013/0256595 A1
(43) Pub. Date: Oct. 3, 2013

(54) LIQUID CRYSTAL COMPOSITION, LIQUID CRYSTAL ELEMENT, AND LIQUID CRYSTAL DISPLAY DEVICE

(71) Applicant: SEMICONDUCTOR ENERGY LABORATORY CO., LTD., (US)

(72) Inventors: Makoto IKENAGA, Atsugi (JP); Daisuke Kubota, Isehara (JP); Takahiro Yamamoto, Tokyo (JP)

(73) Assignee: SEMICONDUCTOR ENERGY LABORATORY CO., LTD., Atsugi-shi (JP)

(21) Appl. No.: 13/832,532

(22) Filed: Mar. 15, 2013

(30) Foreign Application Priority Data
Mar. 30, 2012 (JP) 2012-081529
Mar. 30, 2012 (JP) 2012-081601

(51) Int. Cl. C09K 19/54

(52) U.S. Cl. CPC C09K 19/54
USPC 252/299.5; 560/73

(57) ABSTRACT

A novel polymerizable monomer is provided. A novel liquid crystal composition which can be used in a variety of liquid crystal devices is provided using the polymerizable monomer. The use of the novel liquid crystal composition makes it possible to reduce driving voltage of a liquid crystal element and to reduce power consumption of a liquid crystal display device. A polymerizable monomer represented by General Formula (G1) is provided. A liquid crystal composition which includes a polymerizable monomer represented by General Formula (H1), a nematic liquid crystal, and a chiral material is also provided. In General Formulae (G1) and (H1), n and m are individually an integer from 1 to 20, and R¹ and R² individually represent hydrogen or a methyl group. In General Formulae (G1), k is 2 or 3.

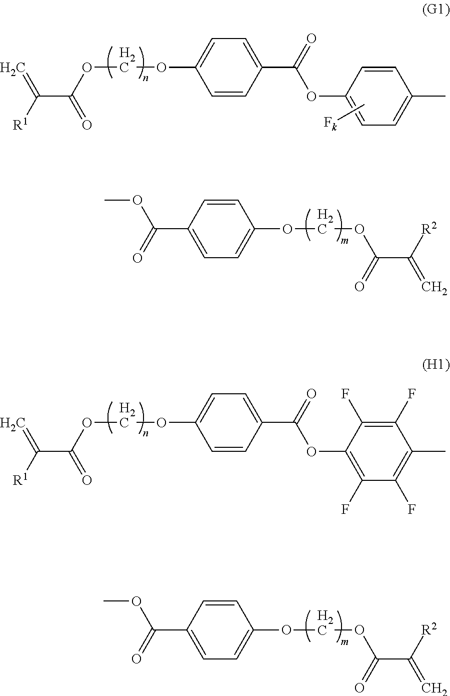

### BACKGROUND OF THE INVENTION

1. Field of the Invention

The present invention relates to a liquid crystal composition, a liquid crystal element, and a liquid crystal display device, and manufacturing methods thereof.

2. Description of the Related Art

In recent years, liquid crystal has been applied to a variety of devices; in particular, a liquid crystal display device (liquid crystal display) having features of thinness and lightness has been used for displays in a wide range of fields.

For a larger and higher-resolution display screen, shorter response time of liquid crystal has been required, and development thereof has been advanced (see, for example, Patent Document 1).

As a display mode of liquid crystal capable of high-speed response, a display mode using liquid crystal exhibiting a blue phase is given. The mode using liquid crystal exhibiting a blue phase achieves high-speed response, does not require an alignment film, and achieves a wide viewing angle, and thus has been developed more actively for practical use (see, for example, Patent Document 2).

### REFERENCE

[Patent Document 1] Japanese Published Patent Application No. 2008-303381
[Patent Document 2] PCT International Publication No. 2005-090520

### SUMMARY OF THE INVENTION

An object is to provide a novel liquid crystal composition that can be used for a variety of liquid crystal devices.

Another object is to achieve a reduction in driving voltage of a liquid crystal element and a reduction in power consumption of a liquid crystal display device with the use of the novel liquid crystal composition.

One embodiment of the present invention provides a polymerizable monomer represented by General Formula (G1).

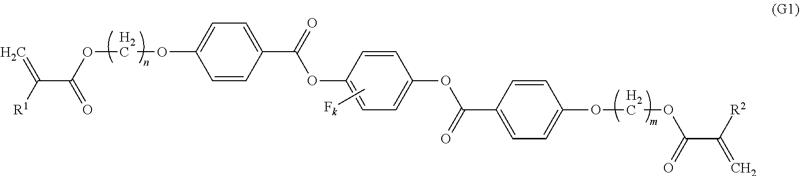

In General Formula (G1), k is 2 or 3, n and m are individually an integer from 1 to 20 (or 2 to 20), and R¹ and R² individually represent hydrogen or a methyl group.

One embodiment of the present invention provides a polymerizable monomer represented by General Formula (G2).

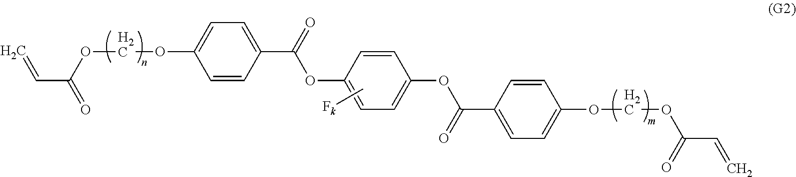

In General Formula (G2), k is 2 or 3, and n and m are individually an integer from 1 to 20.

One embodiment of the present invention provides a polymerizable monomer represented by General Formula (G3).

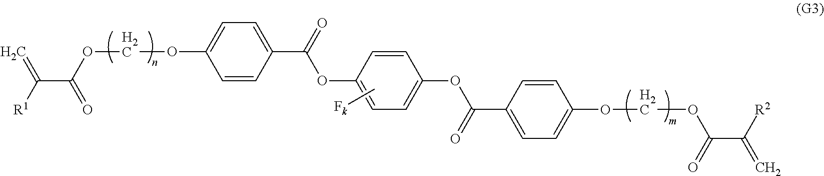

In General Formula (G3), k is 2 or 3, n and m are individually an integer from 1 to 20, n=m, and R¹ and R² individually represent hydrogen or a methyl group.

One embodiment of the present invention provides a polymerizable monomer represented by General Formula (G4).

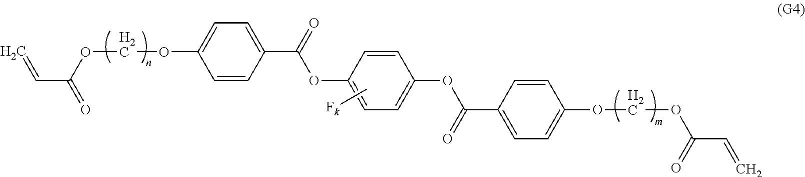

In General Formula (G4), k is 2 or 3, n and m are individually an integer from 1 to 20, and n=m.

One embodiment of the present invention provides a polymerizable monomer represented by General Formula (G11).

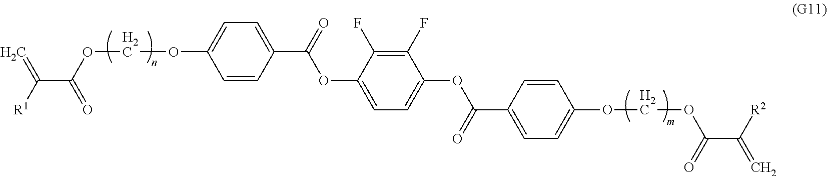

In General Formula (G11), n and m are individually an integer from 1 to 20, and R¹ and R² individually represent hydrogen or a methyl group.

One embodiment of the present invention provides a polymerizable monomer represented by General Formula (G12).

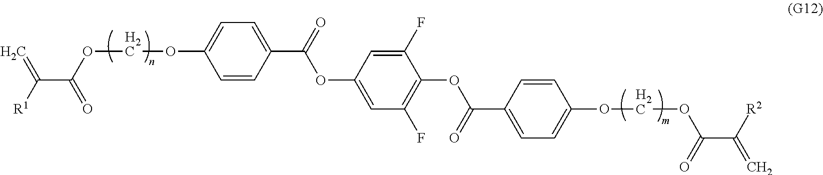

In General Formula (G12), n and m are individually an integer from 1 to 20, and R¹ and R² individually represent hydrogen or a methyl group.

One embodiment of the present invention provides a polymerizable monomer represented by General Formula (G13).

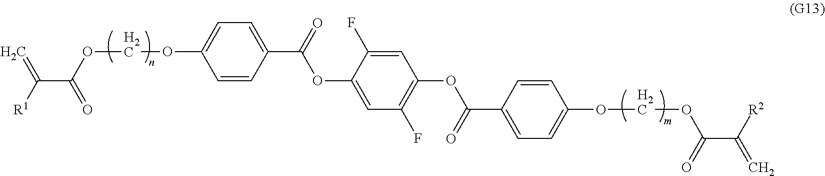

In General Formula (G13), n and m are individually an integer from 1 to 20, and R¹ and R² individually represent hydrogen or a methyl group.

One embodiment of the present invention provides a polymerizable monomer represented by General Formula (G14).

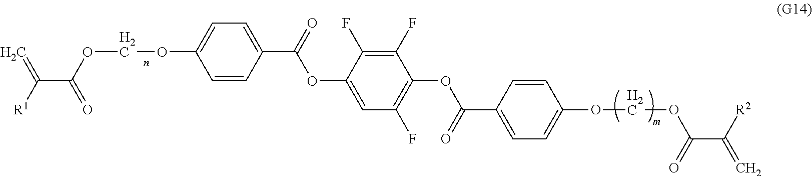

In General Formula (G 14), n and m are individually an integer from 1 to 20, and R¹ and R² individually represent hydrogen or a methyl group.

One embodiment of the present invention provides a polymerizable monomer represented by General Formula (G21).

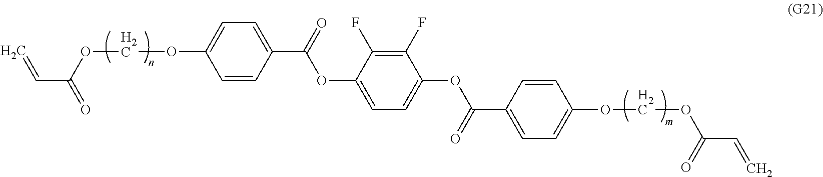

In General Formula (G21), and n and m are individually an integer from 1 to 20.

One embodiment of the present invention provides a polymerizable monomer represented by General Formula (G22).

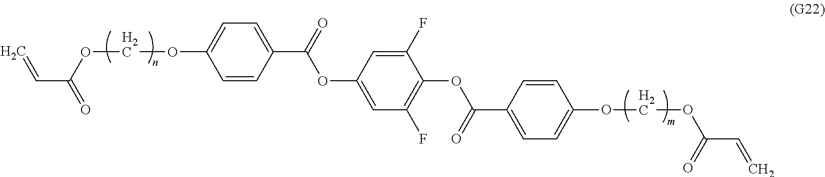

In General Formula (G22), and n and m are individually an integer from 1 to 20.

One embodiment of the present invention provides a polymerizable monomer represented by General Formula (G23).

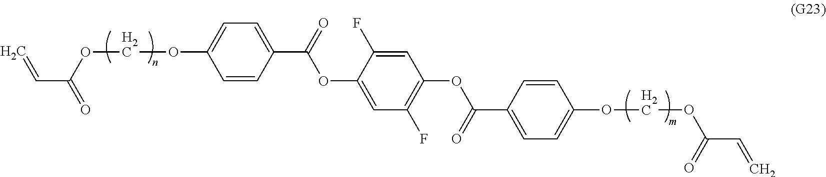

In General Formula (G23), and n and m are individually an integer from 1 to 20.

One embodiment of the present invention provides a polymerizable monomer represented by General Formula (G24).

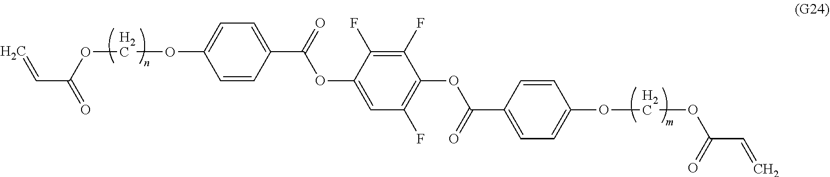

In General Formula (G24), n and m are individually an integer from 1 to 20.

One embodiment of the present invention provides a polymerizable monomer represented by General Formula (G31).

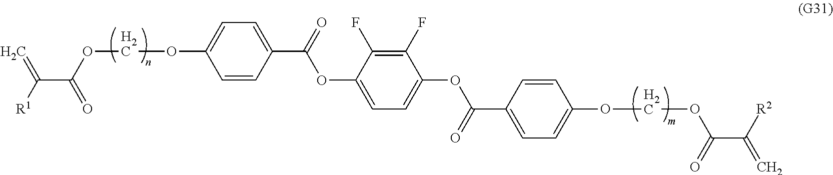

In General Formula (G31), n and m are individually an integer from 1 to 20, n=m, and R¹ and R² individually represent hydrogen or a methyl group.

One embodiment of the present invention provides a polymerizable monomer represented by General Formula (G32).

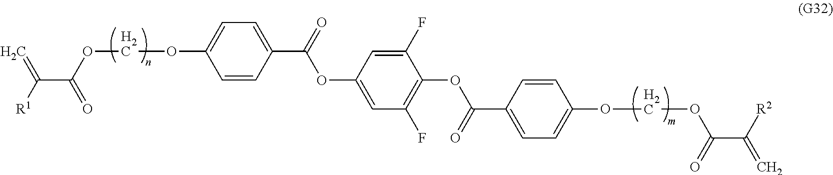

In General Formula (G32), n and m are individually an integer from 1 to 20, n=m, and R¹ and R² individually represent hydrogen or a methyl group.

One embodiment of the present invention provides a polymerizable monomer represented by General Formula (G33).

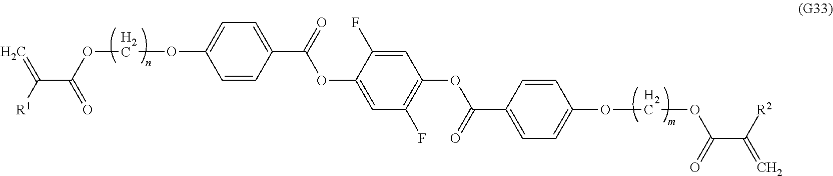

In General Formula (G33), n and m are individually an integer from 1 to 20, n=m, and R¹ and R² individually represent hydrogen or a methyl group.

One embodiment of the present invention provides a polymerizable monomer represented by General Formula (G34).

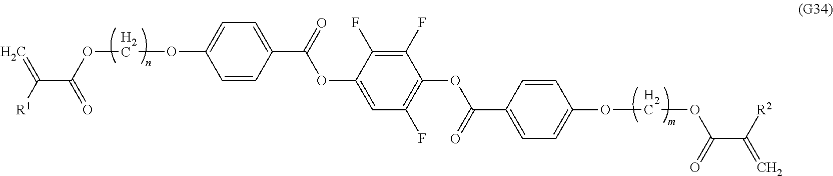

In General Formula (G34), n and m are individually an integer from 1 to 20, n=m, and R¹ and R² individually represent hydrogen or a methyl group.

One embodiment of the present invention provides a polymerizable monomer represented by General Formula (G41).

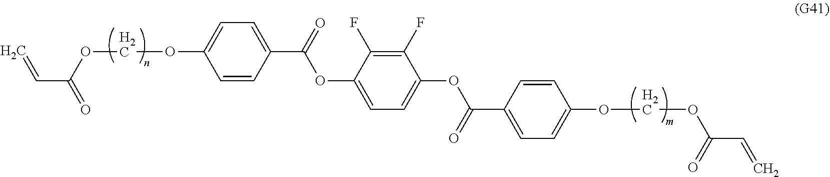

In General Formula (G41), n and m are individually an integer from 1 to 20, and n=m.

One embodiment of the present invention provides a polymerizable monomer represented by General Formula (G42).

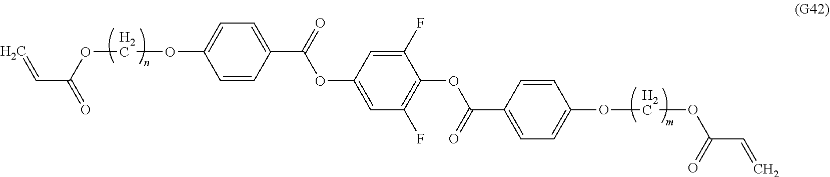

In General Formula (G42), n and m are individually an integer from 1 to 20, and n=m.

One embodiment of the present invention provides a polymerizable monomer represented by General Formula (G43).

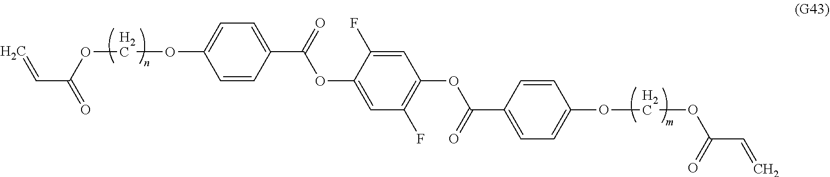

In General Formula (G43), n and m are individually an integer from 1 to 20, and n=m.

One embodiment of the present invention provides a polymerizable monomer represented by General Formula (G44).

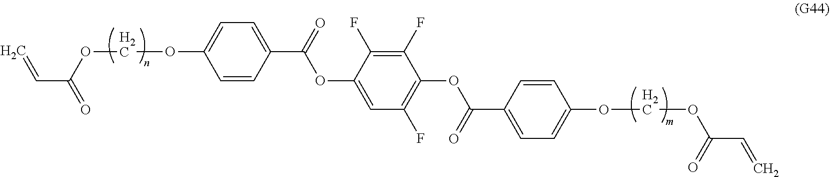

In General Formula (G44), n and m are individually an integer from 1 to 20, and n=m.

One embodiment of the present invention provides a liquid crystal composition including any of the above polymerizable monomers, a nematic liquid crystal, and a chiral material.

One embodiment of the present invention provides a liquid crystal composition including a polymerizable monomer represented by General Formula (H1), a nematic liquid crystal, and a chiral material.

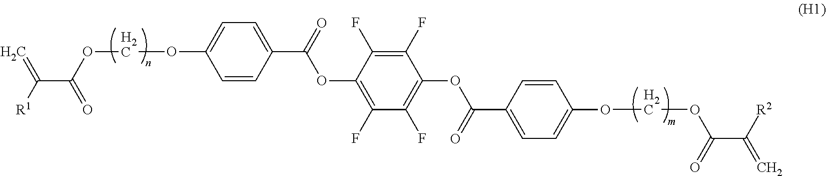

In General Formula (H1), n and m are individually an integer from 1 to 20 (or 2 to 20), and R¹ and R² individually represent hydrogen or a methyl group.

One embodiment of the present invention provides a liquid crystal composition including a polymerizable monomer represented by General Formula (H2), a nematic liquid crystal, and a chiral material.

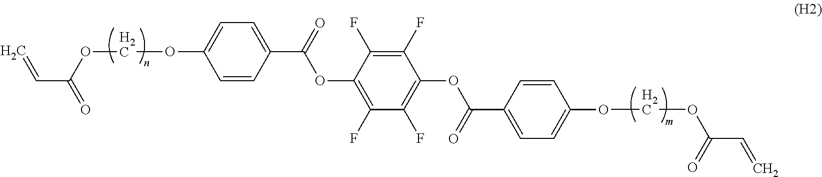

In General Formula (H2), n and m are individually an integer from 1 to 20.

One embodiment of the present invention provides a liquid crystal composition including a polymerizable monomer represented by General Formula (H3), a nematic liquid crystal, and a chiral material.

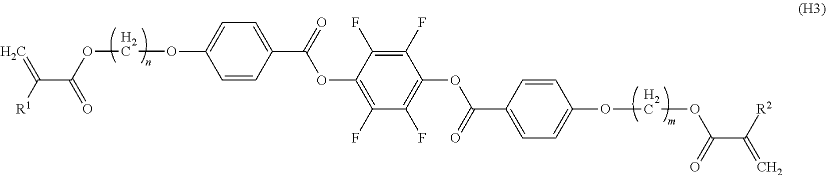

In General Formula (H3), n and m are individually an integer from 1 to 20, n=m, and R¹ and R² individually represent hydrogen or a methyl group.

One embodiment of the present invention provides a liquid crystal composition including a polymerizable monomer represented by General Formula (H4), a nematic liquid crystal, and a chiral material.

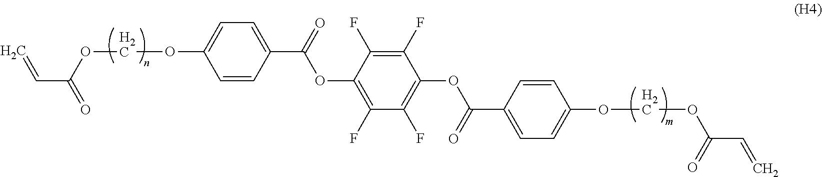

In General Formula (H4), n and m are individually an integer from 1 to 20, and n=m.

One embodiment of the present invention provides a liquid crystal composition exhibiting a blue phase as any of the above liquid crystal compositions.

One embodiment of the present invention provides a liquid crystal element, a liquid crystal display device, or an electronic appliance in which any of the above liquid crystal compositions is used.

In one embodiment of the present invention, the novel polymerizable monomer represented by General Formula (G1) can be provided as a polymerizable monomer.

In one embodiment of the present invention, a novel liquid crystal composition which includes the polymerizable monomer represented by General Formula (G1) as a polymerizable monomer, a nematic liquid crystal, and a chiral material can be provided.

In one embodiment of the present invention, a novel liquid crystal composition which includes the polymerizable monomer represented by General Formula (G1) as a polymerizable monomer, a nematic liquid crystal, and a chiral material and exhibits a blue phase can be provided.

In one embodiment of the present invention, a novel liquid crystal composition which includes the polymerizable monomer represented by General Formula (H1) as a polymerizable monomer, a nematic liquid crystal, and a chiral material can be provided.

In one embodiment of the present invention, a novel liquid crystal composition which includes the polymerizable monomer represented by General Formula (H1) as a polymerizable monomer, a nematic liquid crystal, and a chiral material and exhibits a blue phase can be provided.

In one embodiment of the present invention, a liquid crystal element, a liquid crystal display device, or an electronic appliance with lower driving voltage and lower power consumption can be provided with the use of any of the liquid crystal compositions.

### BRIEF DESCRIPTION OF THE DRAWINGS

FIGS. 1A and 1B are conceptual views illustrating liquid crystal compositions.

FIGS. 2A and 2B illustrate one embodiment of a liquid crystal display device.

FIGS. 3A to 3D each illustrate one embodiment of an electrode structure of a liquid crystal display device.

FIGS. 4A1, 4A2, and 4B illustrate liquid crystal display modules.

FIGS. 5A to 5F illustrate electronic appliances.

FIG. 6 shows the relation between applied voltage and transmittance of Liquid Crystal Elements 1 to 5 and Comparative Liquid Crystal Element 1.

FIGS. 7A to 7C are ¹H NMR charts of o2F-RM257-O3.

FIG. 8 shows an absorption spectrum of o2F-RM257-O3.

FIGS. 9A to 9C are ¹H NMR charts of o2F-RM257-O6.

FIG. 10 shows an absorption spectrum of o2F-RM257-O6.

FIGS. 11A to 11C are ¹H NMR charts of p2F-RM257-O3.

FIG. 12 shows an absorption spectrum of p2F-RM257-O3.

FIGS. 13A to 13C are ¹H NMR charts of p2F-RM257-O6.

FIG. 14 shows an absorption spectrum of p2F-RM257-O6.

FIGS. 15A to 15C are ¹H NMR charts of p2F-RM257-O8.

FIG. 16 shows an absorption spectrum of p2F-RM257-O8.

FIG. 17 shows the relation between applied voltage and transmittance of Liquid Crystal Elements 6 and 7 and Comparative Liquid Crystal Element 2.

FIGS. 18A to 18C are ¹H NMR charts of 4F-RM257-O3.

FIG. 19 shows an absorption spectrum of 4F-RM257-O3.

FIGS. 20A to 20C are ¹H NMR charts of 4F-RM257-O6.

FIG. 21 shows an absorption spectrum of 4F-RM257-O6.

FIGS. 22A to 22C are ¹H NMR charts of 4F-RM257-O10.

FIG. 23 shows an absorption spectrum of 4F-RM257-O10.

FIGS. 24A to 24C are ¹H NMR charts of 4F-RM257-O12.

FIG. 25 shows an absorption spectrum of 4F-RM257-O12.

FIG. 26 shows the relation between applied voltage and transmittance of Liquid Crystal Element 8.

### DETAILED DESCRIPTION OF THE INVENTION

Embodiment will be described in detail with reference to the accompanying drawings. Note that the present invention is not limited to the following description, and it will be easily understood by those skilled in the art that modes and details can be modified in various ways without departing from the spirit and scope of the present invention. Therefore, the present invention should not be construed as being limited to the following description. In the structures to be described below, the same portions or portions having similar functions are denoted by the same reference numerals in different drawings, and explanation thereof will not be repeated.

Note that the ordinal numbers such as “first”, “second”, and “third” in this specification are used for convenience and do not denote the order of steps and the stacking order of layers. In addition, the ordinal numbers in this specification do not denote particular names which specify the present invention.

### Embodiment 1

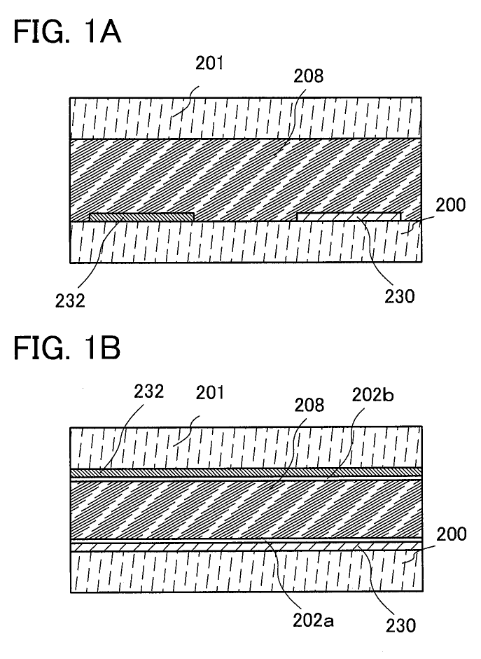

A liquid crystal composition, a liquid crystal element using the liquid crystal composition, or a liquid crystal display device of one embodiment of the present invention will be described with reference to FIGS. 1A and 1B. FIGS. 1A and 1B are each a cross-sectional view of a liquid crystal element and a liquid crystal display device.

One embodiment of the present invention provides a polymerizable monomer represented by General Formula (G1).

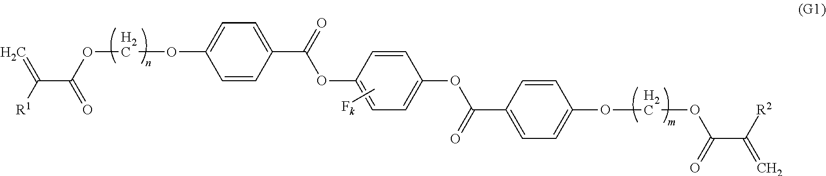

In General Formula (G1), k is 2 or 3, n and m are individually an integer from 1 to 20, and R¹ and R² individually represent hydrogen or a methyl group.

One embodiment of the present invention provides a polymerizable monomer represented by General Formula (G2).

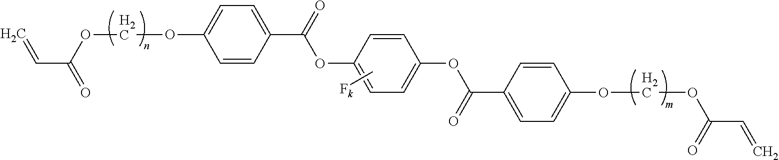

In General Formula (G2), k is 2 or 3, and n and m are individually an integer from 1 to 20.

One embodiment of the present invention provides a polymerizable monomer represented by General Formula (G3).

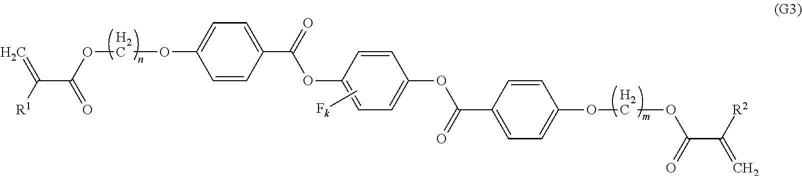

In General Formula (G3), k is 2 or 3, n and m are individually an integer from 1 to 20, n=m, and R¹ and R² individually represent hydrogen or a methyl group.

One embodiment of the present invention provides a polymerizable monomer represented by General Formula (G4).

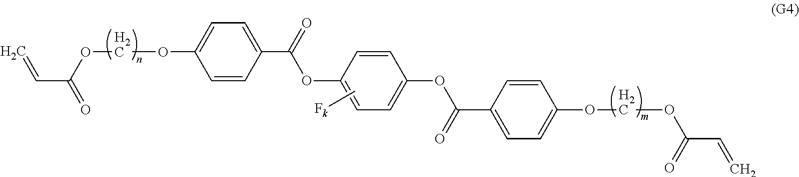

In General Formula (G4), k is 2 or 3, n and m are individually an integer from 1 to 20, and n=m.

One embodiment of the present invention provides a polymerizable monomer represented by General Formula (G11).

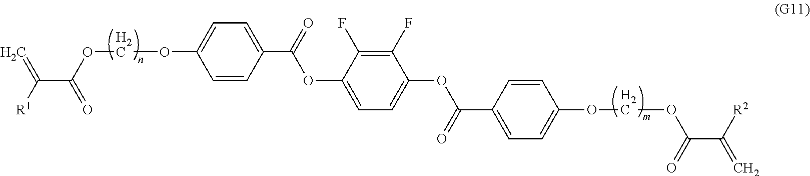

In General Formula (G11), n and m are individually an integer from 1 to 20, and R¹ and R² individually represent hydrogen or a methyl group.

One embodiment of the present invention provides a polymerizable monomer represented by General Formula (G12).

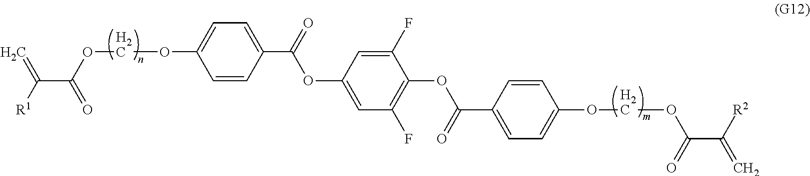

In General Formula (G12), n and m are individually an integer from 1 to 20, and R¹ and R² individually represent hydrogen or a methyl group.

One embodiment of the present invention provides a polymerizable monomer represented by General Formula (G13).

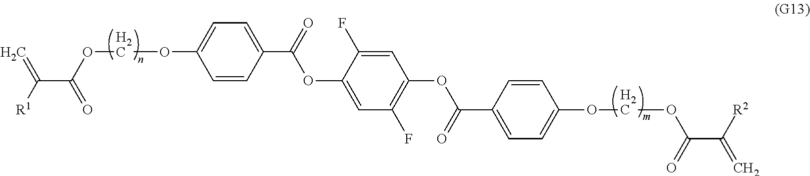

In General Formula (G13), n and m are individually an integer from 1 to 20, and R¹ and R² individually represent hydrogen or a methyl group.

One embodiment of the present invention provides a polymerizable monomer represented by General Formula (G14).

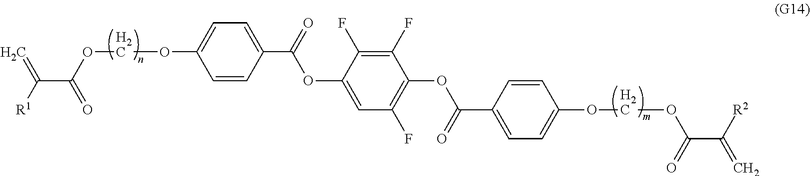

In General Formula (G14), n and m are individually an integer from 1 to 20, and R¹ and R² individually represent hydrogen or a methyl group.

One embodiment of the present invention provides a polymerizable monomer represented by General Formula (G21).

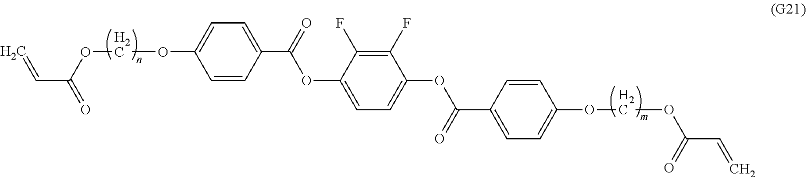

In General Formula (G21), and n and m are individually an integer from 1 to 20.

One embodiment of the present invention provides a polymerizable monomer represented by General Formula (G22).

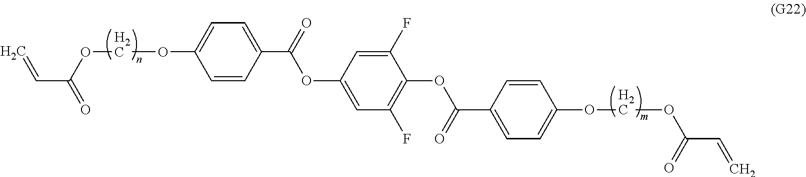

In General Formula (G22), and n and m are individually an integer from 1 to 20.

One embodiment of the present invention provides a polymerizable monomer represented by General Formula (G23).

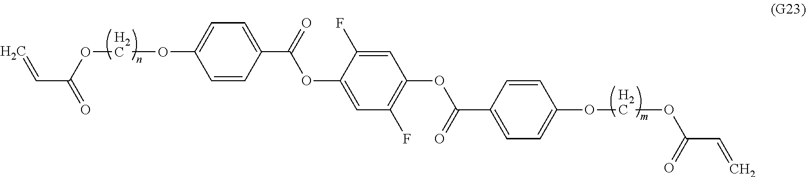

In General Formula (G23), and n and m are individually an integer from 1 to 20.

One embodiment of the present invention provides a polymerizable monomer represented by General Formula (G24).

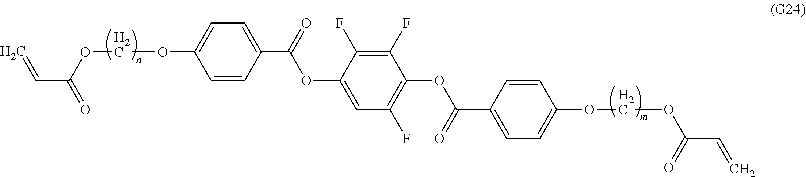

In General Formula (G24), and n and m are individually an integer from 1 to 20.

One embodiment of the present invention provides a polymerizable monomer represented by General Formula (G31).

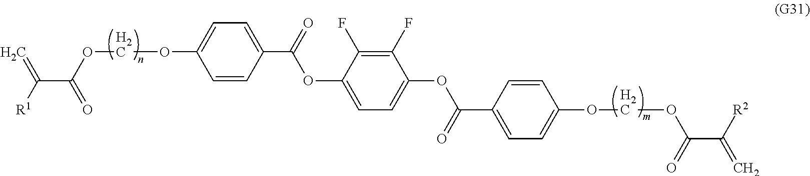

In General Formula (G31), n and m are individually an integer from 1 to 20, n=m, and R¹ and R² individually represent hydrogen or a methyl group.

One embodiment of the present invention provides a polymerizable monomer represented by General Formula (G32).

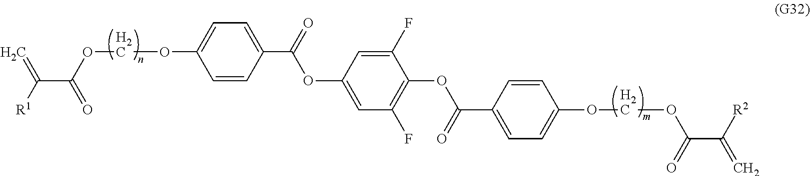

In General Formula (G32), n and m are individually an integer from 1 to 20, n=m, and R¹ and R² individually represent hydrogen or a methyl group.

One embodiment of the present invention provides a polymerizable monomer represented by General Formula (G33).

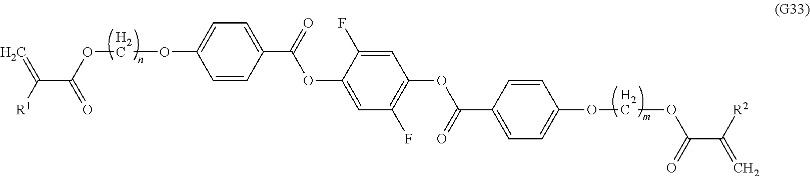

In General Formula (G33), n and m are individually an integer from 1 to 20, n=m, and R¹ and R² individually represent hydrogen or a methyl group.

One embodiment of the present invention provides a polymerizable monomer represented by General Formula (G34).

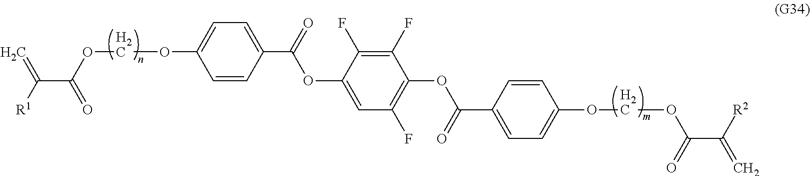

In General Formula (G34), n and m are individually an integer from 1 to 20, n=m, and R¹ and R² individually represent hydrogen or a methyl group.

One embodiment of the present invention provides a polymerizable monomer represented by General Formula (G41).

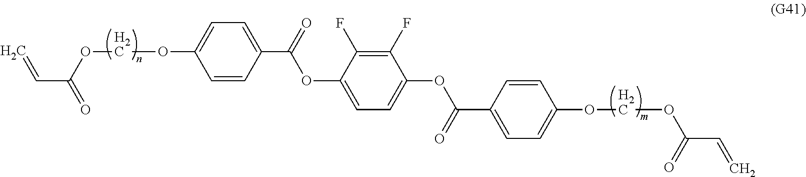

In General Formula (G41), n and m are individually an integer from 1 to 20, and n=m.

One embodiment of the present invention provides a polymerizable monomer represented by General Formula (G42).

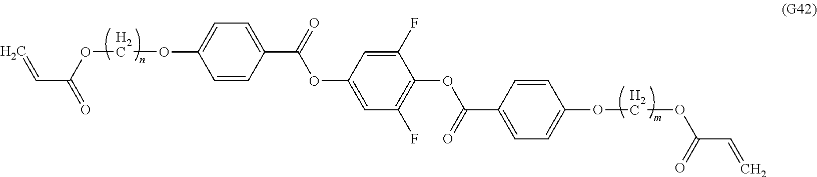

In General Formula (G42), n and m are individually an integer from 1 to 20, and n=m.

One embodiment of the present invention provides a polymerizable monomer represented by General Formula (G43).

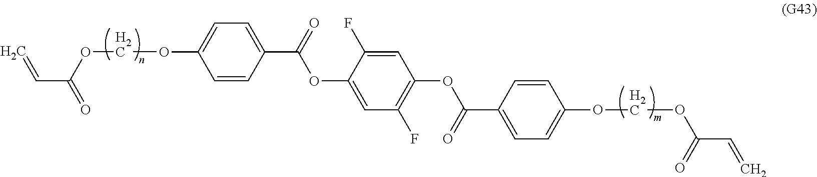

In General Formula (G43), n and m are individually an integer from 1 to 20, and n=m.

One embodiment of the present invention provides a polymerizable monomer represented by General Formula (G44).

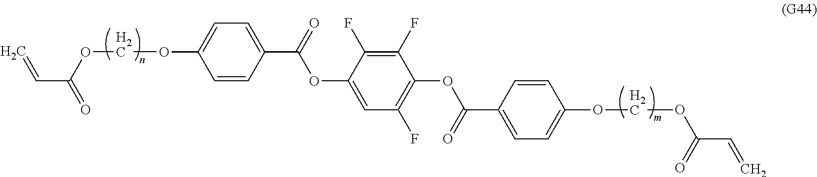

In General Formula (G44), n and m are individually an integer from 1 to 20, and n=m.

Specific examples of the polymerizable monomer represented by General Formula (G 1) include polymerizable monomers represented by General Formula (100) to General Formula (144), General Formula (200) to General Formula (249), General Formula (300) to General Formula (344), and General Formula (400) to General Formula (449). However, the present invention is not limited thereto.

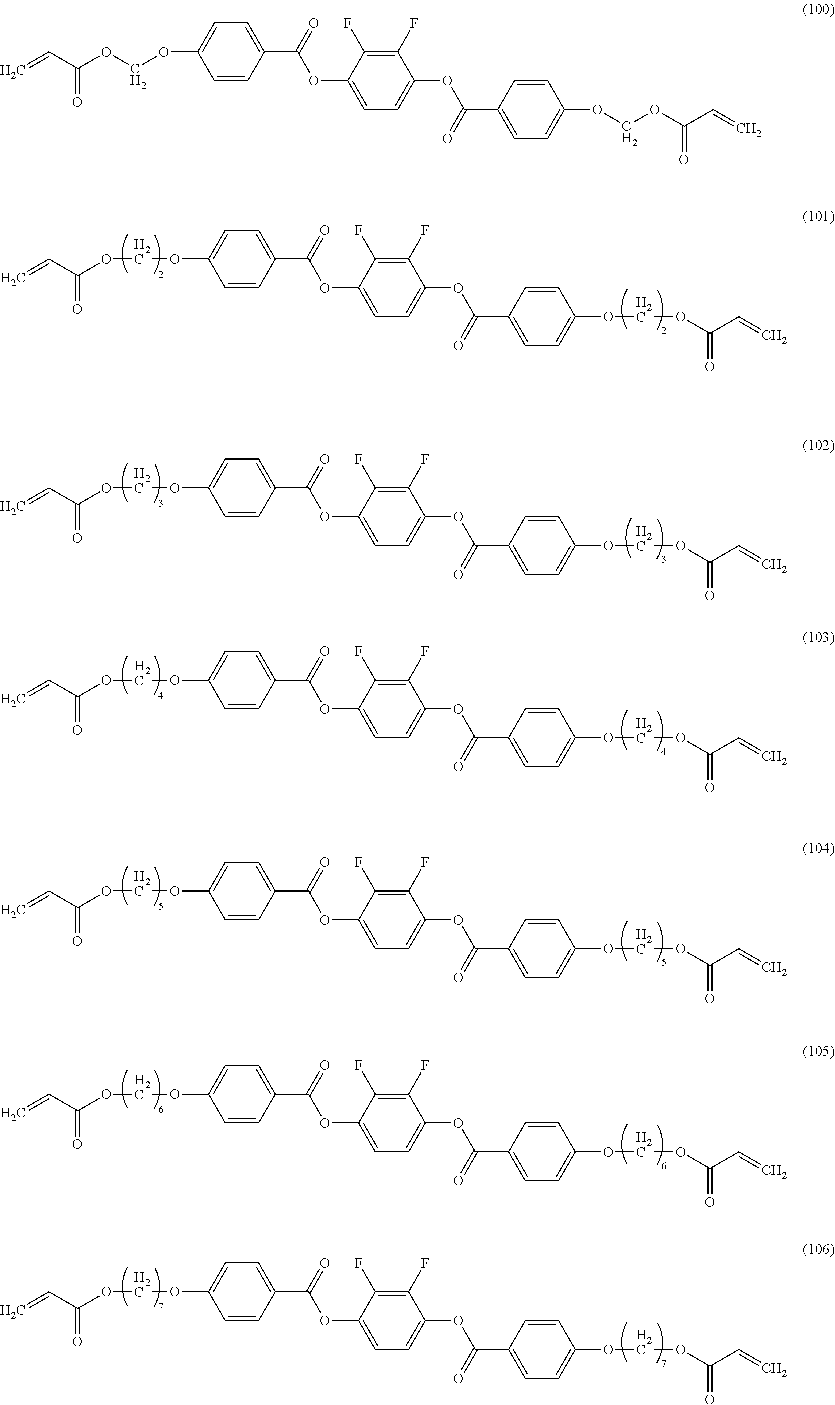

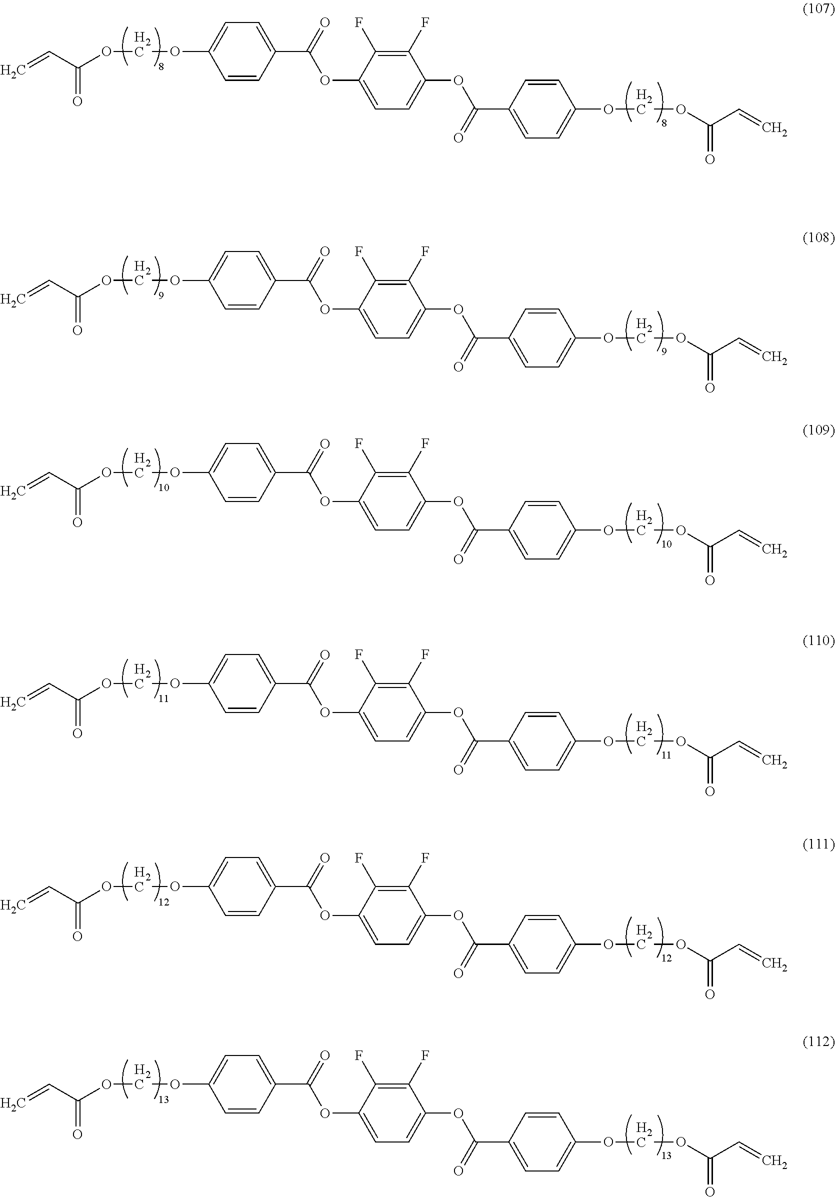

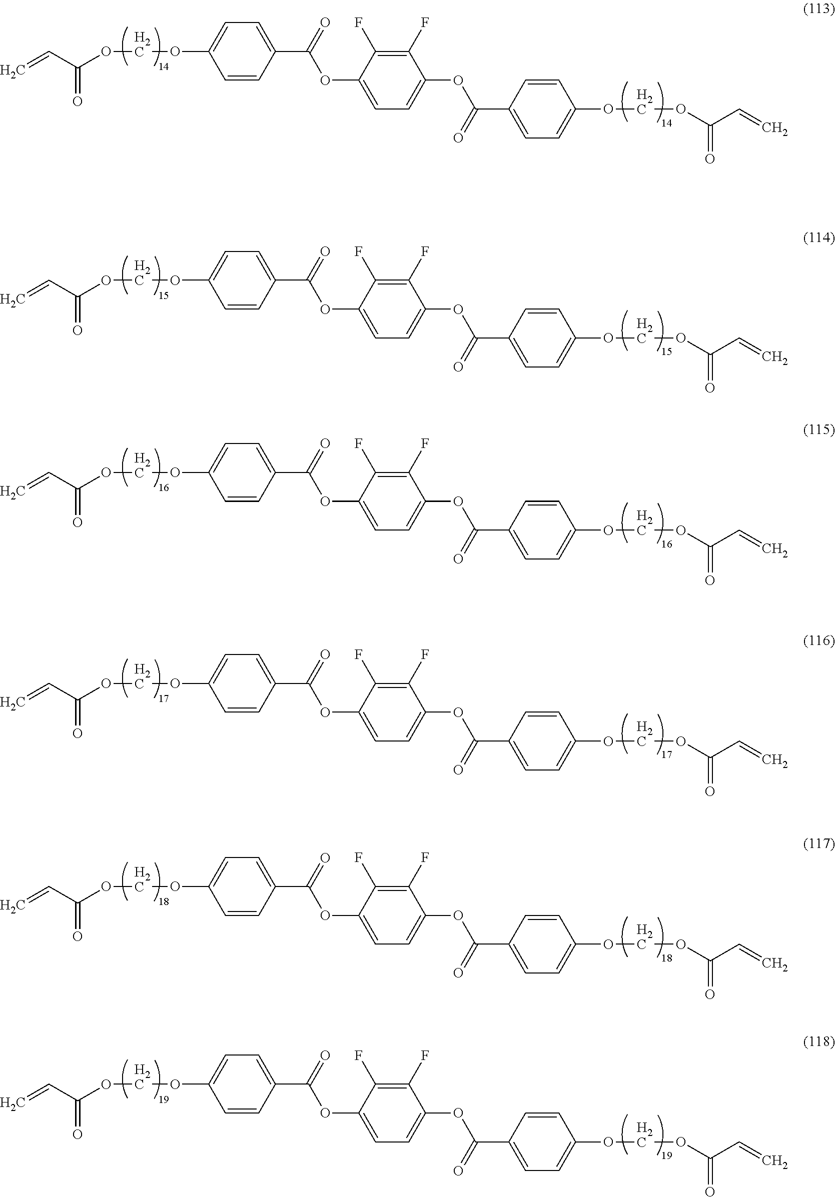

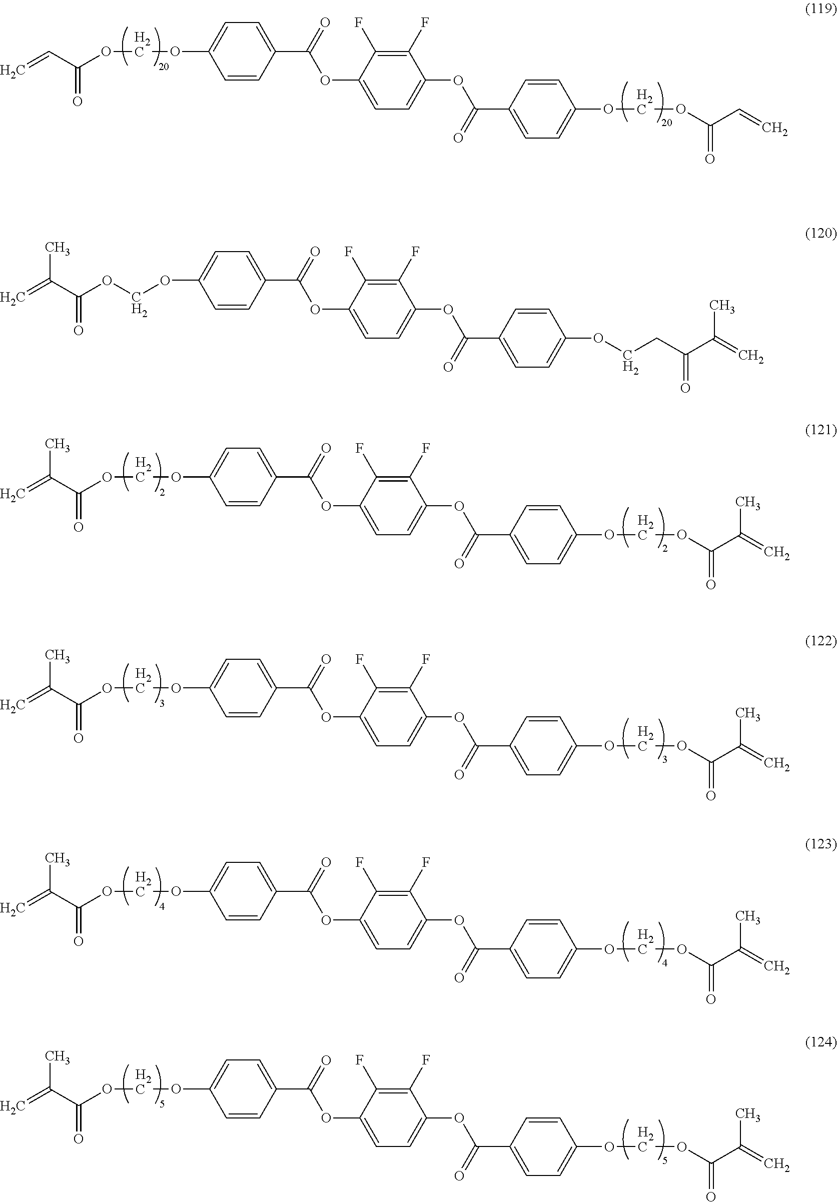

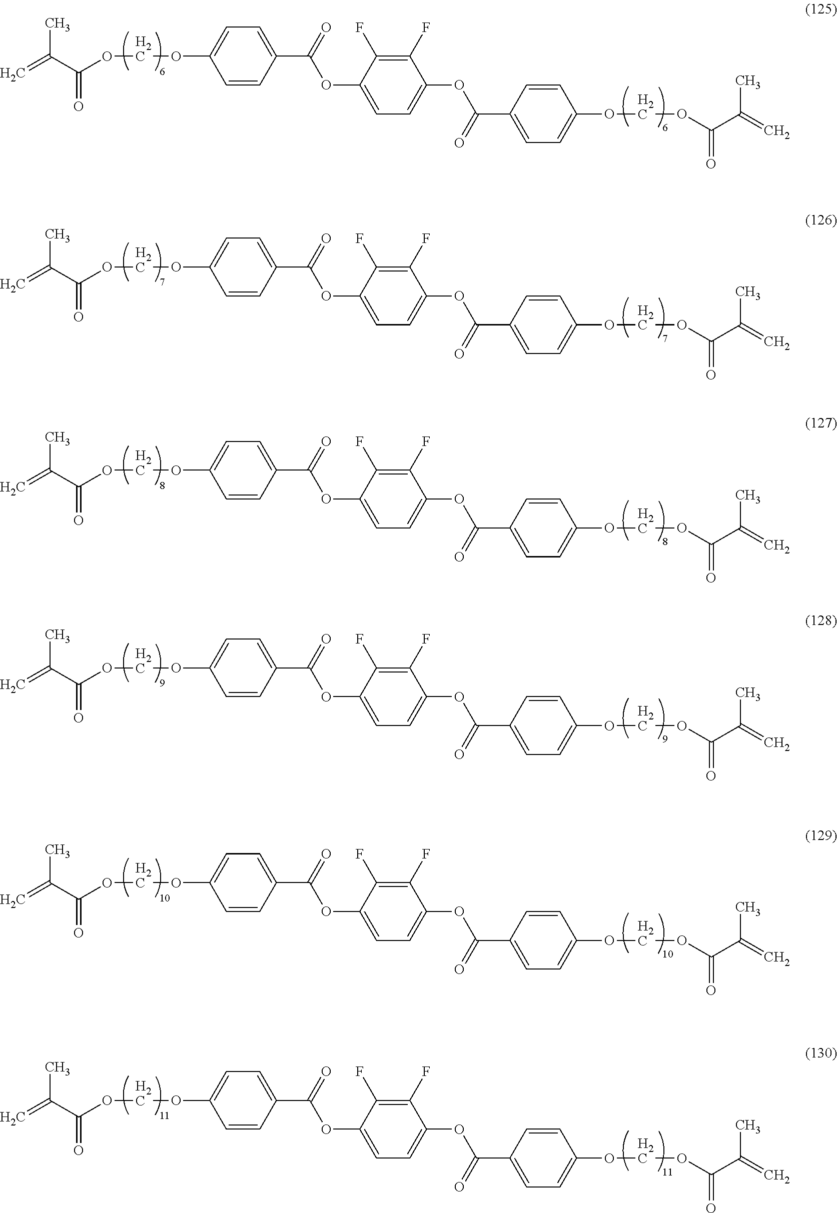

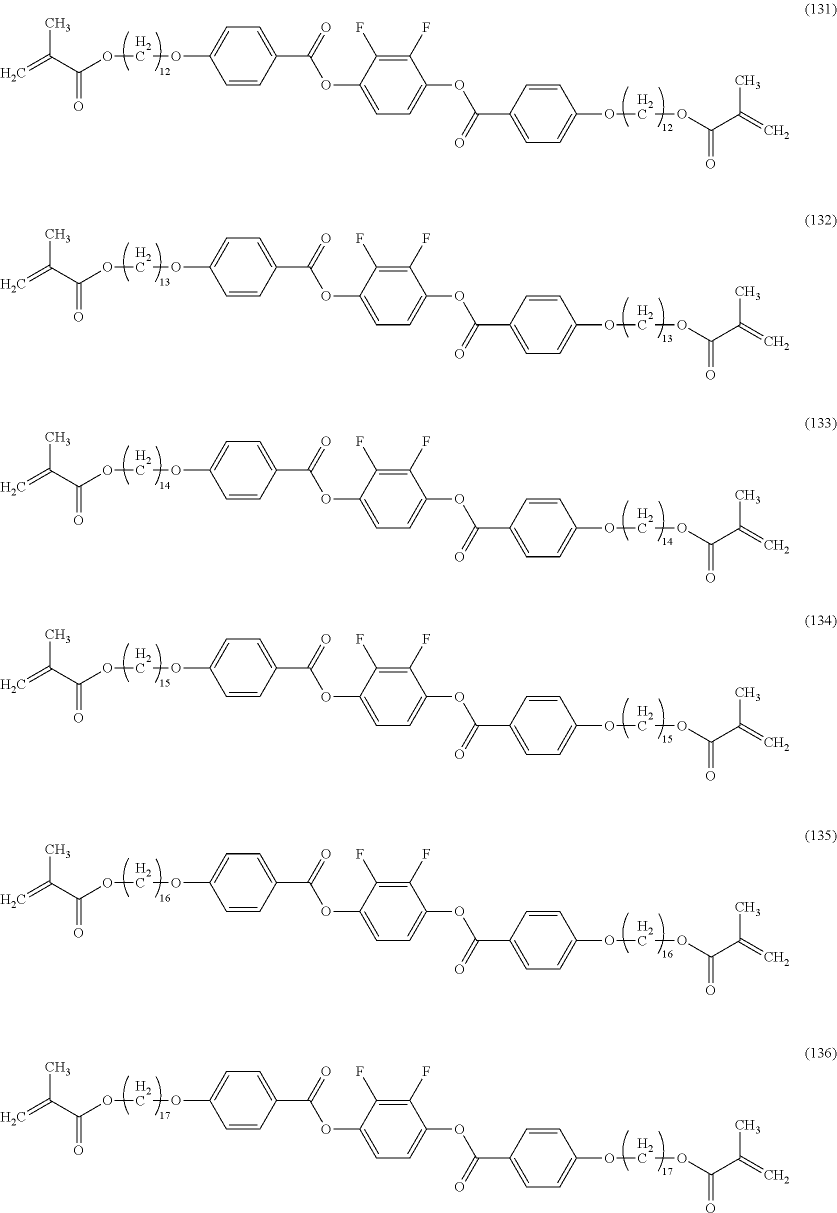

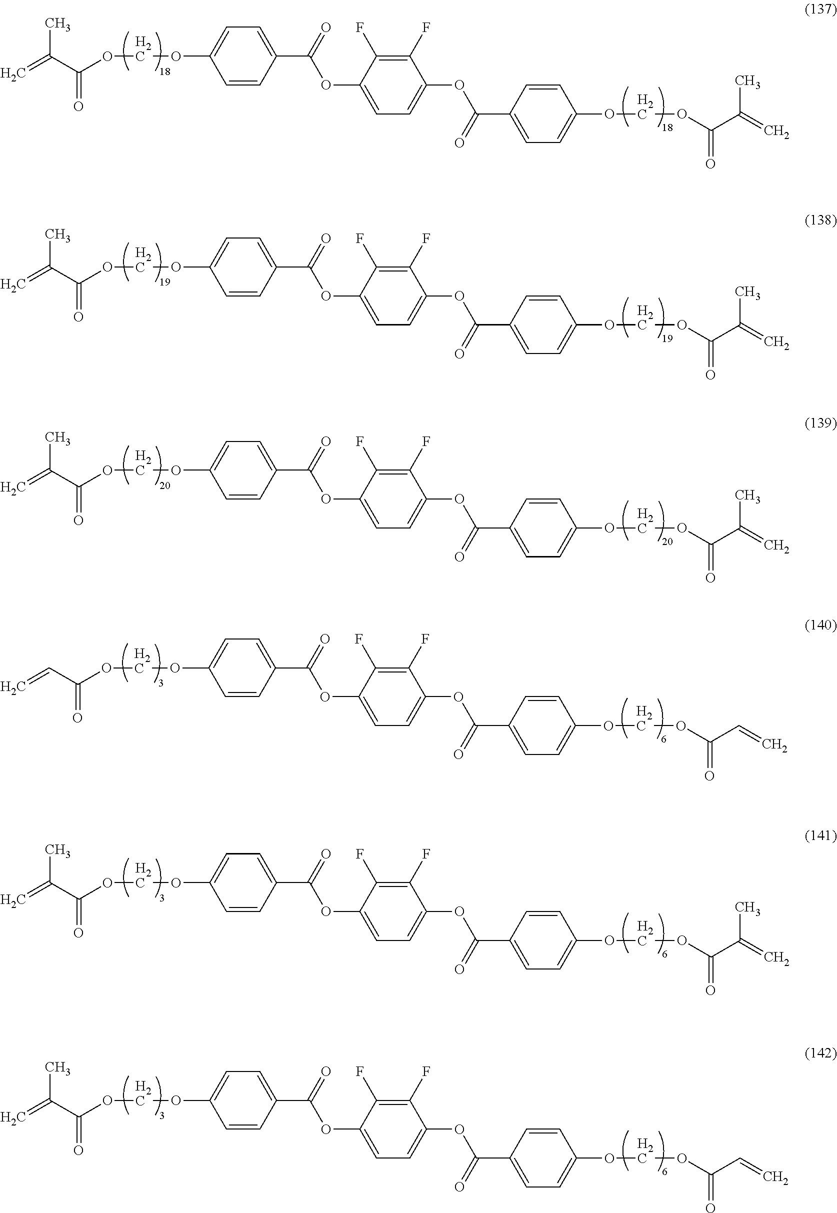

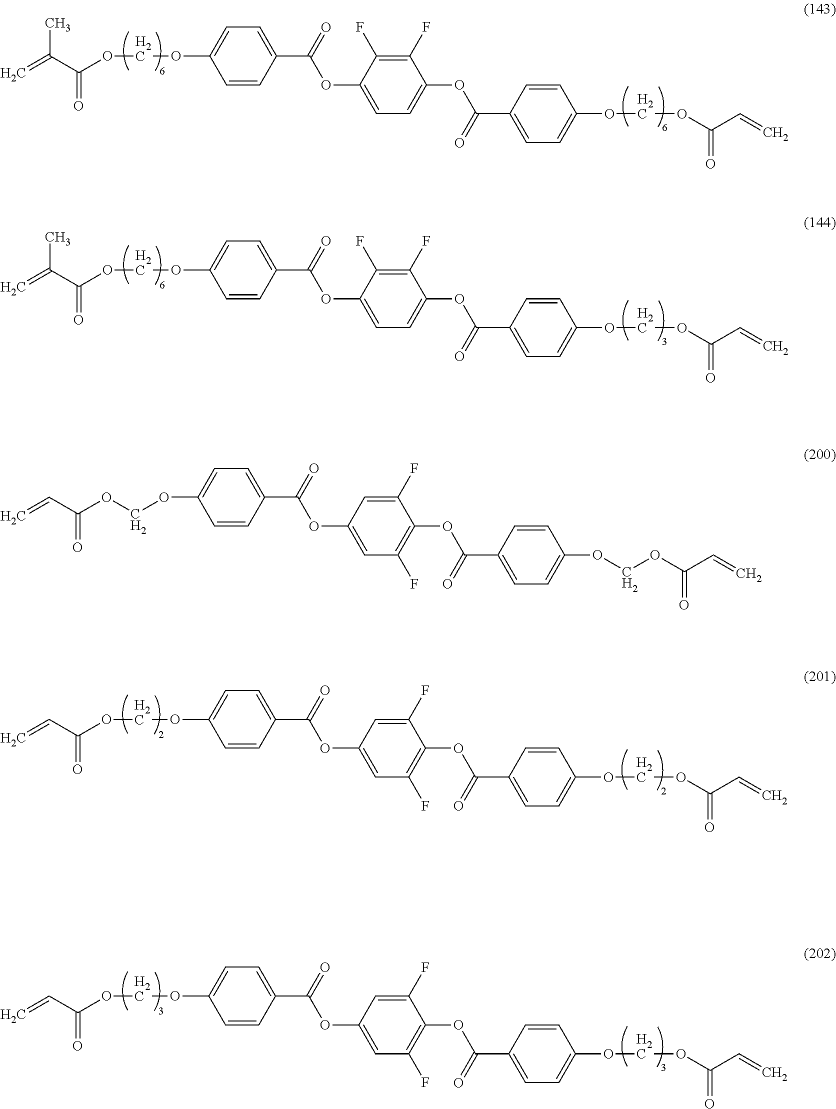

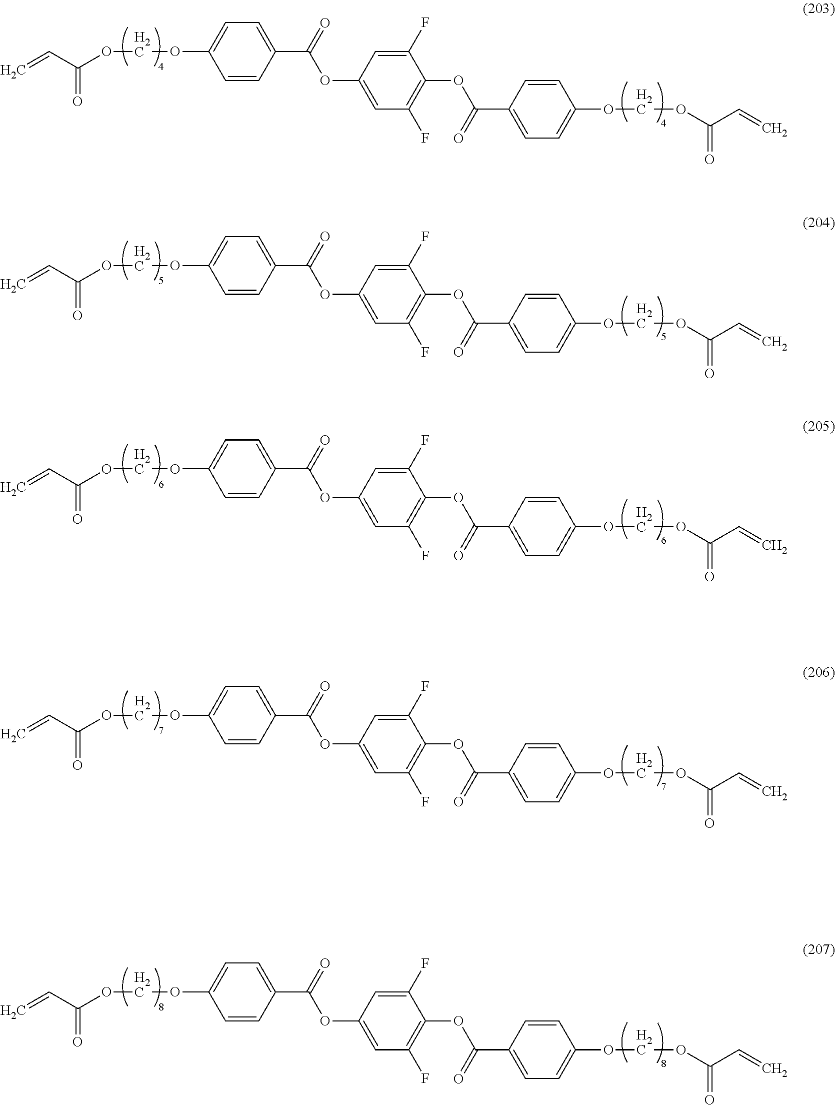

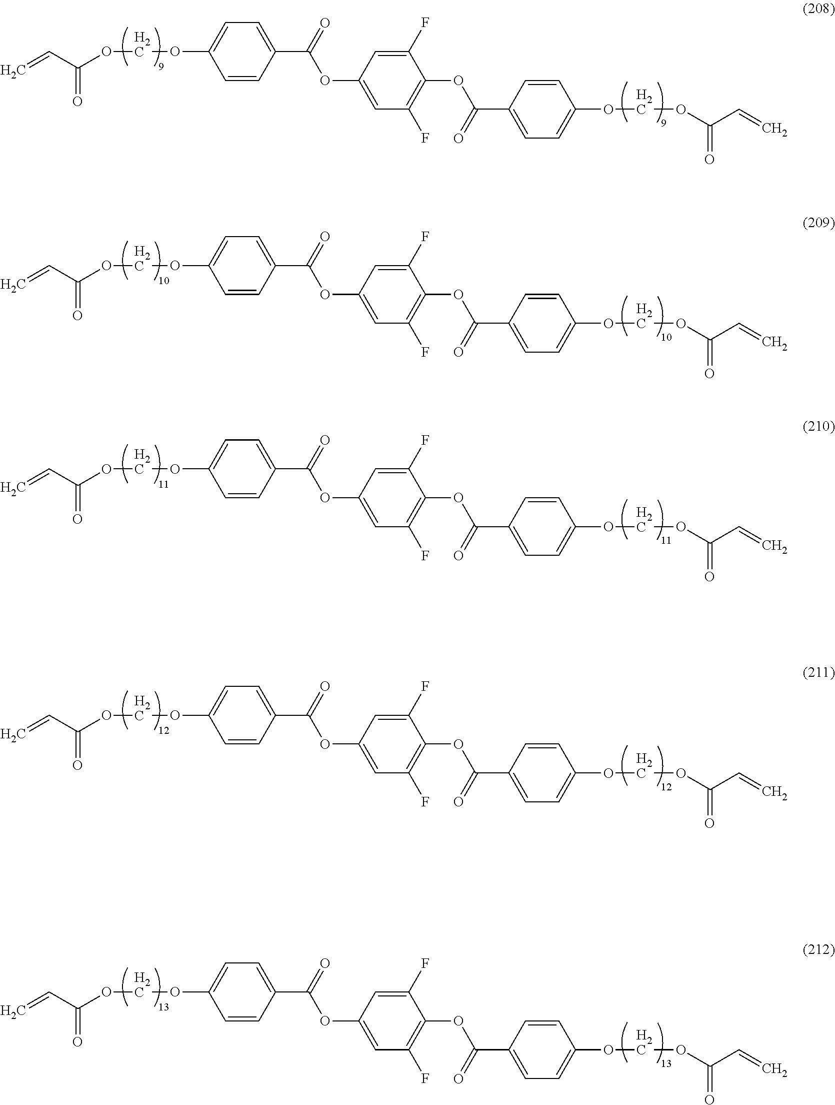

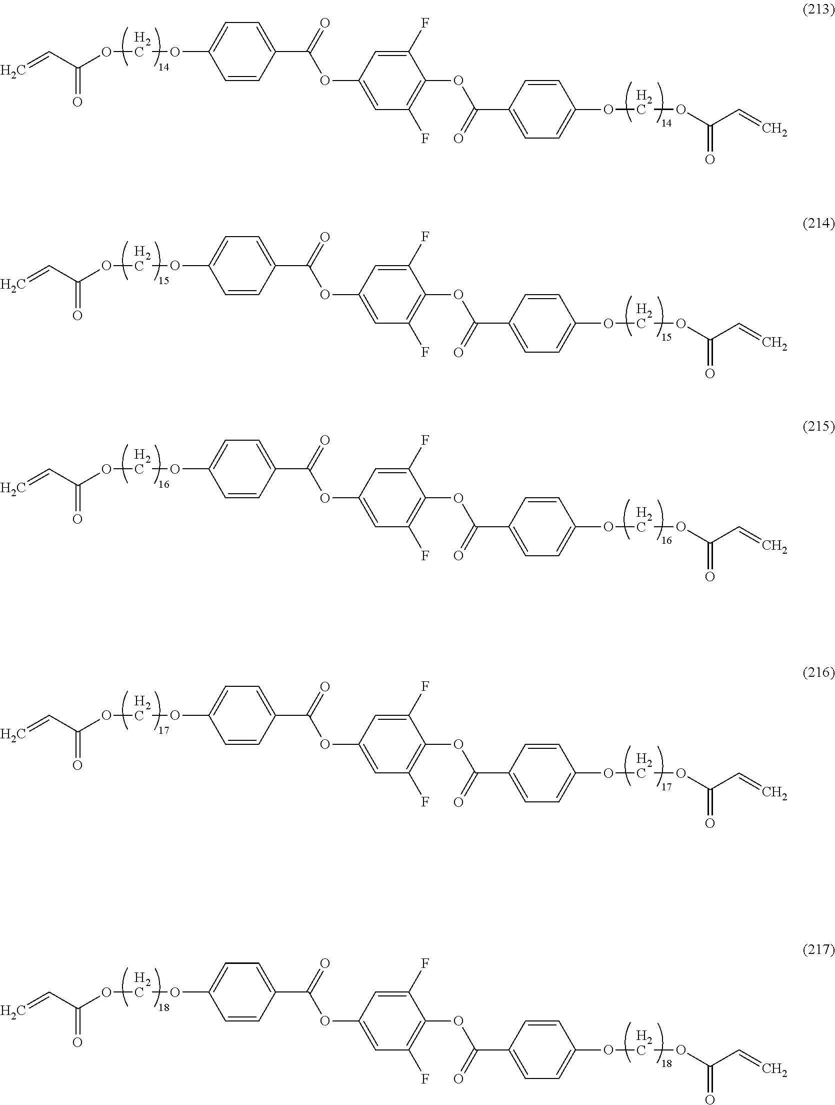

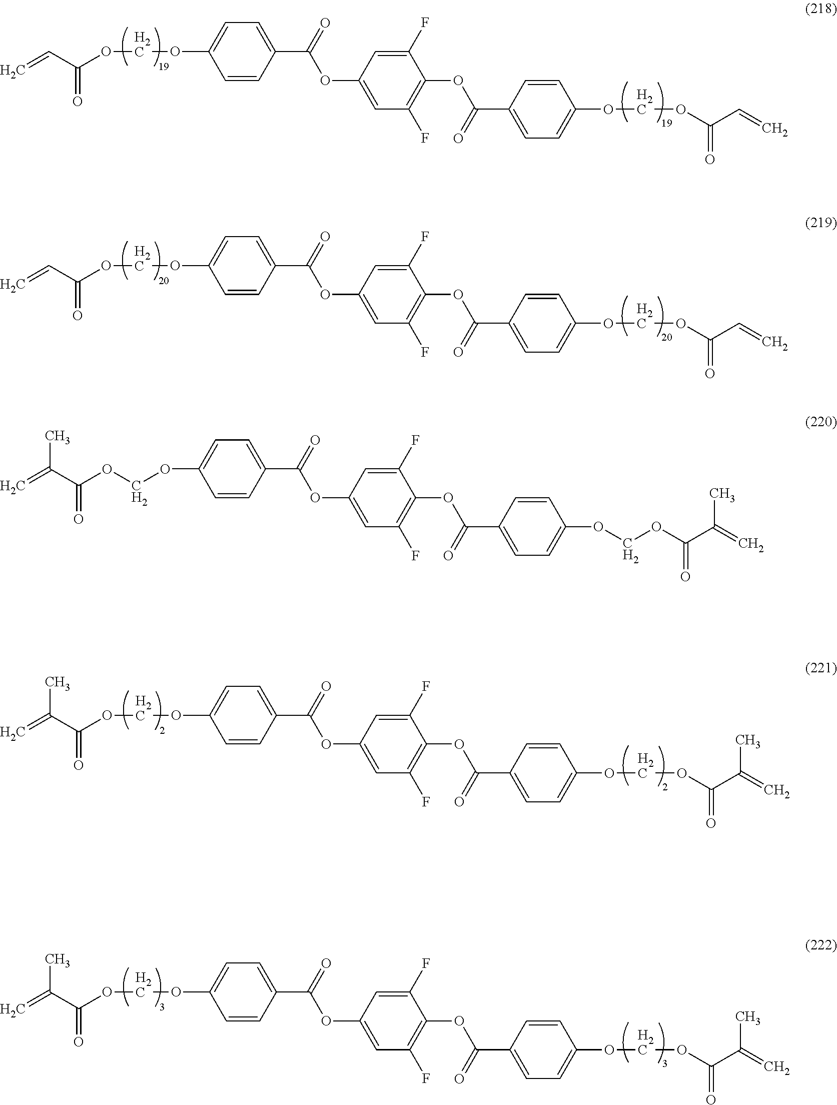

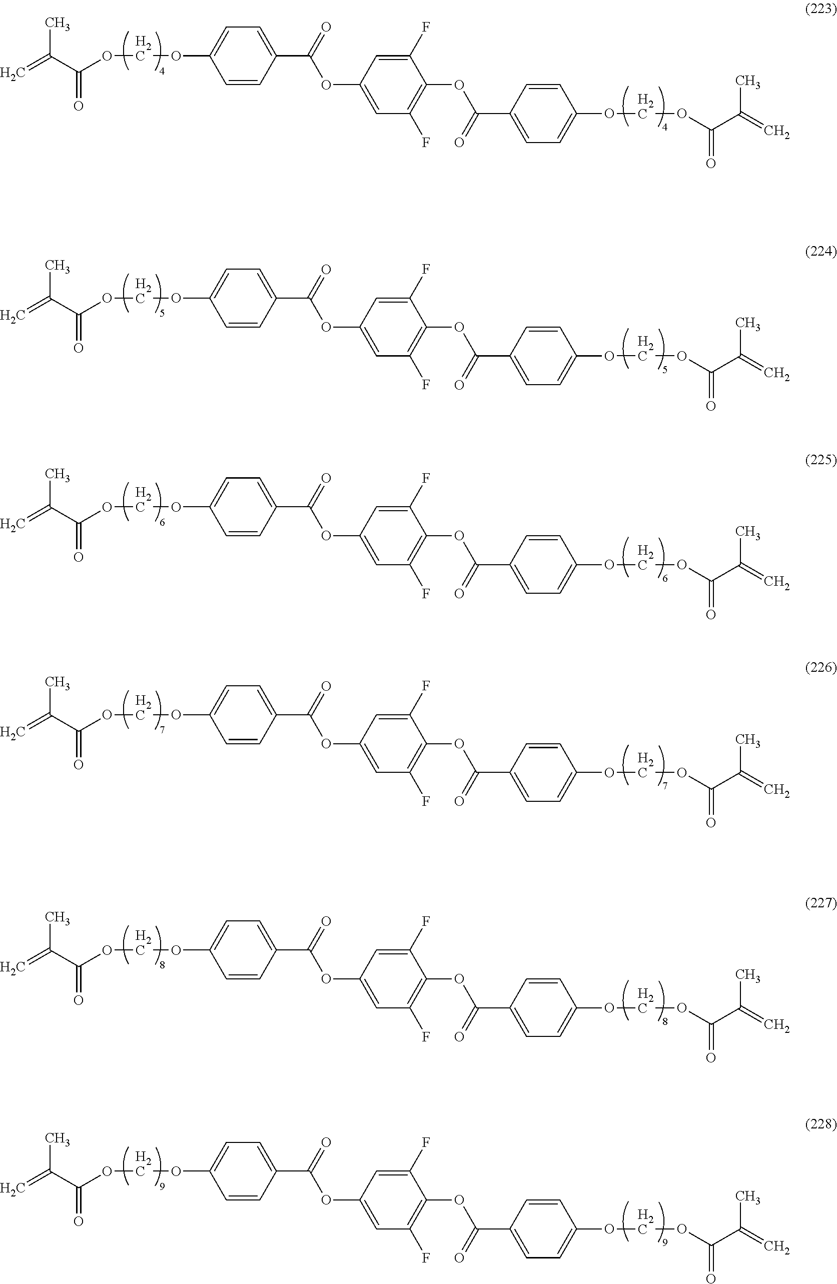

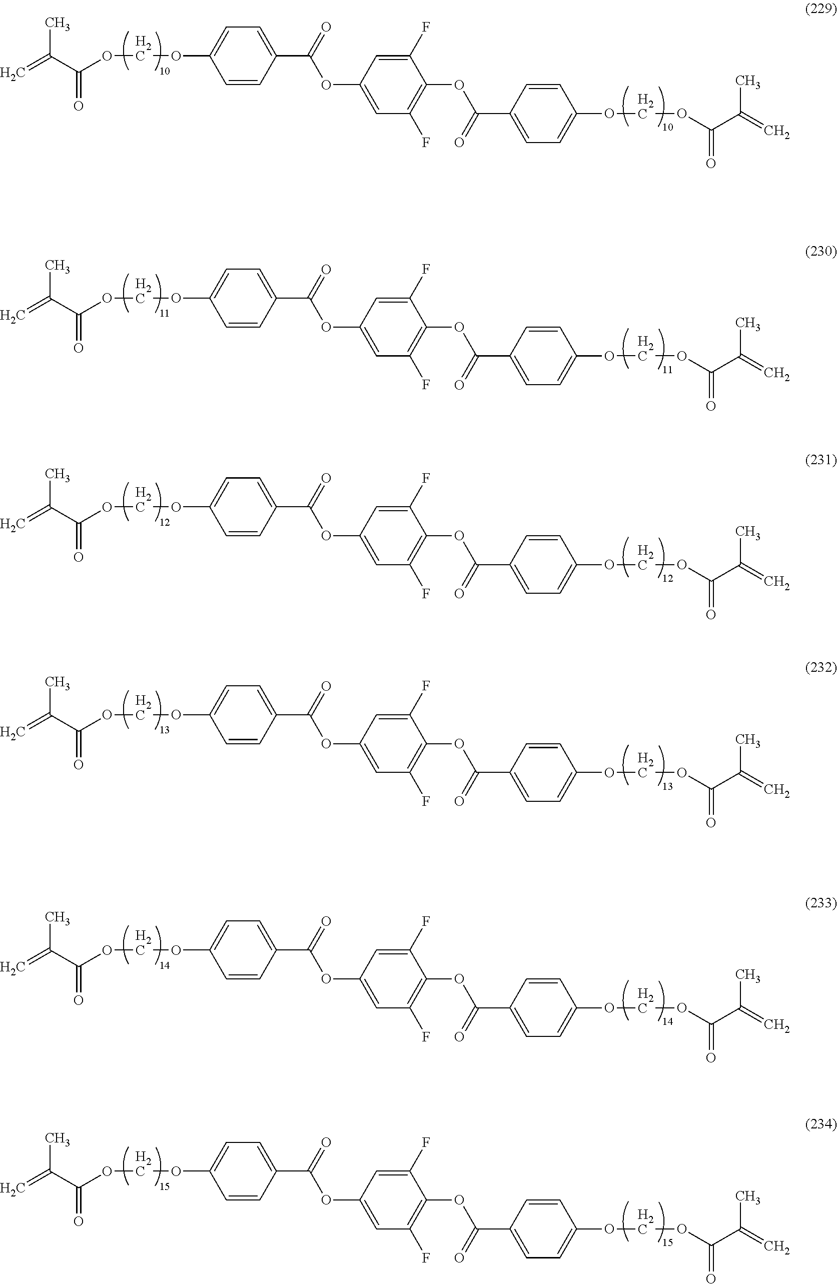

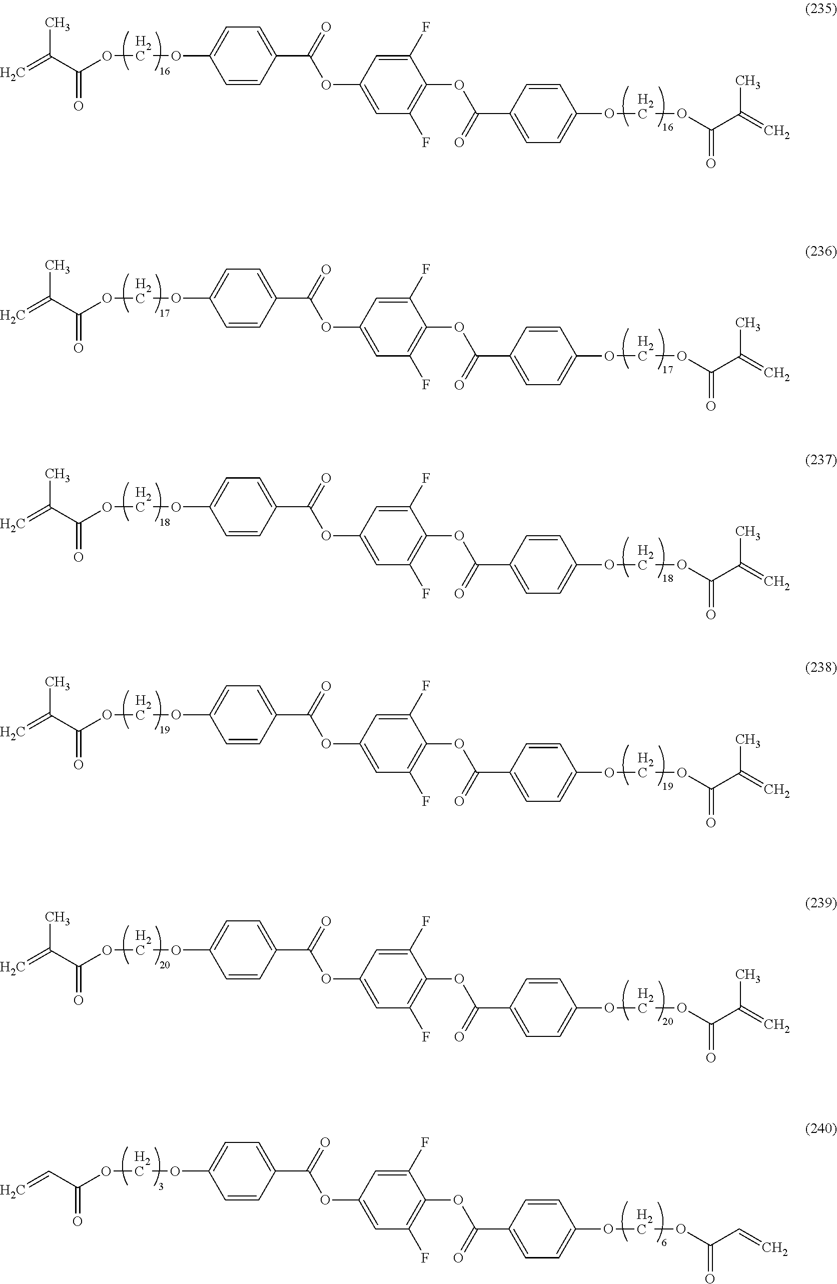

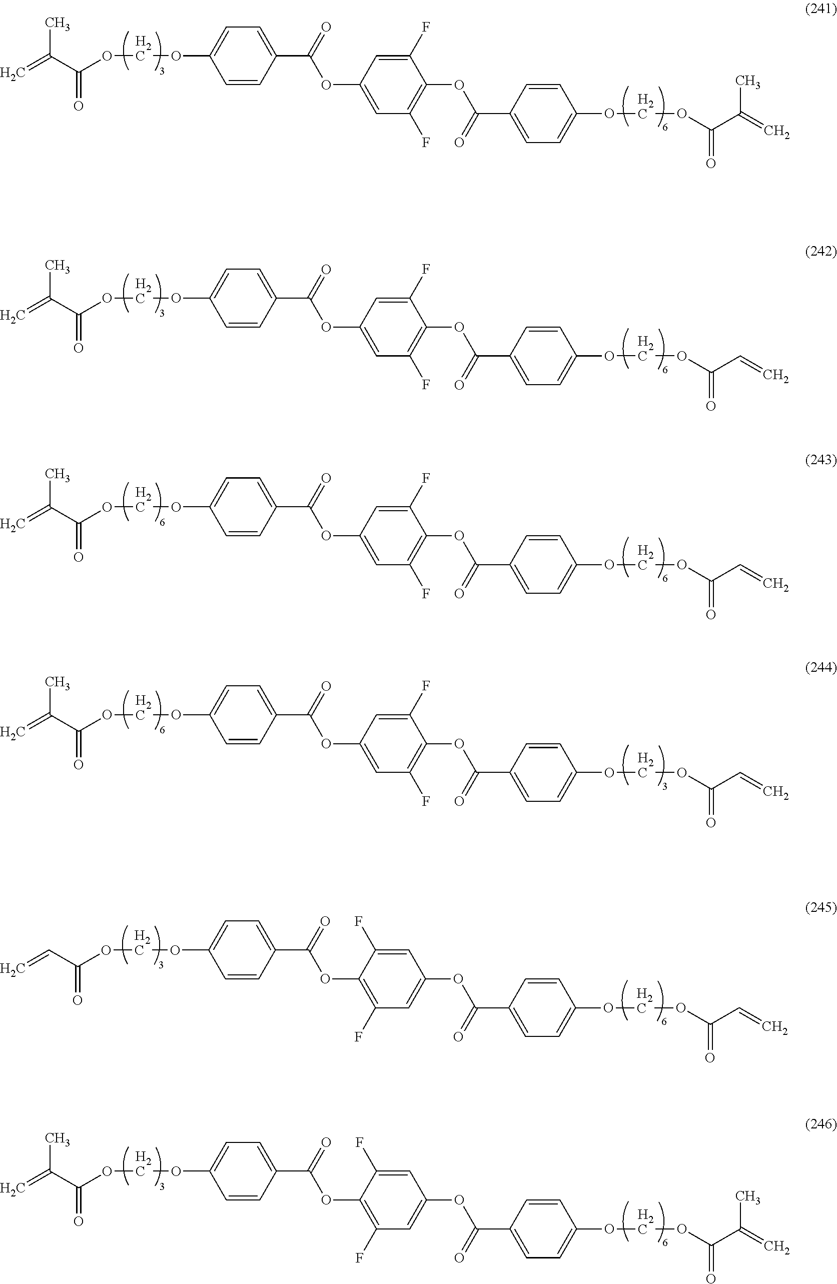

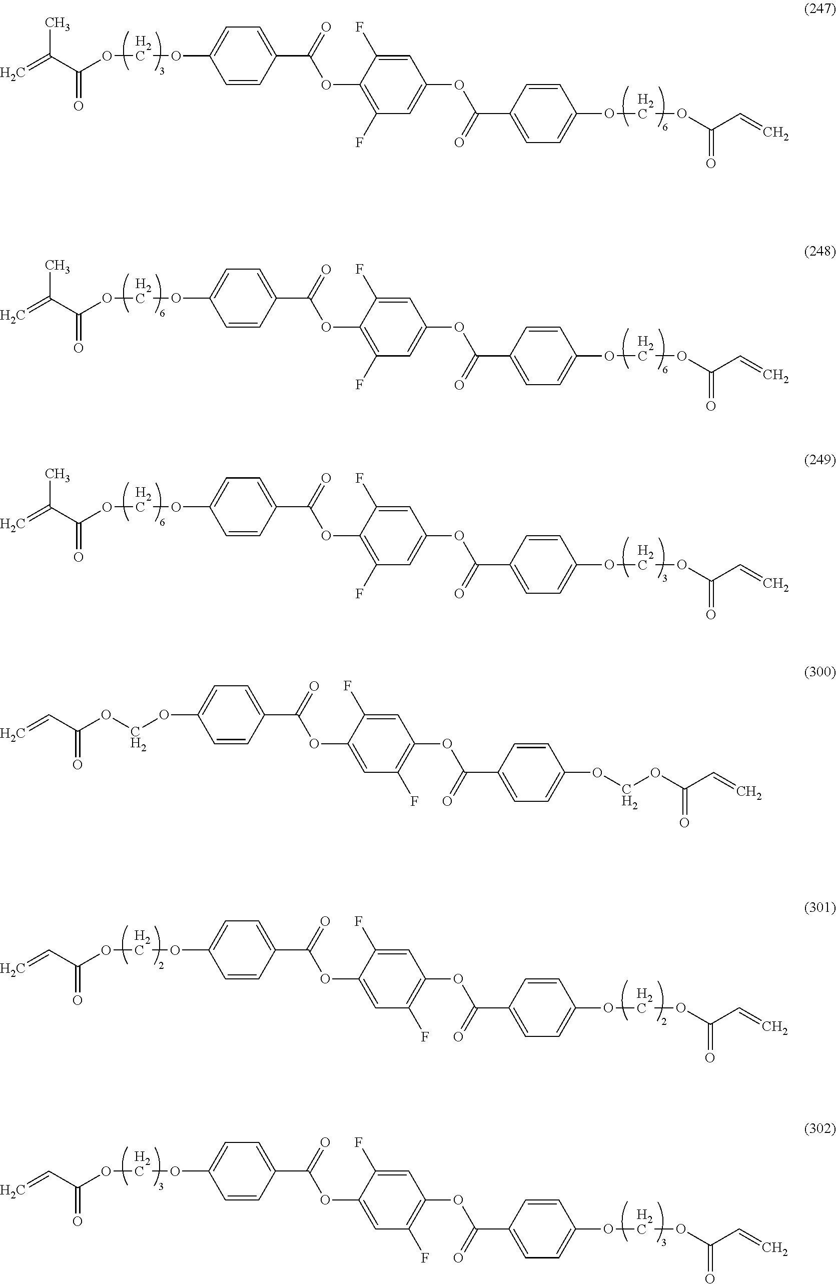

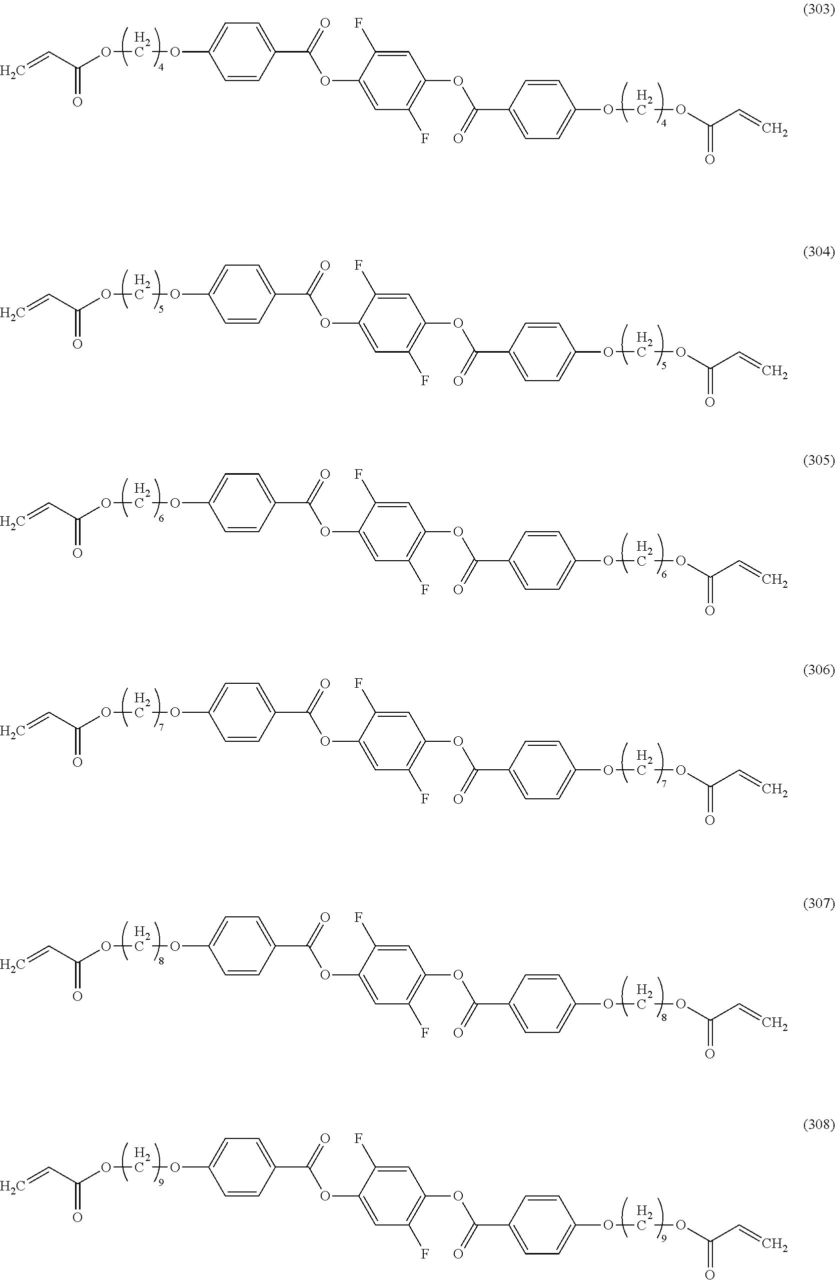

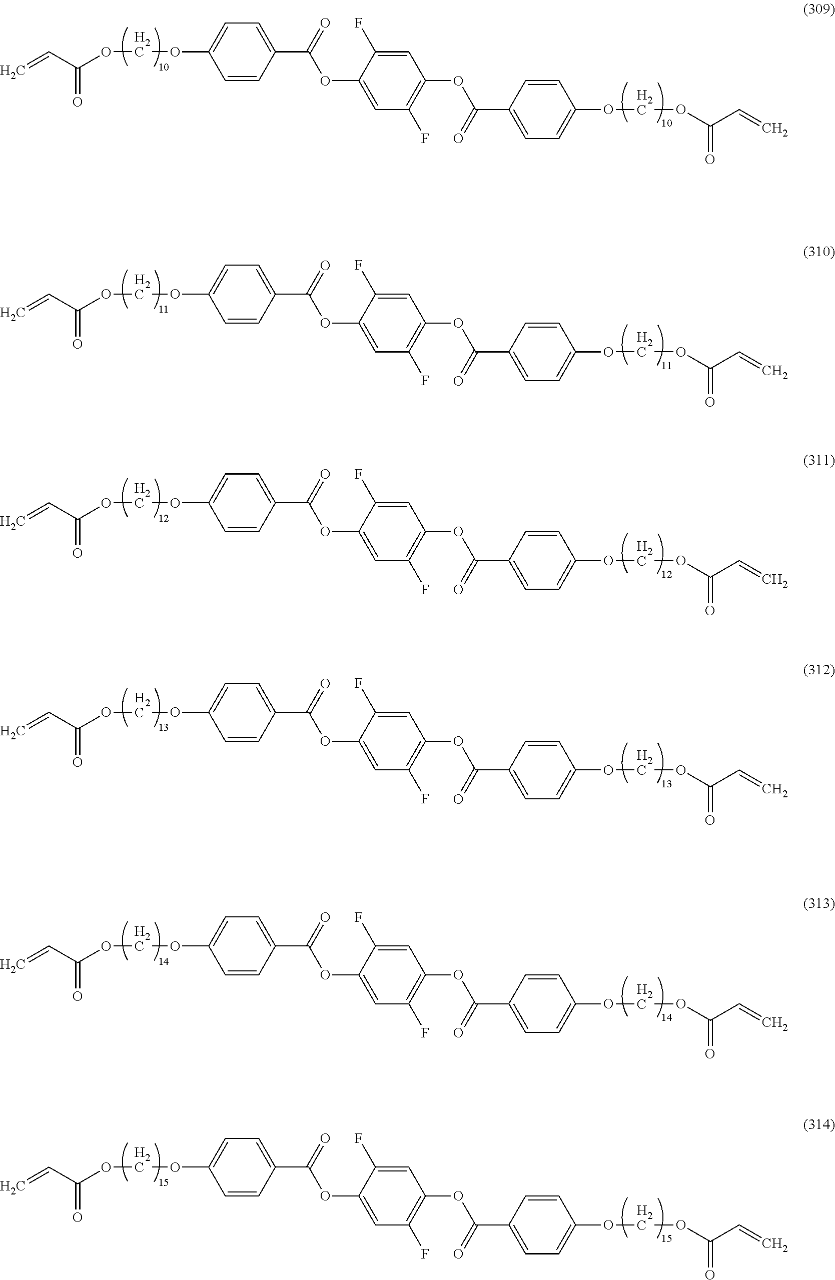

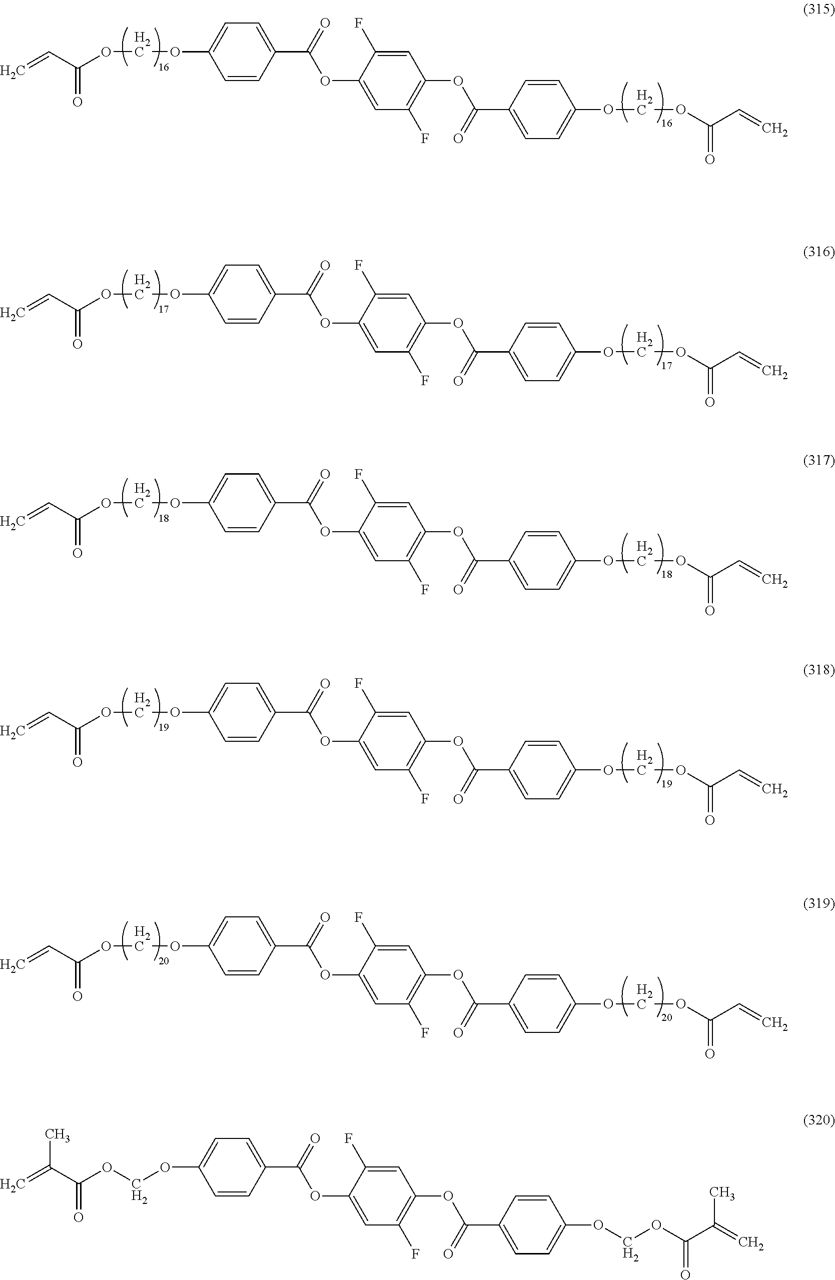

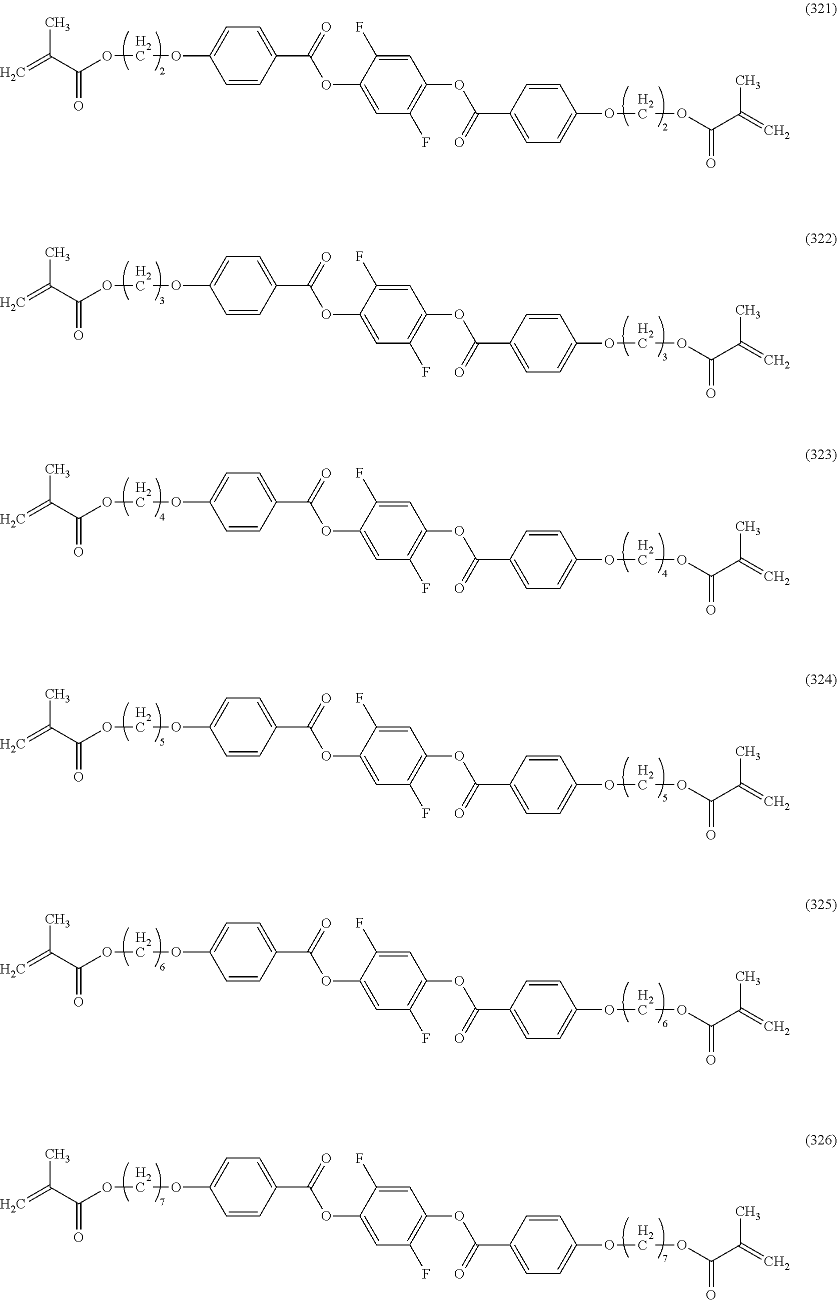

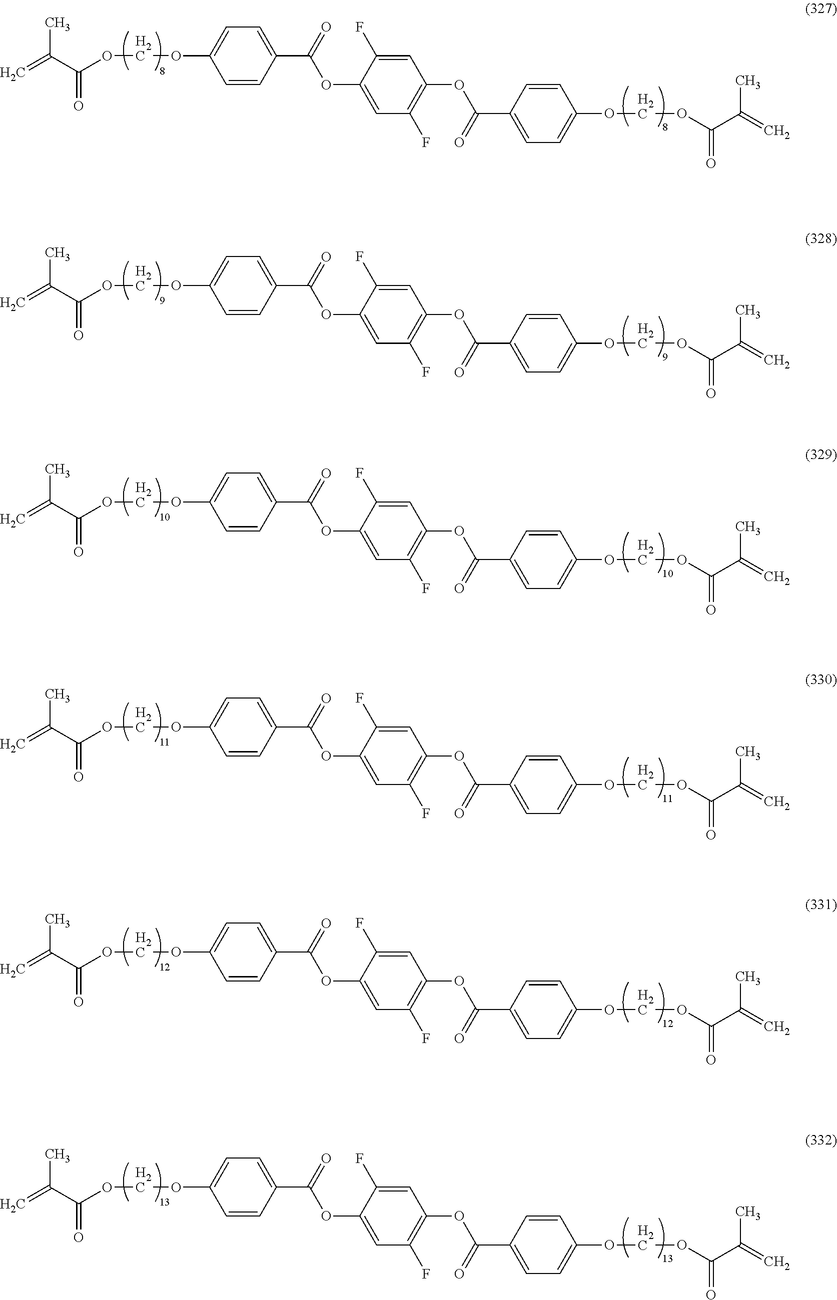

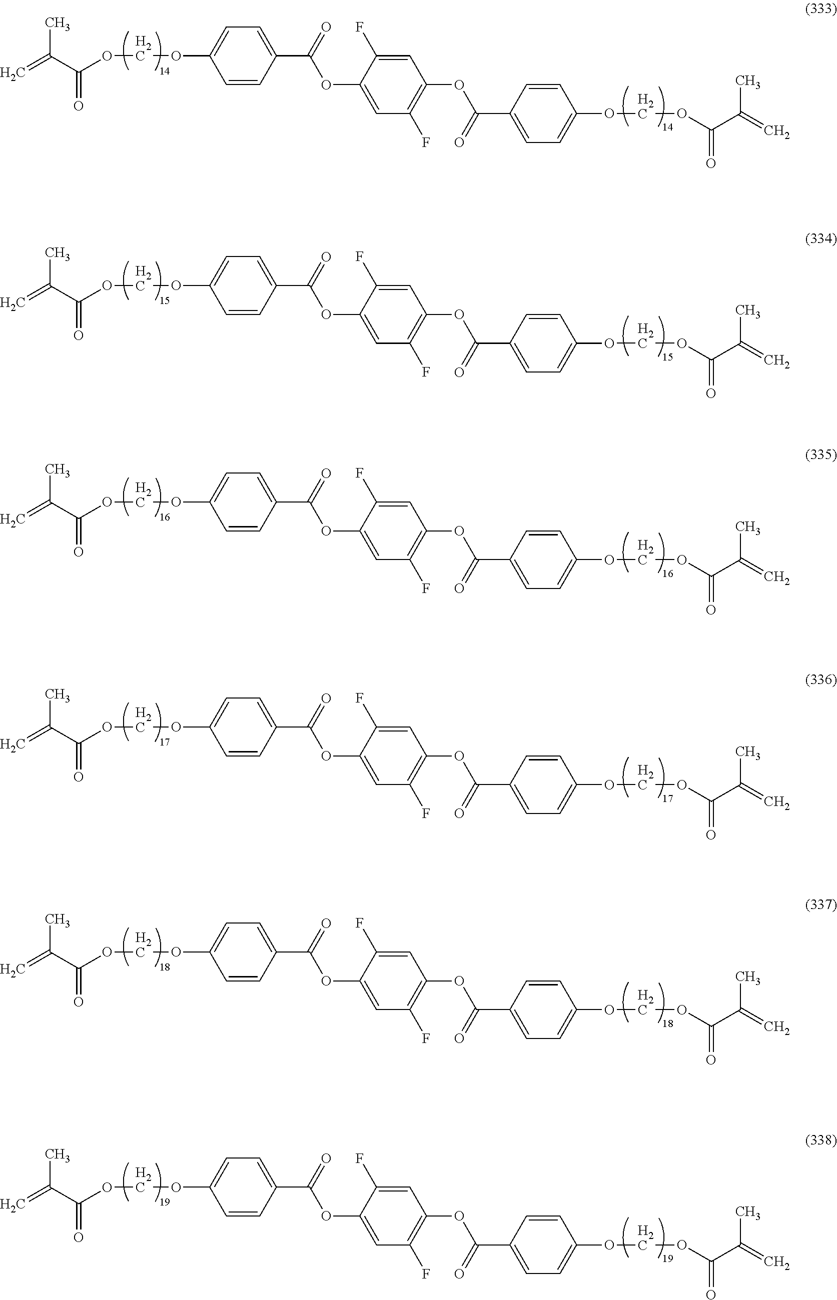

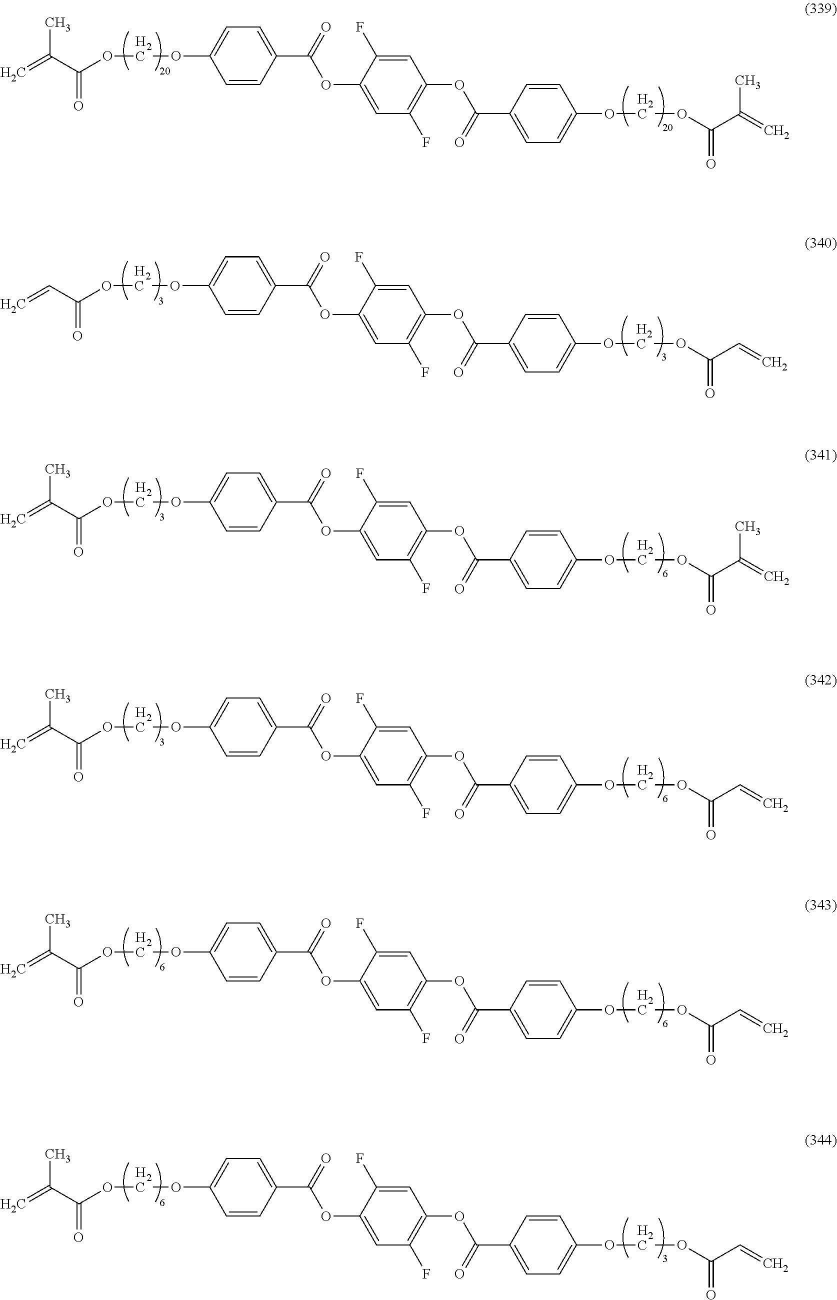

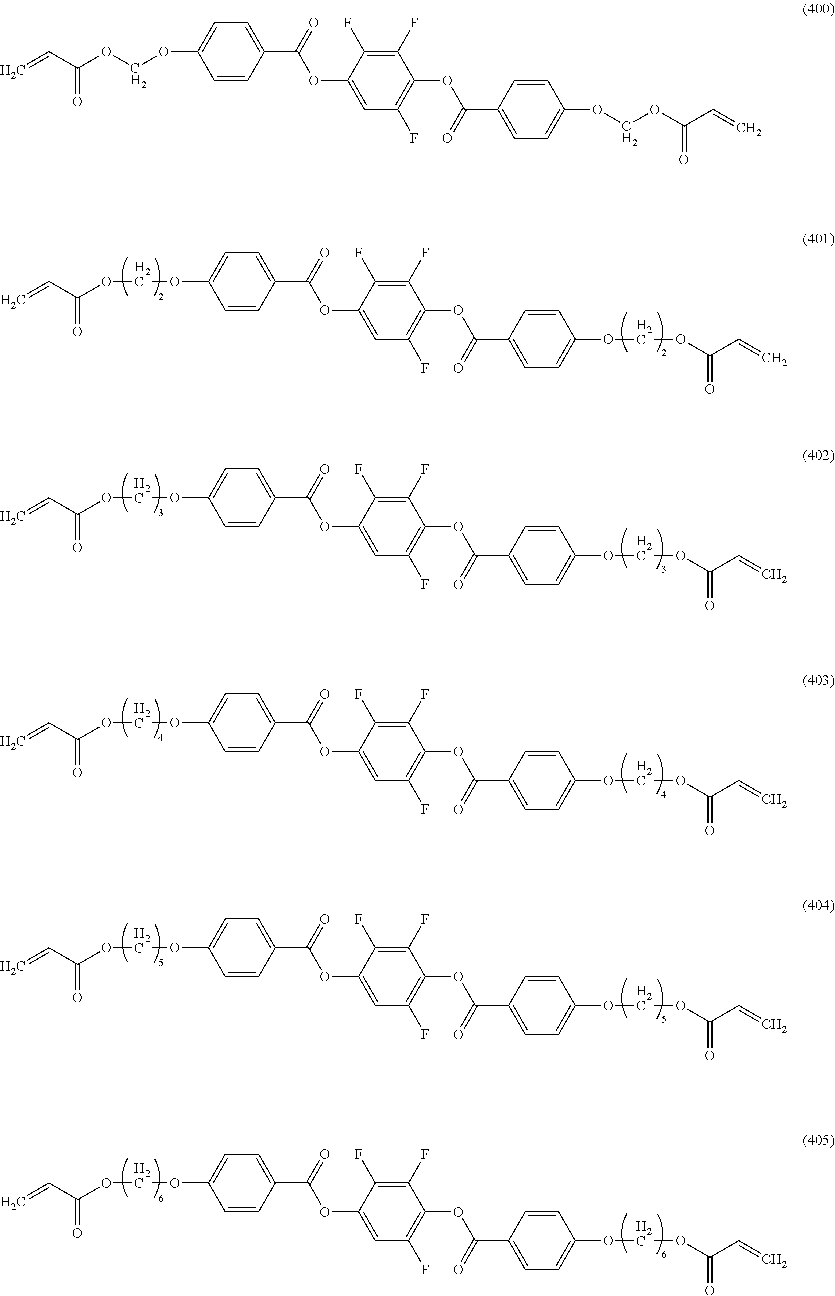

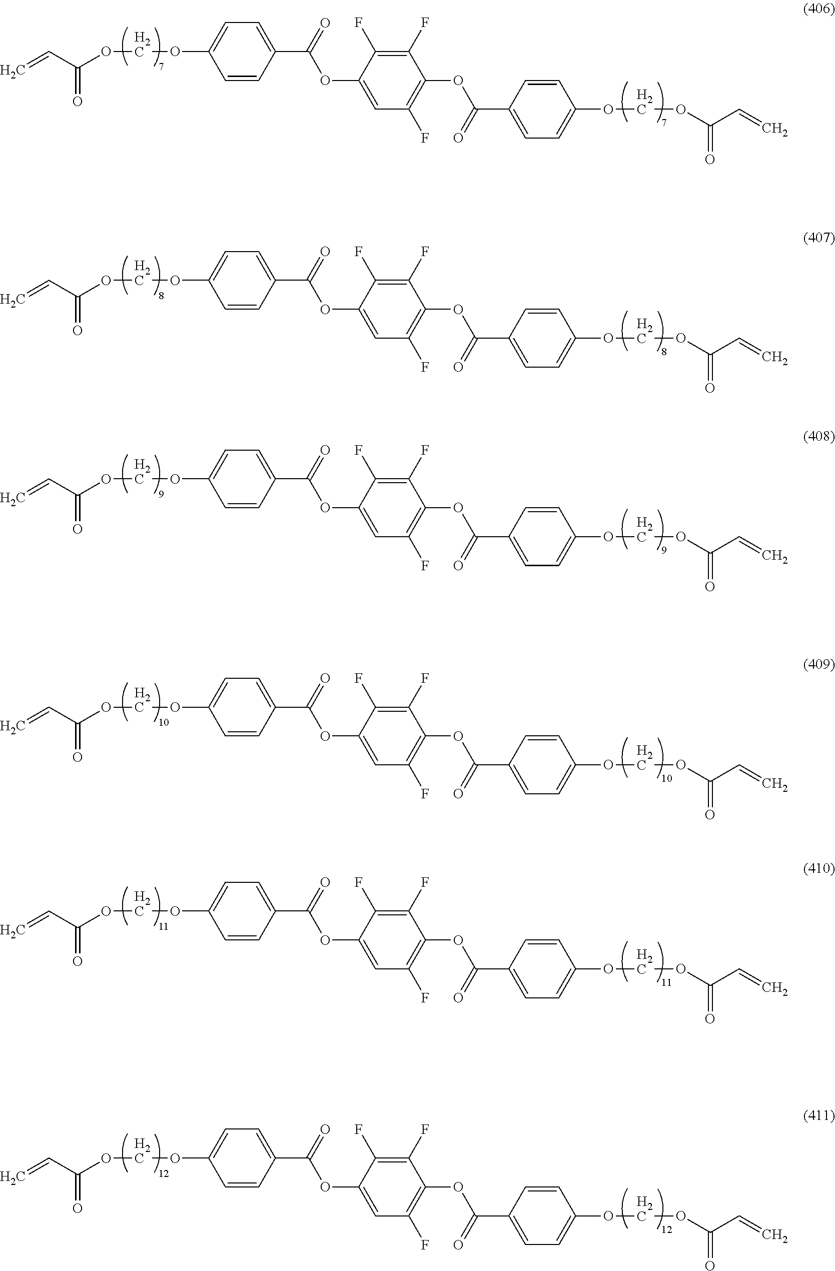

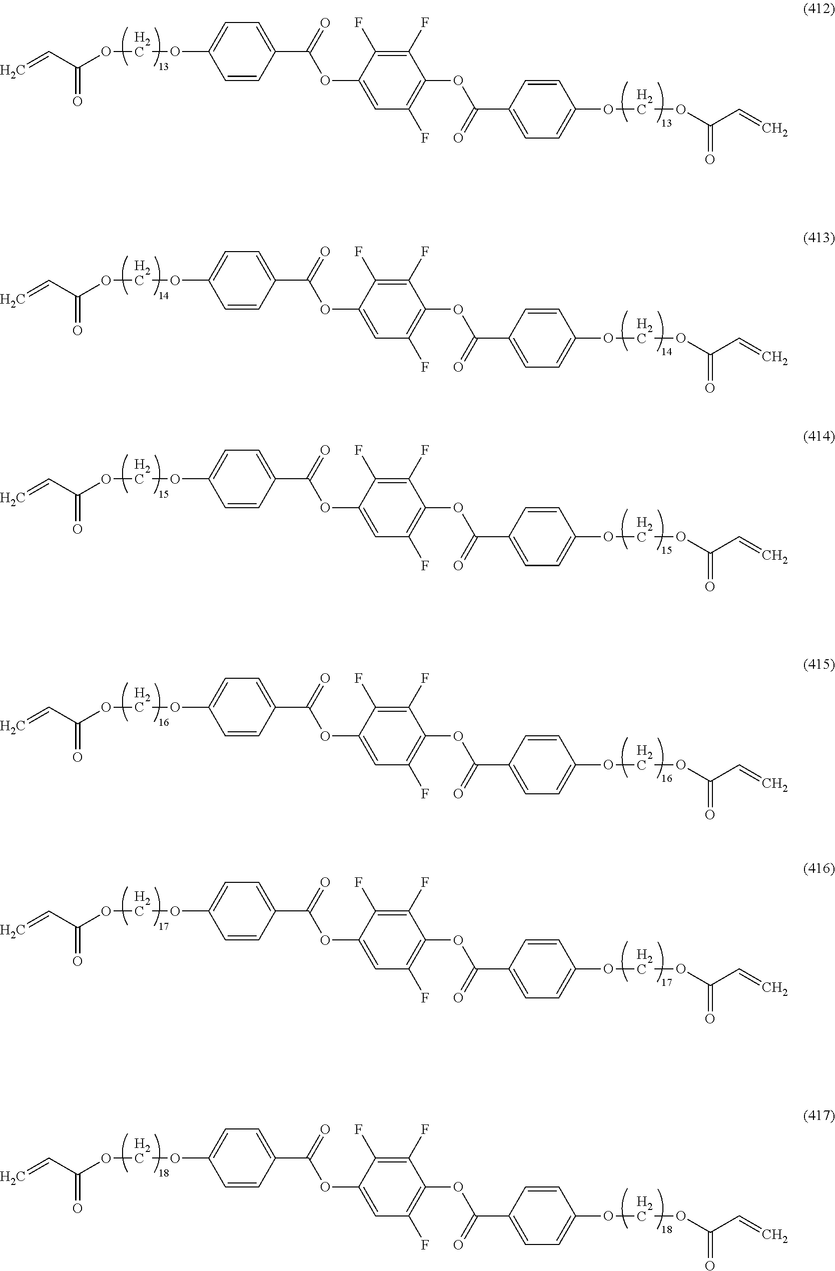

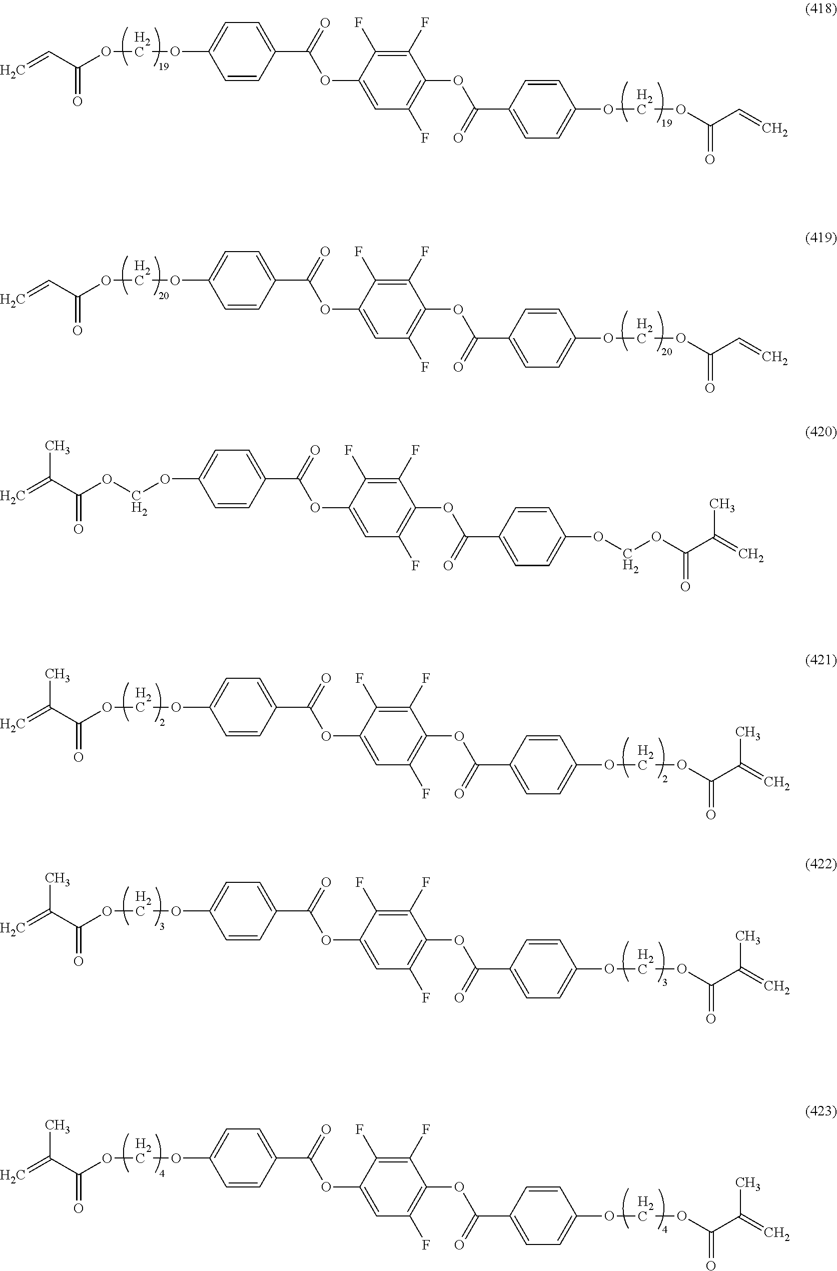

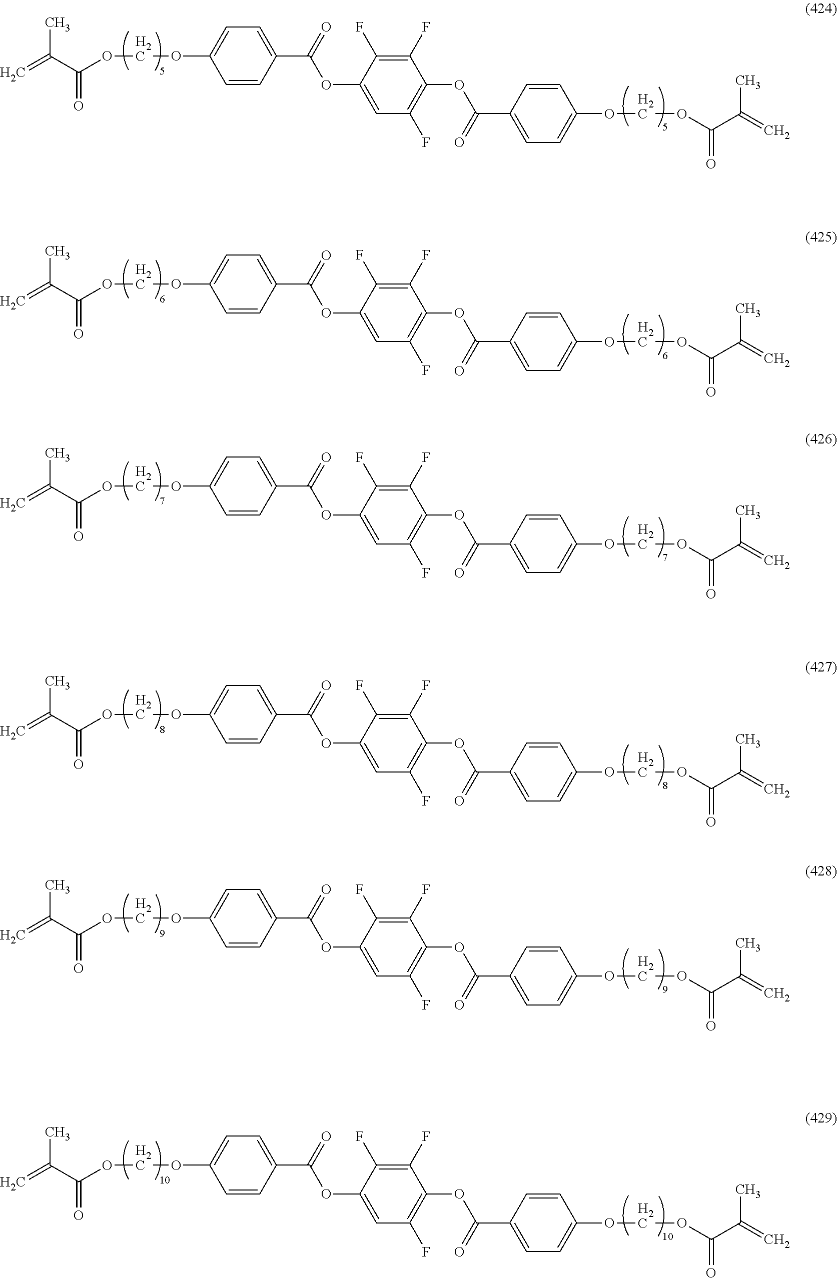

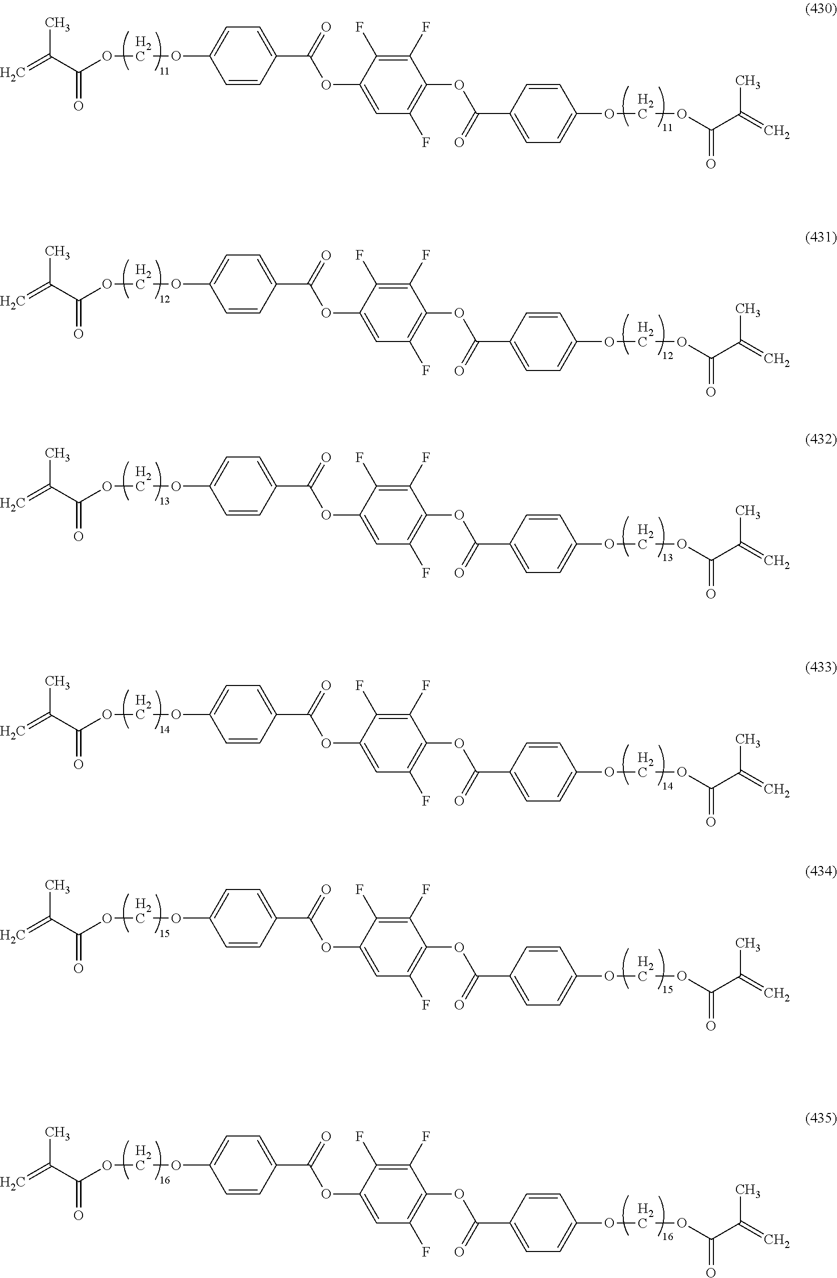

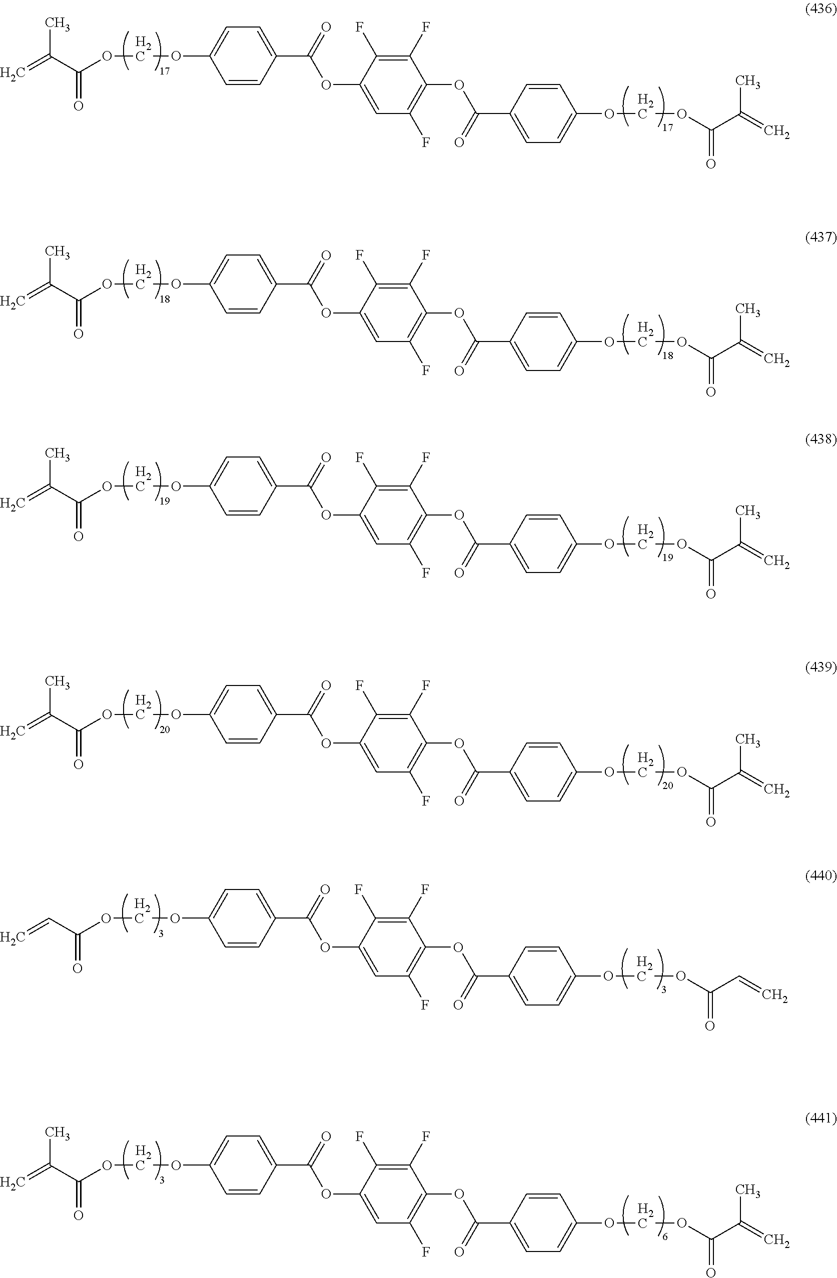

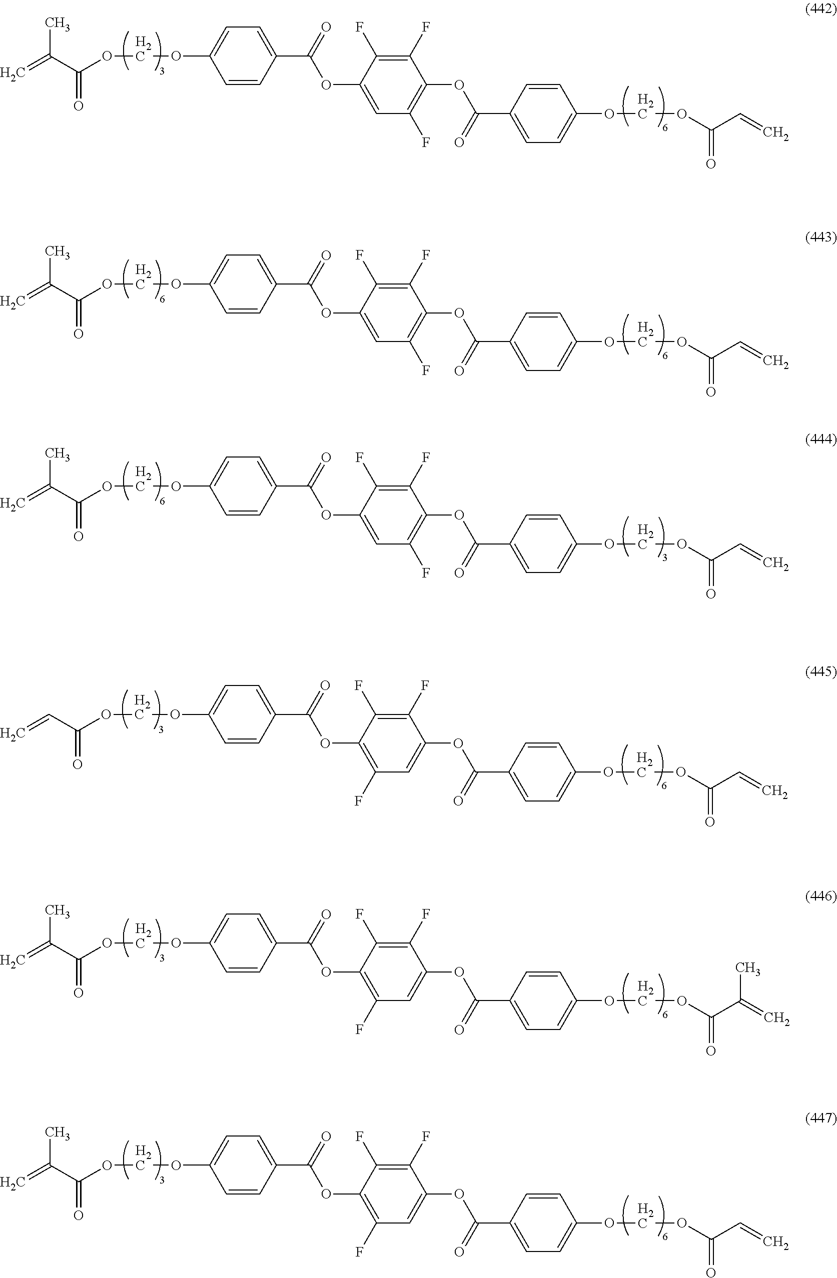

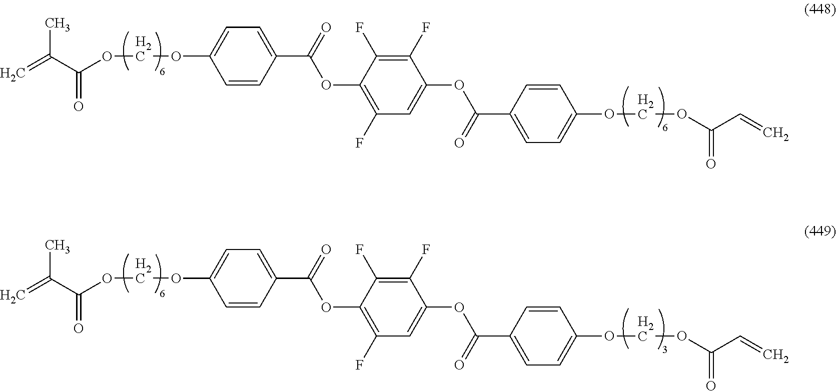

A variety of reactions can be applied to a synthesis method of the polymerizable monomer represented by General Formula (G1), which is included in the liquid crystal composition of one embodiment of the present invention. For example, through synthesis reactions shown in Synthesis Schemes (C-1), (C-2), and (D-1) given below, the polymerizable monomer which is represented by General Formula (G1) and included in the liquid crystal composition of one embodiment of the present invention can be synthesized. Note that the synthesis method of the polymerizable monomer represented by General Formula (G1) of one embodiment of the present invention is not limited to the synthesis method below.

A synthesis method of the polymerizable monomer represented by General Formula (G1) will be described.

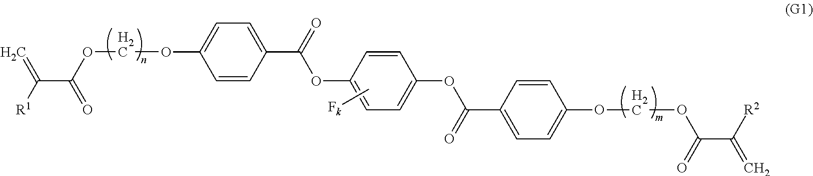

In General Formula (G1), k is 2 or 3, n and m are individually an integer from 1 to 20, and R¹ and R² individually represent hydrogen or a methyl group. First, with reference to Reaction Formulae (C-1) and (C-2) given below, a synthesis method of the polymerizable monomer represented by General Formula (G1) will be described.

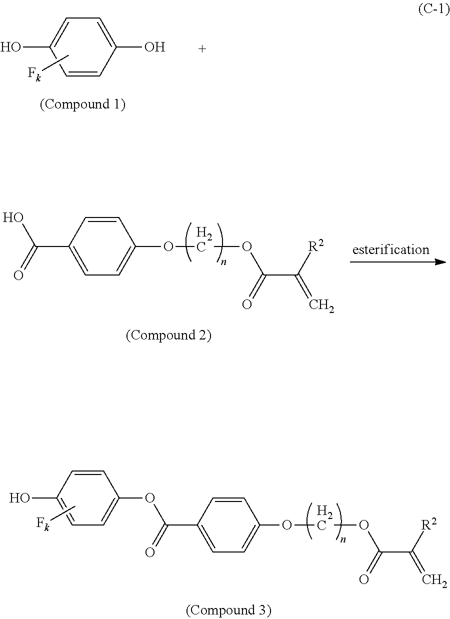

An esterification reaction between Compound 1 and a benzoic acid derivative (Compound 2) can give a hydroxyphenyl derivative (Compound 3) (Reaction Formula (C-1)). In Reaction Formula (C-1), k is 2 or 3, n and m are individually an integer from 1 to 20, and R¹ and R² individually represent hydrogen or a methyl group.

As the esterification reaction, an esterification reaction in which dehydration condensation using an acid catalyst is performed (addition-elimination reaction) is given. In the case where a dehydration condensation reaction is performed, an acid catalyst such as concentrated sulfuric acid or p-toluenesulfonic acid, 1-ethyl-3-(3-dimethylaminopropyl)carbodiimide hydrochloride (abbreviation: EDC), or dicyclohexyl carbodiimide (abbreviation: DCC) can be used. In the case where EDC or DCC is used, EDC is preferably used, in which case a by-product can be easily removed. The synthesis of Compound 3 is not limited to such reactions.

Next, a synthesis method of the polymerizable monomer represented by General Formula (G 1) will be described with reference to Reaction Formula (C-2) given below.

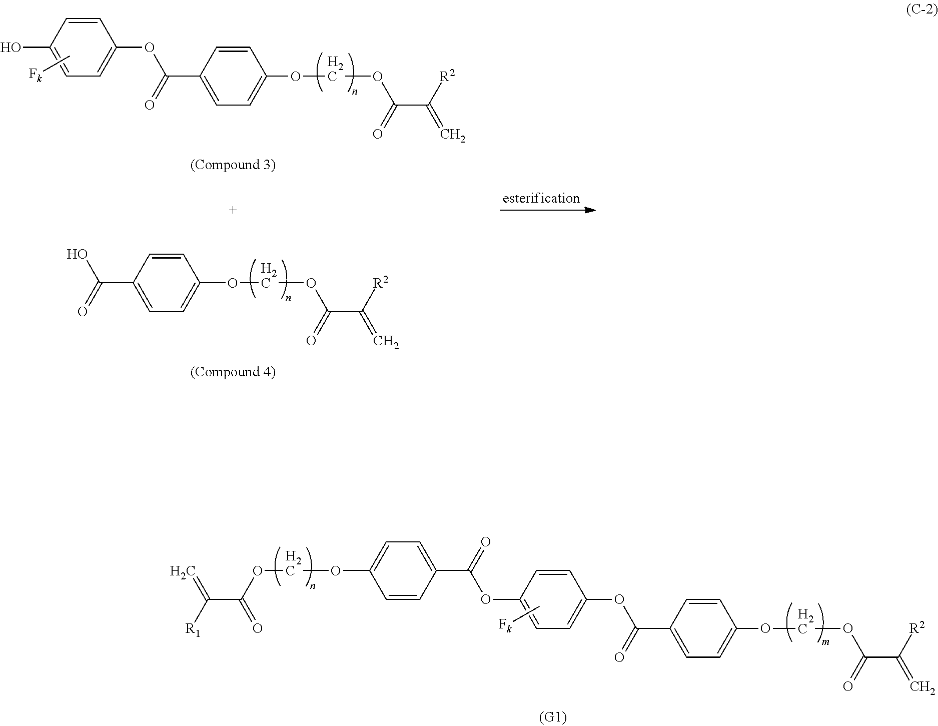

An esterification reaction between a benzoic acid derivative (Compound 4) and a hydroxyphenyl derivative (Compound 3) can give a target compound represented by General Formula (G 1) (Reaction Formula (C-2)). In Reaction Formula (C-2), k is 2 or 3, n and m are individually an integer from 1 to 20, and R¹ and R² individually represent hydrogen or a methyl group.

As the esterification reaction, an esterification reaction in which dehydration condensation using an acid catalyst is performed (addition-elimination reaction) is given. In the case where a dehydration condensation reaction is performed, an acid catalyst such as concentrated sulfuric acid or p-toluenesulfonic acid, 1-ethyl-3-(3-dimethylaminopropyl)carbodiimide hydrochloride (abbreviation: EDC), or dicyclohexyl carbodiimide (abbreviation: DCC) can be used. In the case where EDC or DCC is used, EDC is preferably used, in which case a by-product can be easily removed. The synthesis of the polymerizable monomer represented by General Formula (G1) is not limited to such reactions.

Next, a synthesis method of the polymerizable monomer represented by General Formula (G1) will be described referring to Reaction Formula (D-1) given below. The target compound (G1) of the synthesis in Reaction Formula (D-1) given below corresponds to the polymerizable monomer represented by General Formula (G1) in Reaction Formula (C-1) given above in which n=m and R¹═R².

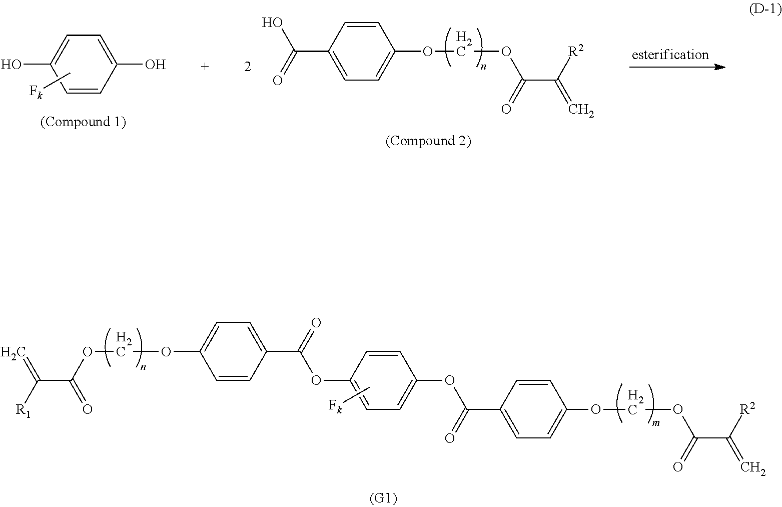

An esterification reaction between one equivalent of Compound 1 and two equivalents of a benzoic acid derivative (Compound 2) can give a target compound represented by General Formula (G1) (Reaction Formula (D-1)). In Reaction Formula (D-1), k is 2 or 3, n is an integer from 1 to 20, and R¹ represents hydrogen or a methyl group.

As the esterification reaction, an esterification reaction in which dehydration condensation using an acid catalyst is performed (addition-elimination reaction) is given. In the case where a dehydration condensation reaction is performed, an acid catalyst such as concentrated sulfuric acid or p-toluenesulfonic acid, 1-ethyl-3-(3-dimethylaminopropyl)carbodiimide hydrochloride (abbreviation: EDC), or dicyclohexyl carbodiimide (abbreviation: DCC) can be used. In the case where EDC or DCC is used, EDC is preferably used, in which case a by-product can be easily removed. The synthesis of the polymerizable monomer represented by General Formula (G1) is not limited to such reactions.

In the above manner, the polymerizable monomer represented by General Formula (G1) of one embodiment of the present invention can be synthesized.

In addition, a liquid crystal composition including the polymerizable monomer represented by General Formula (G1) of one embodiment of the present invention can be manufactured.

The liquid crystal composition of one embodiment of the present invention is a liquid crystal composition which includes the polymerizable monomer represented by General Formula (H1), a nematic liquid crystal, and a chiral material.

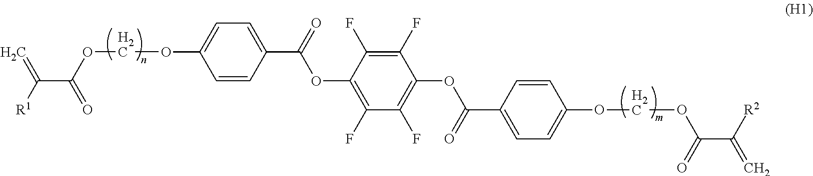

In General Formula (H1), n and m are individually an integer from 1 to 20, and R¹ and R² individually represent hydrogen or a methyl group.

The liquid crystal composition of one embodiment of the present invention is a liquid crystal composition which includes the polymerizable monomer represented by General Formula (H2), a nematic liquid crystal, and a chiral material.

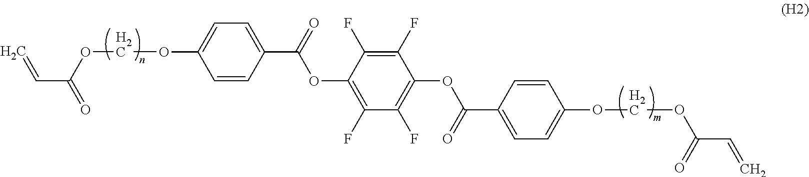

In General Formula (H2), n and m are individually an integer from 1 to 20.

The liquid crystal composition of one embodiment of the present invention is a liquid crystal composition which includes the polymerizable monomer represented by General Formula (H3), a nematic liquid crystal, and a chiral material.

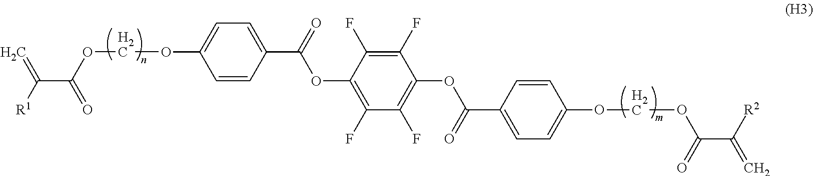

In General Formula (H3), n and m are individually an integer from 1 to 20, n=m, and R¹ and R² individually represent hydrogen or a methyl group.

The liquid crystal composition of one embodiment of the present invention is a liquid crystal composition which includes the polymerizable monomer represented by General Formula (H4), a nematic liquid crystal, and a chiral material.

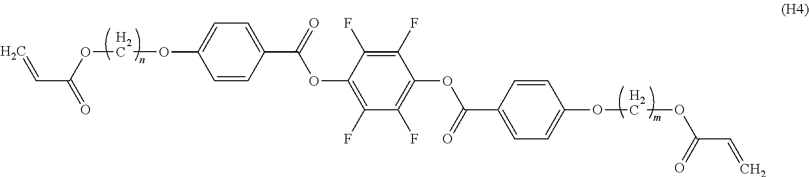

In General Formula (H4), n and m are individually an integer from 1 to 20, and n=m.

Specific examples of the polymerizable monomer represented by General Formula (H1) include polymerizable monomers represented by Structural Formula (500) to Structural Formula (544). However, the present invention is not limited thereto.

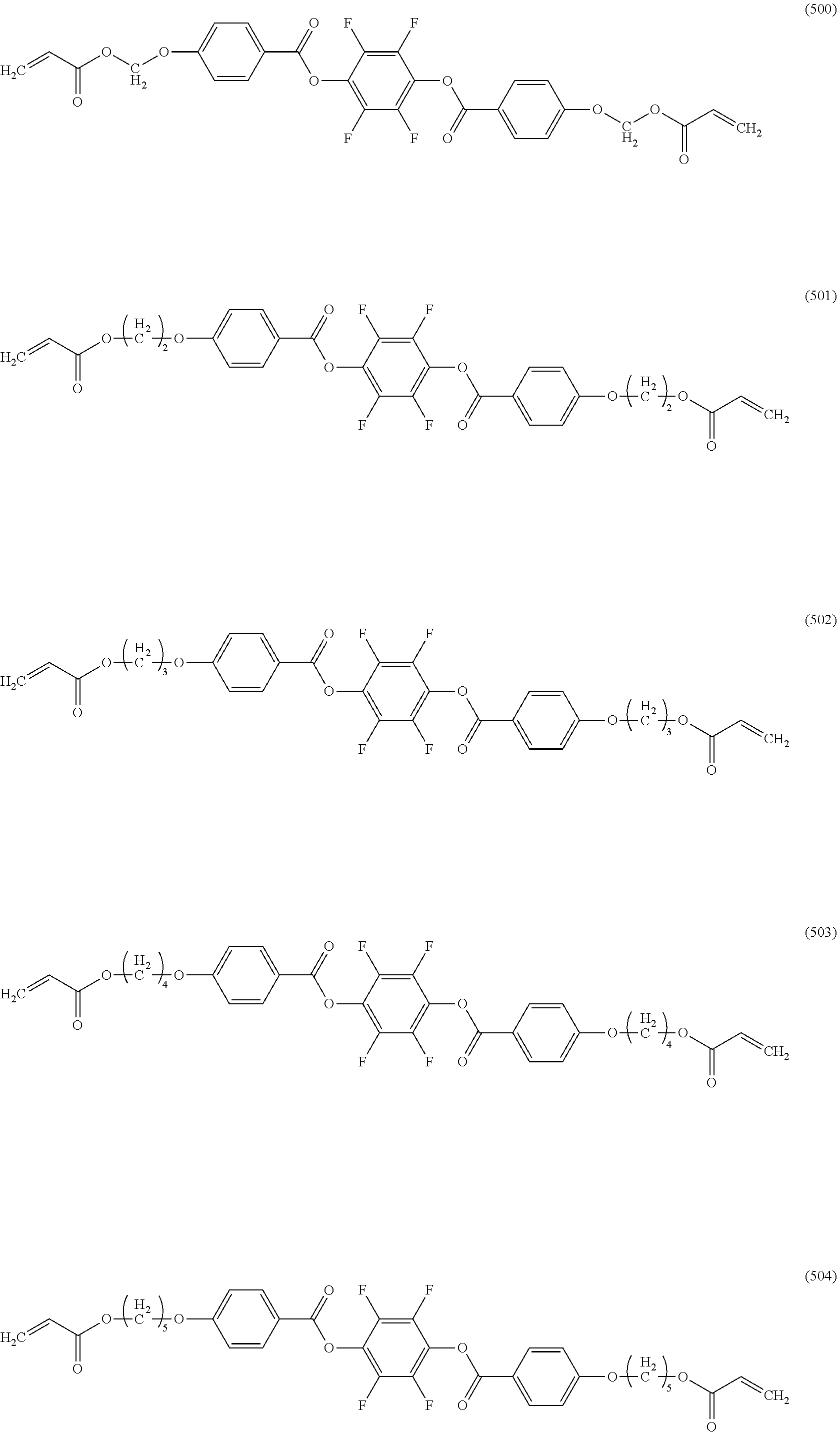

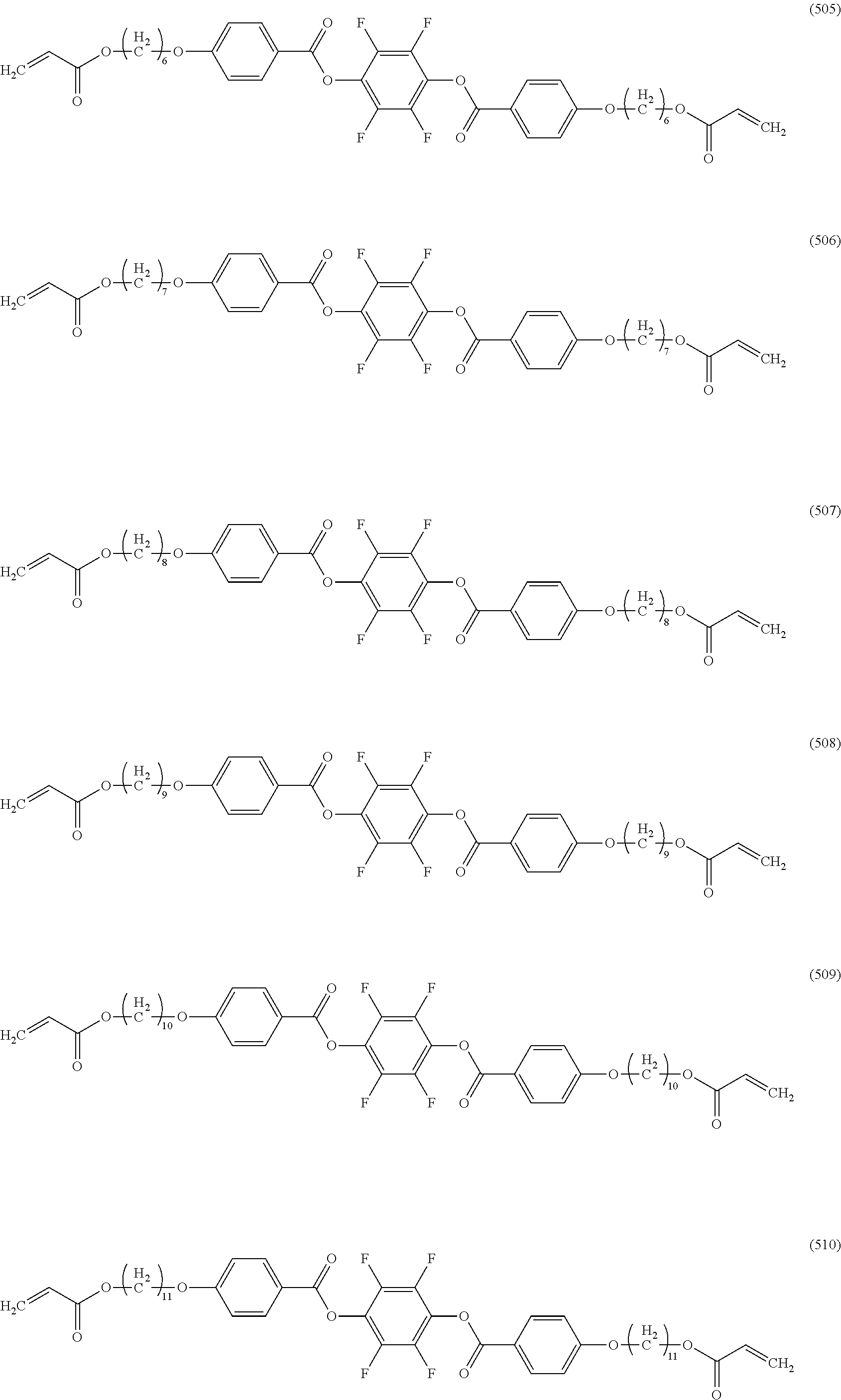

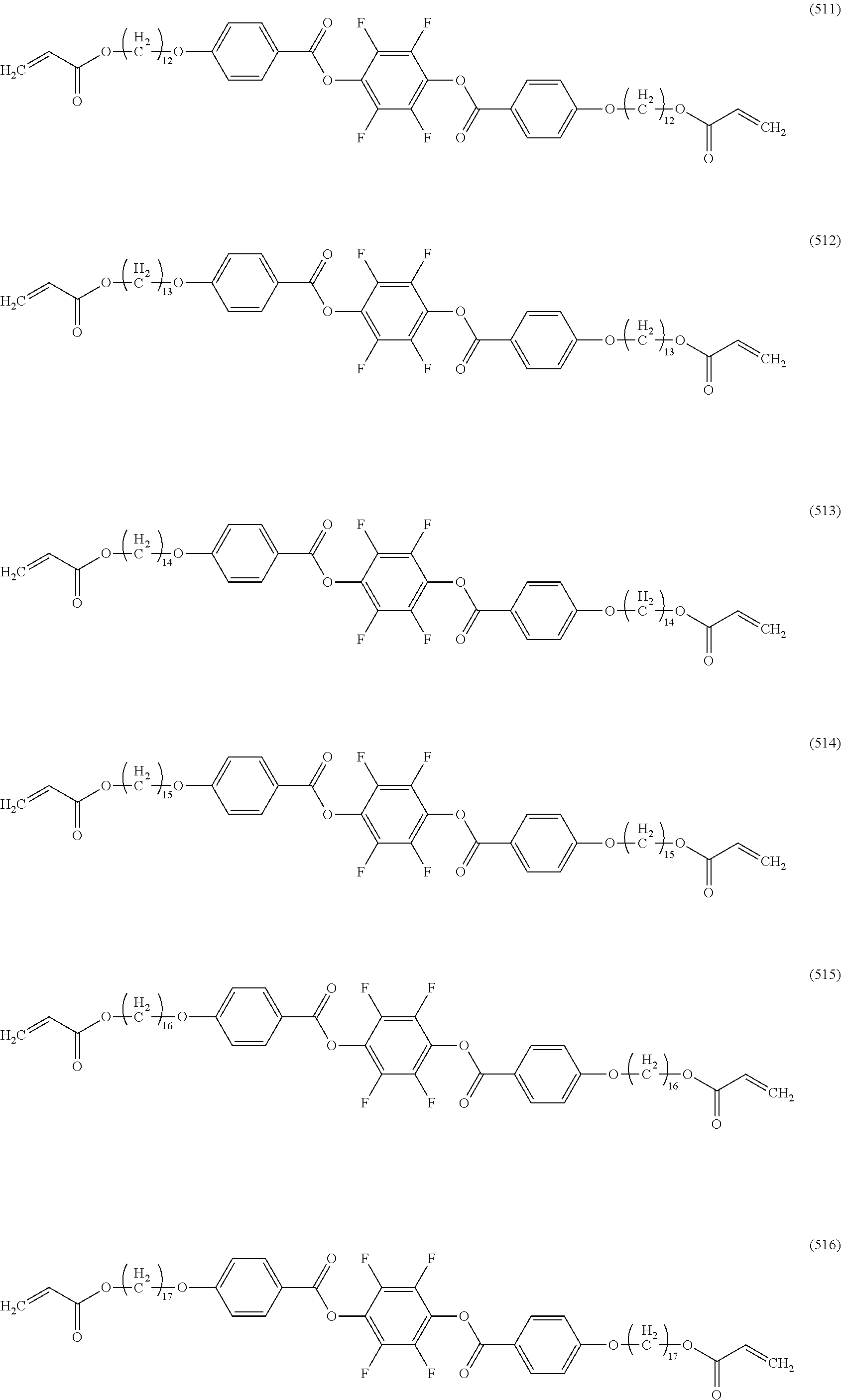

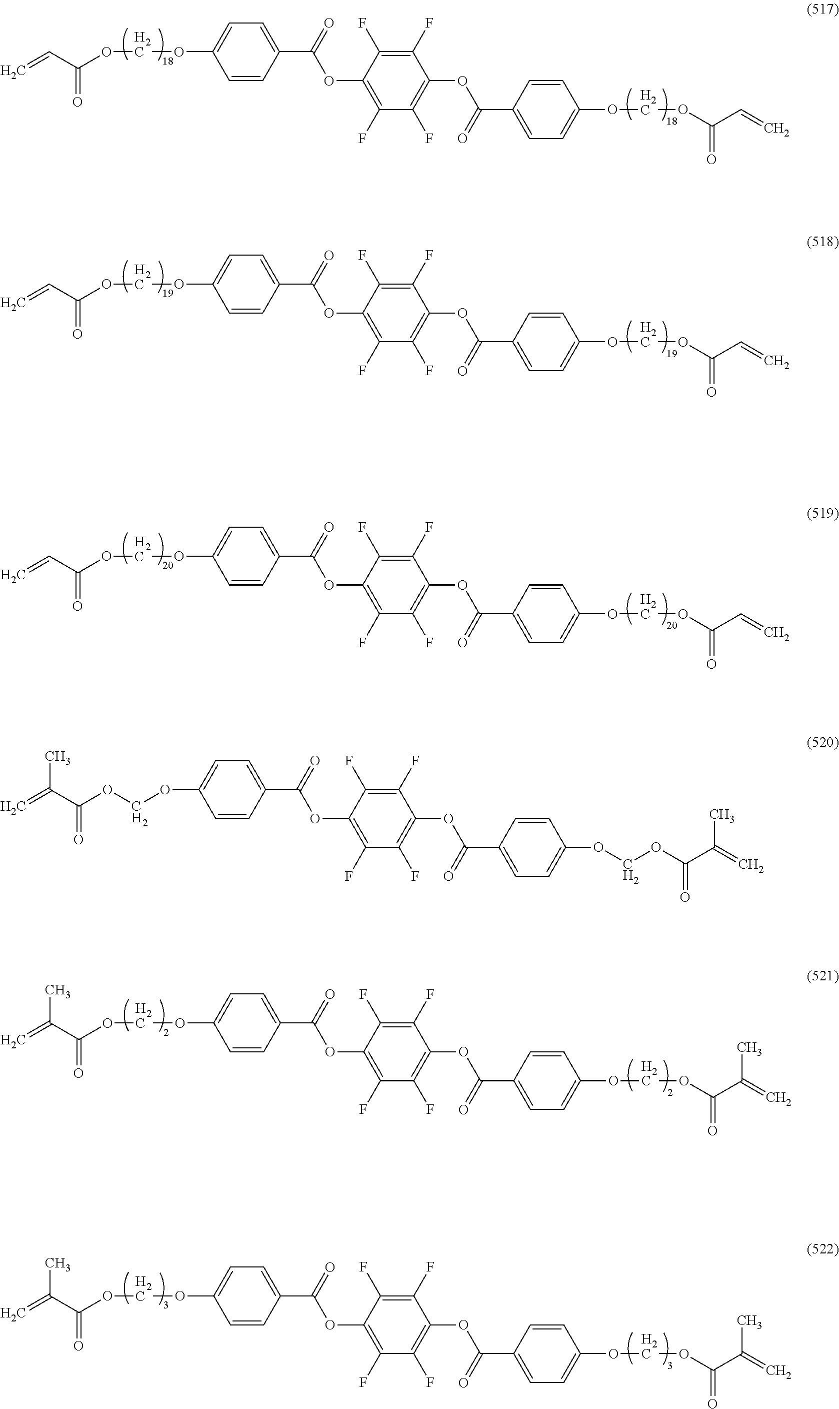

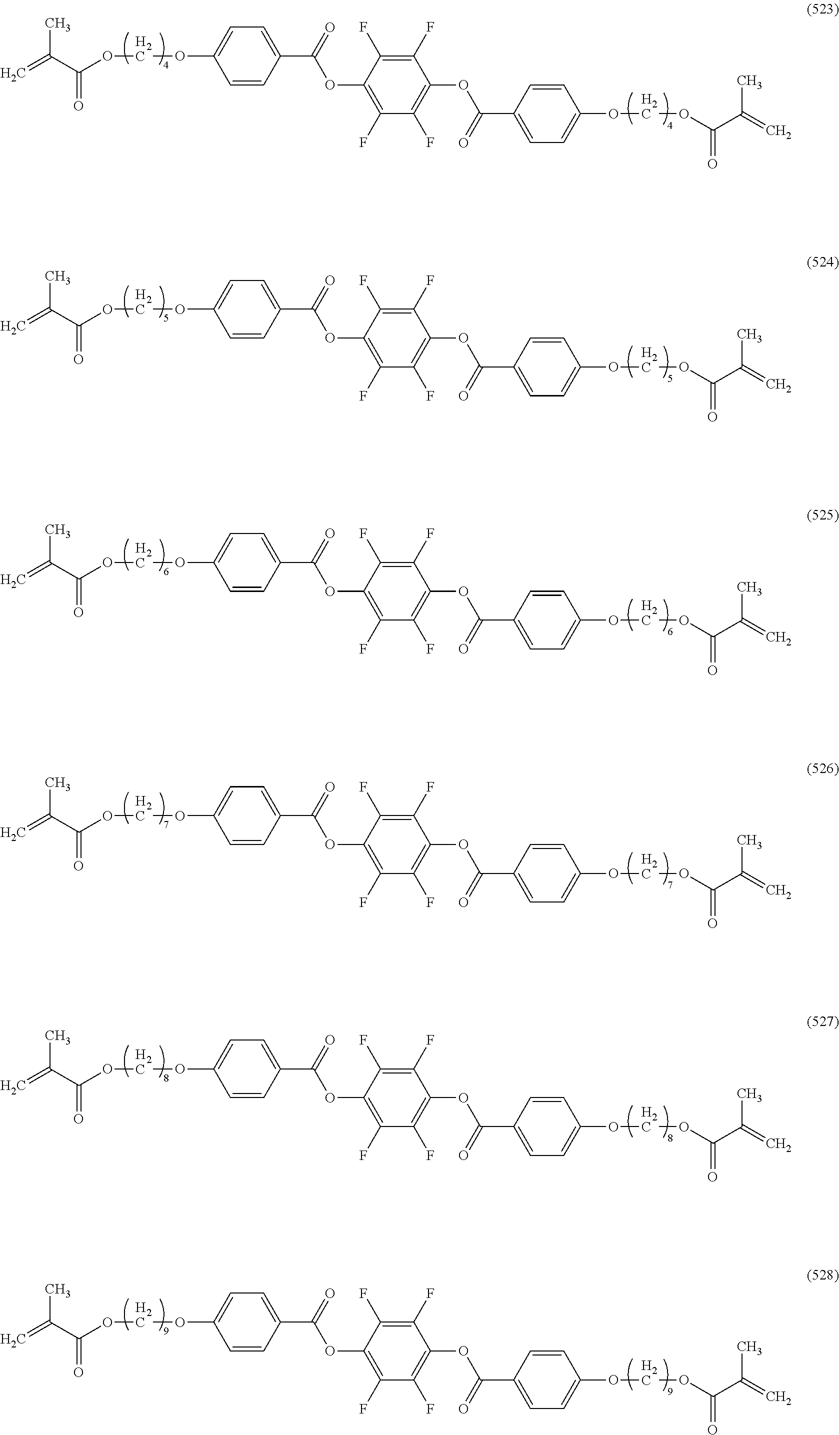

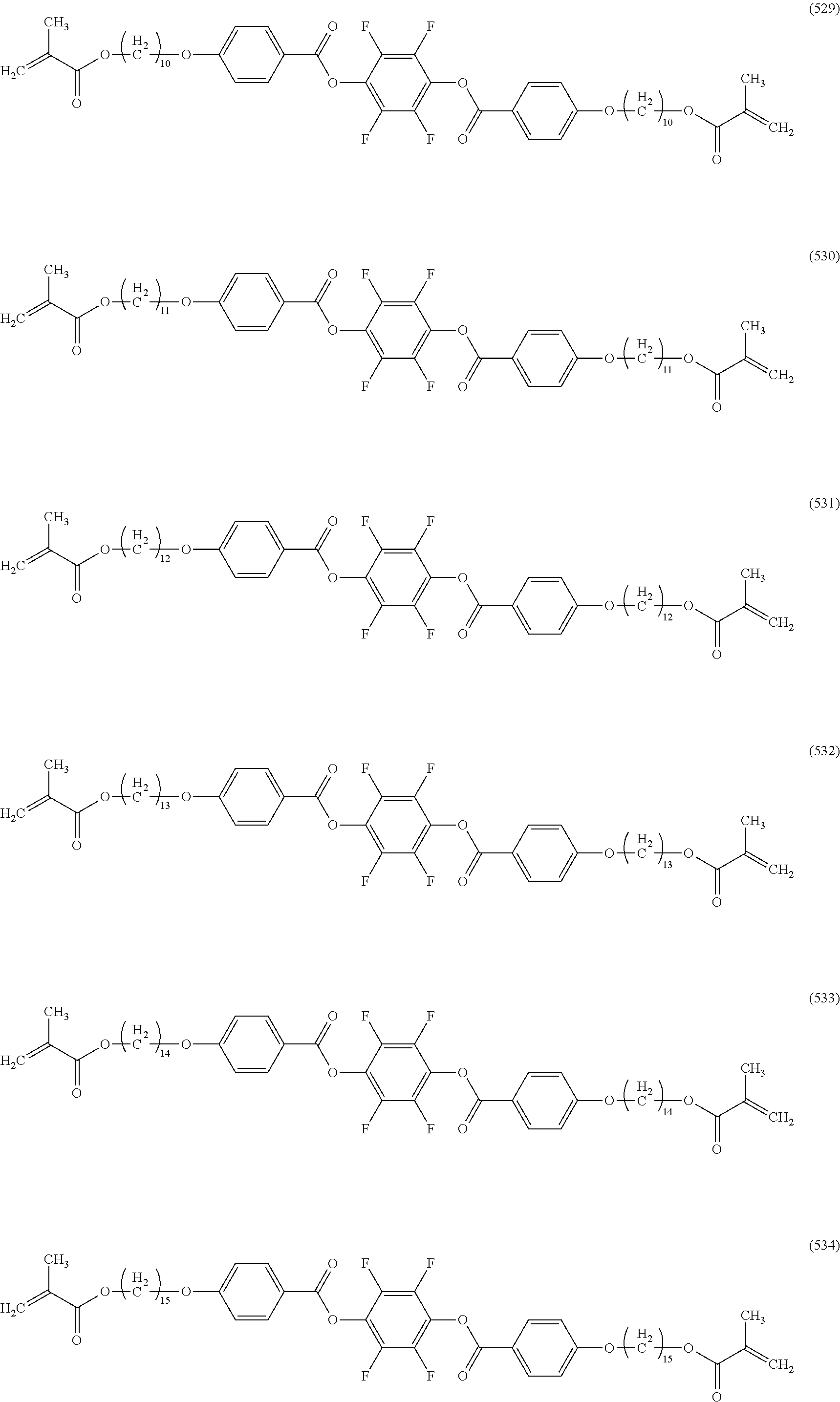

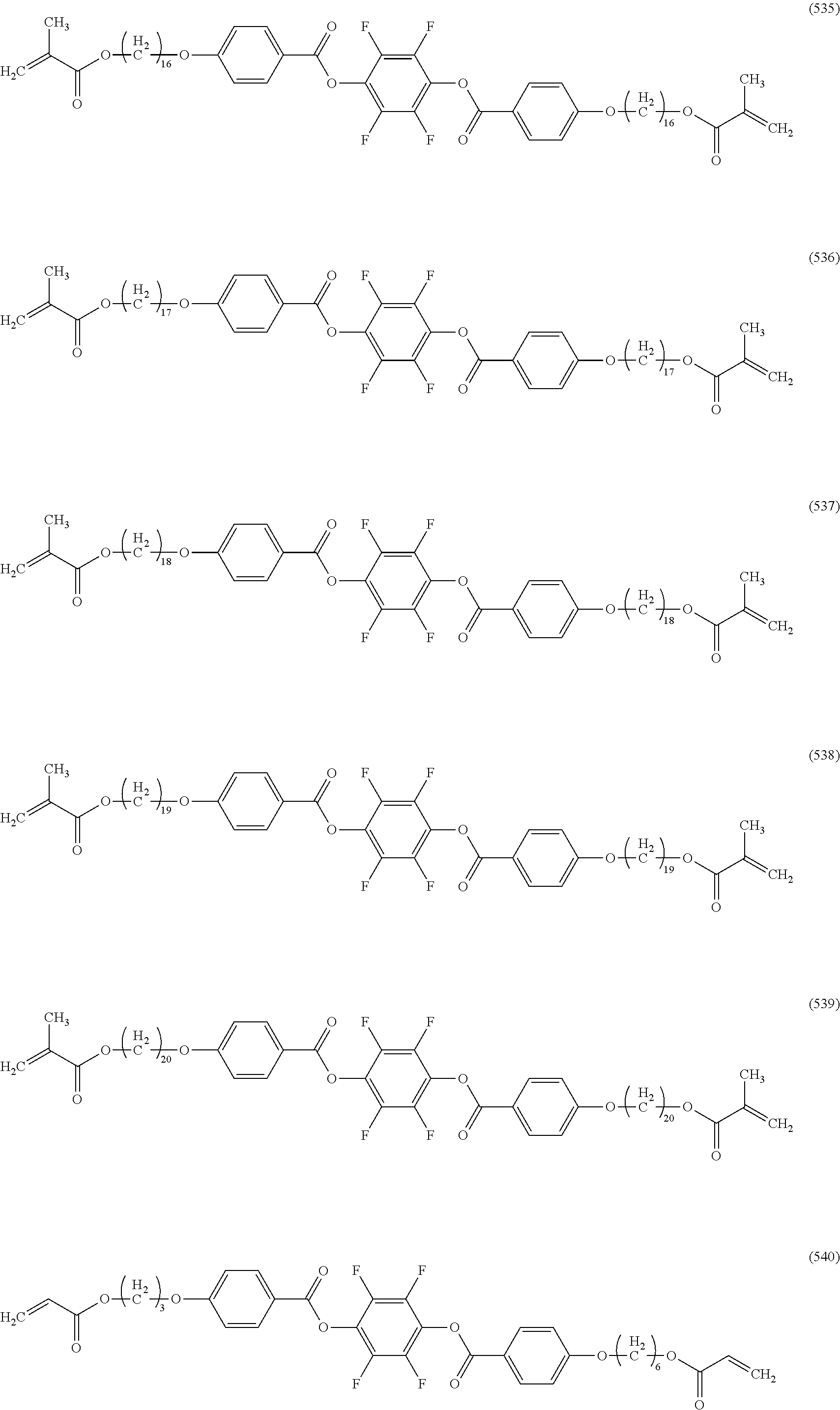

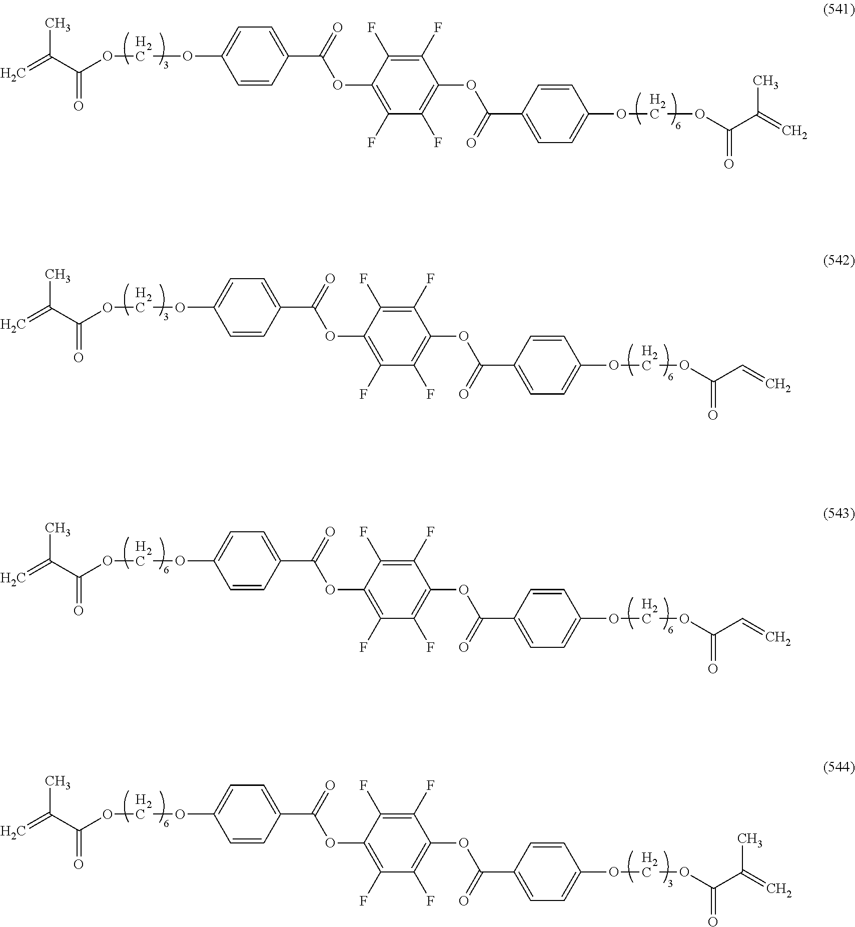

A variety of reactions can be applied to a synthesis method of the polymerizable monomer represented by General Formula (H1), which is included in the liquid crystal composition of one embodiment of the present invention. For example, through synthesis reactions shown in Synthesis Schemes (E-1), (E-2), and (F-1) given below, the polymerizable monomer which is represented by General Formula (H1) and included in the liquid crystal composition of one embodiment of the present invention can be synthesized. Note that the synthesis method of the polymerizable monomer represented by General Formula (H1) of one embodiment of the present invention is not limited to the synthesis method below.

A synthesis method of the polymerizable monomer represented by General Formula (H1) given below will be described.

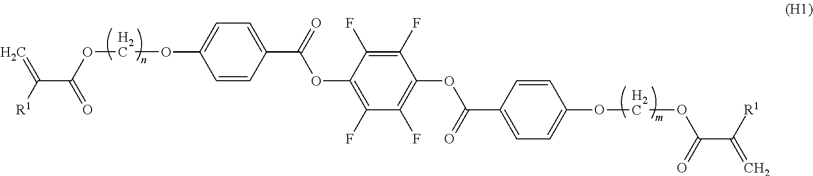

In General Formula (H1), n and m are individually an integer from 1 to 20; R¹ and R² individually represent hydrogen or a methyl group. First, with reference to Reaction Formulae (E-1) and (E-2) given below, a synthesis method of the polymerizable monomer represented by General Formula (H1) will be described.

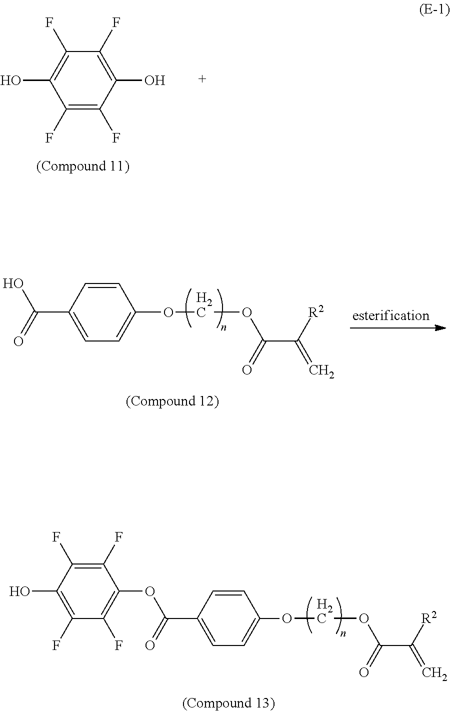

An esterification reaction between tetrafluoro-1,4-benzenediol (Compound 11) and a benzoic acid derivative (Compound 12) can give a hydroxyphenyl derivative (Compound 13) (Reaction Formula (E-1)). In Reaction Formula (E-1), n and m are individually an integer from 1 to 20, and R¹ and R² individually represent hydrogen or a methyl group.

As the esterification reaction, an esterification reaction in which dehydration condensation using an acid catalyst is performed (addition-elimination reaction) is given. In the case where a dehydration condensation reaction is performed, an acid catalyst such as concentrated sulfuric acid or p-toluenesulfonic acid, 1-ethyl-3-(3-dimethylaminopropyl)carbodiimide hydrochloride (abbreviation: EDC), or dicyclohexyl carbodiimide (abbreviation: DCC) can be used. In the case where EDC or DCC is used, EDC is preferably used, in which case a by-product can be easily removed. The synthesis of Compound 13 is not limited to such reactions.

Next, a synthesis method of the polymerizable monomer represented by General Formula (H1) will be described with reference to Reaction Formula (E-2) given below.

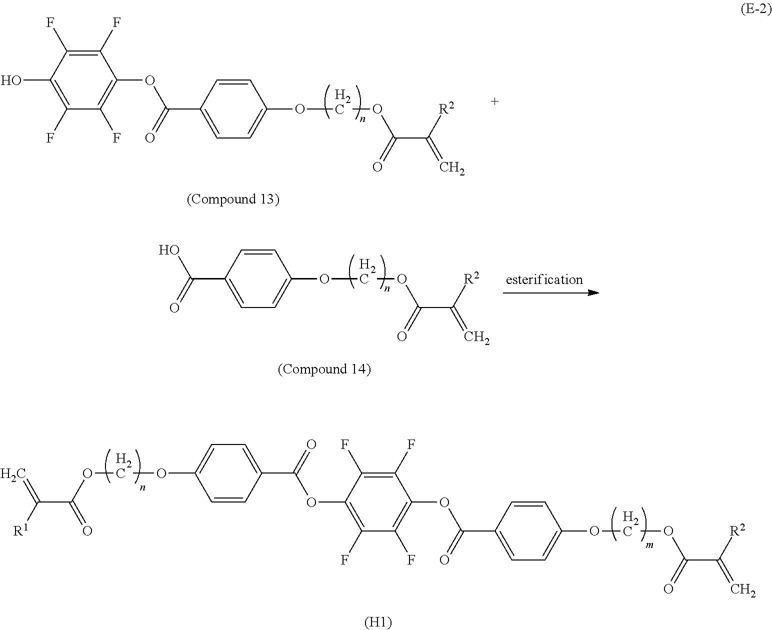

An esterification reaction between a benzoic acid derivative (Compound 14) and a hydroxyphenyl derivative (Compound 13) can give the target compound represented by General Formula (H1) (Reaction Formula (E-2)). In Reaction Formula (E-2), n and m are individually an integer from 1 to 20, and R¹ and R² individually represent hydrogen or a methyl group.

As the esterification reaction, an esterification reaction in which dehydration condensation using an acid catalyst is performed (addition-elimination reaction) is given. In the case where a dehydration condensation reaction is performed, an acid catalyst such as concentrated sulfuric acid or p-toluenesulfonic acid, 1-ethyl-3-(3-dimethylaminopropyl)carbodiimide hydrochloride (abbreviation: EDC), or dicyclohexyl carbodiimide (abbreviation: DCC) can be used. In the case where EDC or DCC is used, EDC is preferably used, in which case a by-product can be easily removed. The synthesis of the polymerizable monomer represented by General Formula (H1) is not limited to such reactions.

Next, a synthesis method of the polymerizable monomer represented by General Formula (H1) will be described with reference to Reaction Formula (F-1) given below. The target compound (H1) of the synthesis in Reaction Formula (F-1) given below corresponds to the polymerizable monomer represented by General Formula (H1) in Reaction Formula (E-1) given above in which n=m and R¹═R².

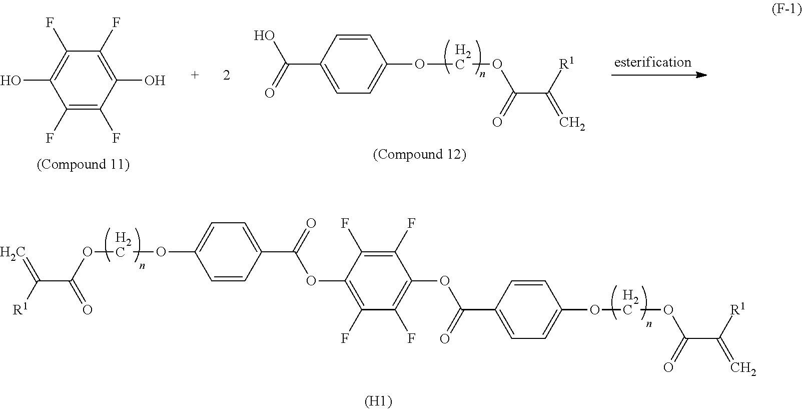

An esterification reaction between one equivalent of tetrafluoro-1,4-benzenediol (Compound 11) and two equivalents of a benzoic acid derivative (Compound 12) can give the target compound represented by General Formula (H1) (Reaction Formula (F-1)). In Reaction Formula (F-1), n is an integer from 1 to 20, and R¹ represents hydrogen or a methyl group.

As the esterification reaction, an esterification reaction in which dehydration condensation using an acid catalyst is performed (addition-elimination reaction) is given. In the case where a dehydration condensation reaction is performed, an acid catalyst such as concentrated sulfuric acid or p-toluenesulfonic acid, 1-ethyl-3-(3-dimethylaminopropyl)carbodiimide hydrochloride (abbreviation: EDC), or dicyclohexyl carbodiimide (abbreviation: DCC) can be used. In the case where EDC or DCC is used, EDC is preferably used, in which case a by-product can be easily removed. The synthesis of the polymerizable monomer represented by General Formula (H1) is not limited to such reactions.

In the above manner, the polymerizable monomer represented by General Formula (H1), which is included in the liquid crystal composition of one embodiment of the present invention, can be synthesized.

The liquid crystal composition of one embodiment of the present invention, which includes the polymerizable monomer represented by General Formula (G1), a nematic liquid crystal, and a chiral material, can be used as a liquid crystal composition exhibiting a blue phase.

The liquid crystal composition of one embodiment of the present invention, which includes the polymerizable monomer represented by General Formula (H1), a nematic liquid crystal, and a chiral material, can be used as a liquid crystal composition exhibiting a blue phase.

The nematic liquid crystal is not particularly limited; examples thereof are a biphenyl-based compound, a terphenyl-based compound, a phenylcyclohexyl-based compound, a biphenylcyclohexyl-based compound, a phenylbicyclohexyl-based compound, a benzoic acid phenyl-based compound, a cyclohexyl benzoic acid phenyl-based compound, a phenyl benzoic acid phenyl-based compound, a bicyclohexyl carboxylic acid phenyl-based compound, an azomethine-based compound, an azo-based compound, an azoxy-based compound, a stilbene-based compound, a bicyclohexyl-based compound, a phenylpyrimidine-based compound, a biphenylpyrimidine-based compound, a pyrimidine-based compound, and a biphenyl ethyne-based compound.

The chiral material is used to induce twisting of the liquid crystal composition, align the liquid crystal composition in a helical structure, and make the liquid crystal composition exhibit a blue phase. For the chiral material, a compound which has an asymmetric center, high compatibility with the liquid crystal composition, and strong twisting power is used. In addition, the chiral material is an optically active substance; a higher optical purity is better and the most preferable optical purity is 99% or higher.

A blue phase is optically isotropic and thus has no viewing angle dependence. Thus, an alignment film does not need to be formed, which results in improvement of display image quality and cost reduction.

In manufacture of a liquid crystal display device using the liquid crystal composition of one embodiment of the present invention, polymer stabilization treatment for extending the temperature range within which a blue phase is exhibited can be performed using the polymerization monomer included in the liquid crystal composition.

In the liquid crystal composition of one embodiment of the present invention, at least the polymerizable monomer represented by General Formula (G1) or the polymerizable monomer represented by General Formula (H1) is included as a polymerizable monomer.

The use of the liquid crystal composition of one embodiment of the present invention enables low voltage driving of a liquid crystal element, whereby power consumption of a liquid crystal display device, an electronic appliance, or the like can be reduced. Note that the liquid crystal composition of one embodiment of the present invention can be used for an optical appliance which does not have a display function such as an optical shutter.

Further, plural types of polymerizable monomers may be used. In addition to the polymerizable monomer represented by General Formula (G1) and the polymerizable monomer represented by General Formula (H1), other polymerizable monomers can be used.

Examples of the polymerizable monomer that can be used other than the polymerizable monomer represented by General Formula (G1) and the polymerizable monomer represented by General Formula (H1) include a thermopolymerizable (thermosetting) monomer which can be polymerized by heat, a photopolymerizable (photocurable) monomer which can be polymerized by light, and a polymerizable monomer which can be polymerized by heat and light. Further, a polymerization initiator may be added to the liquid crystal composition.

The polymerizable monomer that can be used other than the polymerizable monomers represented by General Formulae (G1) and (H1) may be a monofunctional monomer such as acrylate or methacrylate; a polyfunctional monomer such as diacrylate, triacrylate, dimethacrylate, or trimethacrylate; or a mixture thereof. Further, the polymerizable monomer may have liquid crystallinity, non-liquid crystallinity, or both of them.

As the polymerization initiator, a radical polymerization initiator which generates radicals by light irradiation, an acid generator which generates an acid by light irradiation, or a base generator which generates a base by light irradiation may be used. Since the polymerizable monomer represented by General Formula (G1) and the polymerization monomer represented by General Formula (H1) is a photopolymerizable monomer, a photopolymerization initiator is used.

Polymer stabilization treatment can be performed in such a manner that a photopolymerization initiator is added to the liquid crystal composition including the polymerizable monomer represented by General Formula (G1) or the polymerizable monomer represented by General Formula (H1), which is a photopolymerizable monomer, and the mixture is irradiated with light at which the polymerizable monomer represented by General Formula (G 1) or the polymerizable monomer represented by General Formula (H1) reacts with the photopolymerization initiator.

The polymer stabilization treatment may be performed on a liquid crystal composition exhibiting an isotropic phase or a liquid crystal composition exhibiting a blue phase under the control of the temperature. Note that a temperature at which the phase changes from a blue phase to an isotropic phase when the temperature rises, or a temperature at which the phase changes from an isotropic phase to a blue phase when the temperature falls is referred to as the phase transition temperature between a blue phase and an isotropic phase. For example, the polymer stabilization treatment can be performed in the following manner: after a liquid crystal composition to which a photopolymerizable monomer is added is heated to exhibit an isotropic phase, the temperature of the liquid crystal composition is gradually lowered so that the phase changes to a blue phase, and then, light irradiation is performed while the temperature at which a blue phase is exhibited is kept.

FIGS. 1A and 1B illustrate examples of a liquid crystal element and a liquid crystal display device of one embodiment of the present invention.

The liquid crystal element of one embodiment of the present invention includes at least a liquid crystal composition 208 between a pair of electrode layers (a pixel electrode layer 230 and a common electrode layer 232 having different potentials).

The liquid crystal composition of one embodiment of the present invention is a liquid crystal composition which includes the polymerizable monomer represented by General Formula (G1), a nematic liquid crystal, and a chiral material, or a liquid crystal composition which includes the polymerizable monomer represented by General Formula (H1), a nematic liquid crystal, and a chiral material. In the liquid crystal element of one embodiment of the present invention, the liquid crystal composition of one embodiment of the present invention is used as the liquid crystal composition 208.

FIGS. 1A and 1B each illustrate a liquid crystal display device in which a first substrate 200 and a second substrate 201 are positioned so as to face each other with the liquid crystal composition 208 interposed therebetween. A difference between the liquid crystal element and the liquid crystal display device in FIG. 1A and those in FIG. 1B is positions of the pixel electrode layer 230 and the common electrode layer 232 relative to the liquid crystal composition 208.

In the liquid crystal element and the liquid crystal display device illustrated in FIG. 1A, the pixel electrode layer 230 and the common electrode layer 232 are provided adjacent to each other between the first substrate 200 and the liquid crystal composition 208. With the structure illustrated in FIG. 1A, a method in which the gray scale is controlled by generating an electric field substantially parallel (i.e., in a lateral direction) to a substrate to move liquid crystal molecules in a plane parallel to the substrate can be used.

The structure illustrated in FIG. 1A can be favorably applied to the case where the liquid crystal composition 208 is formed of the above liquid crystal composition exhibiting a blue phase, which is the liquid crystal composition of one embodiment of the present invention. The liquid crystal composition provided as the liquid crystal composition 208 may contain an organic resin. After the polymer stabilization treatment, the liquid crystal composition includes polymerizable monomers of one embodiment of the present invention with polymerized terminal acryloyl groups. Thus one embodiment of the present invention provides a liquid crystal element, a liquid crystal display device, or an electronic appliance which includes the above liquid crystal composition.

With an electric field formed between the pixel electrode layer 230 and the common electrode layer 232, a liquid crystal is controlled. An electric field in a lateral direction is formed for the liquid crystal, so that liquid crystal molecules can be controlled using the electric field. The liquid crystal composition exhibiting a blue phase is capable of high-speed response. Thus, a high-performance liquid crystal element and a high-performance liquid crystal display device can be achieved. Since the liquid crystal molecules aligned to exhibit a blue phase can be controlled in the direction parallel to the substrate, a wide viewing angle is obtained.

For example, such a liquid crystal composition exhibiting a blue phase, which is capable of high-speed response, can be favorably used for a successive additive color mixing method (field sequential method) in which light-emitting diodes (LEDs) of RGB or the like are arranged in a backlight unit and color display is performed by time division, or a three-dimensional display method using a shutter glasses system in which images for a right eye and images for a left eye are alternately viewed by time division.

In the liquid crystal element and the liquid crystal display device illustrated in FIG. 1B, the pixel electrode layer 230 and the common electrode layer 232 are provided on the first substrate 200 side and the second substrate 201 side respectively, with the liquid crystal composition 208 interposed therebetween. With the structure illustrated in FIG. 1B, a method in which the gray scale is controlled by generating an electric field substantially perpendicular to a substrate to move liquid crystal molecules in a plane perpendicular to the substrate can be used. An alignment film 202a and an alignment film 202b may be provided between the liquid crystal composition 208 and the pixel electrode layer 230 and between the liquid crystal composition 208 and the common electrode layer 232, respectively. The liquid crystal composition of one embodiment of the present invention can be used in liquid crystal elements with a variety of structures and liquid crystal display devices with a variety of display modes.

The pixel electrode layer 230 and the common electrode layer 232, which are adjacent to each other with the liquid crystal composition 208 interposed therebetween, have a distance at which liquid crystal in the liquid crystal composition 208 between the pixel electrode layer 230 and the common electrode layer 232 responds to a predetermined voltage which is applied to the pixel electrode layer 230 and the common electrode layer 232. The voltage applied is controlled depending on the distance as appropriate.

The maximum thickness (film thickness) of the liquid crystal composition 208 is preferably greater than or equal to 1 μm and less than or equal to 20 μm.

The liquid crystal composition 208 can be formed by a dispenser method (dropping method), or an injection method by which liquid crystal is injected using capillary action or the like after the first substrate 200 and the second substrate 201 are attached to each other.

Although not illustrated in FIGS. 1A and 1B, an optical film such as a polarizing plate, a retardation plate, or an anti-reflection film, or the like is provided as appropriate. For example, circular polarization with a polarizing plate and a retardation plate may be used. In addition, a backlight or the like can be used as a light source.

In this specification, a substrate provided with a semiconductor element (e.g., a transistor) or a pixel electrode layer is referred to as an element substrate (a first substrate), and a substrate which faces the element substrate with a liquid crystal composition interposed therebetween is referred to as a counter substrate (a second substrate).

As a liquid crystal display device of one embodiment of the present invention, the following liquid crystal devices can be provided: a transmissive liquid crystal display device in which display is performed by transmission of light from a light source, a reflective liquid crystal display device in which display is performed by reflection of incident light, or a transflective liquid crystal display device in which a transmissive type and a reflective type are combined.

In the case of the transmissive liquid crystal display device, a pixel electrode layer, a common electrode layer, a first substrate, a second substrate, and other components such as an insulating film and a conductive film, which are provided in a pixel region through which light is transmitted, have a property of transmitting light in the visible wavelength range. In the liquid crystal display device having the structure illustrated in FIG. 1A, it is preferable that the pixel electrode layer and the common electrode layer have a light-transmitting property; however, if an opening pattern is provided, a non-light-transmitting material such as a metal film may be used depending on the shape.

On the other hand, in the case of the reflective liquid crystal display device, a reflective component which reflects light transmitted through the liquid crystal composition (e.g., a reflective film or a substrate) may be provided on the side opposite to the viewing side of the liquid crystal composition. Therefore, a substrate, an insulating film, and a conductive film which are provided between the viewing side and the reflective component and through which light is transmitted have a light-transmitting property with respect to light in the visible wavelength range. Note that in this specification, the light-transmitting property refers to a property of transmitting at least light in the visible wavelength range. In the liquid crystal display device having the structure illustrated in FIG. 1B, the pixel electrode layer or the common electrode layer on the side opposite to the viewing side may have a light-reflecting property so that it can be used as a reflective component.

The pixel electrode layer 230 and the common electrode layer 232 may be formed using one or more of the following: indium tin oxide, a conductive material in which zinc oxide (ZnO) is mixed with indium oxide, a conductive material in which silicon oxide (SiO₂) is mixed with indium oxide, organoindium, organotin, indium oxide containing tungsten oxide, indium zinc oxide containing tungsten oxide, indium oxide containing titanium oxide, and indium tin oxide containing titanium oxide, graphene, metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag), alloys thereof, and nitrides thereof.

As the first substrate 200 and the second substrate 201, a glass substrate of barium borosilicate glass, aluminoborosilicate glass, or the like, a quartz substrate, a plastic substrate, or the like can be used. Note that in the case of the reflective liquid crystal display device, a metal substrate such as an aluminum substrate or a stainless steel substrate may be used as a substrate on the side opposite to the viewing side.

In the above manner, a novel liquid crystal composition which includes the polymerizable monomer represented by General Formula (G1), a nematic liquid crystal, and a chiral material can be provided.

In addition, in the above manner, a novel liquid crystal composition which includes the polymerizable monomer represented by General Formula (H1), a nematic liquid crystal, and a chiral material can be provided.

Thus, the use of the liquid crystal composition makes it possible to provide a liquid crystal element or a liquid crystal display device with lower driving voltage. Consequently, a liquid crystal display device with low power consumption can be provided.

This embodiment can be implemented in appropriate combination with any of the structures described in the other embodiments.

### Embodiment 2

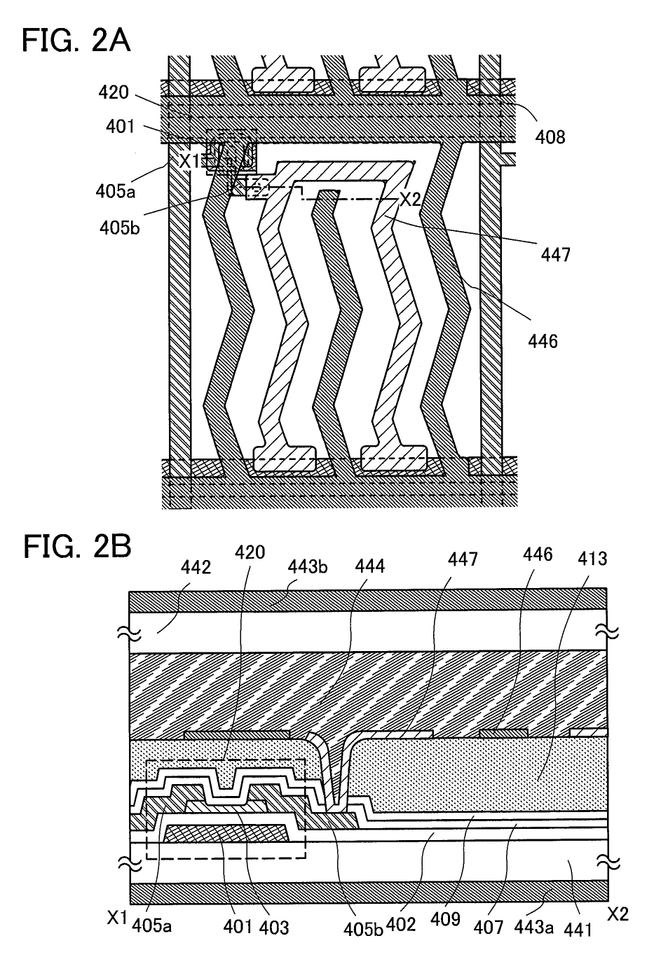

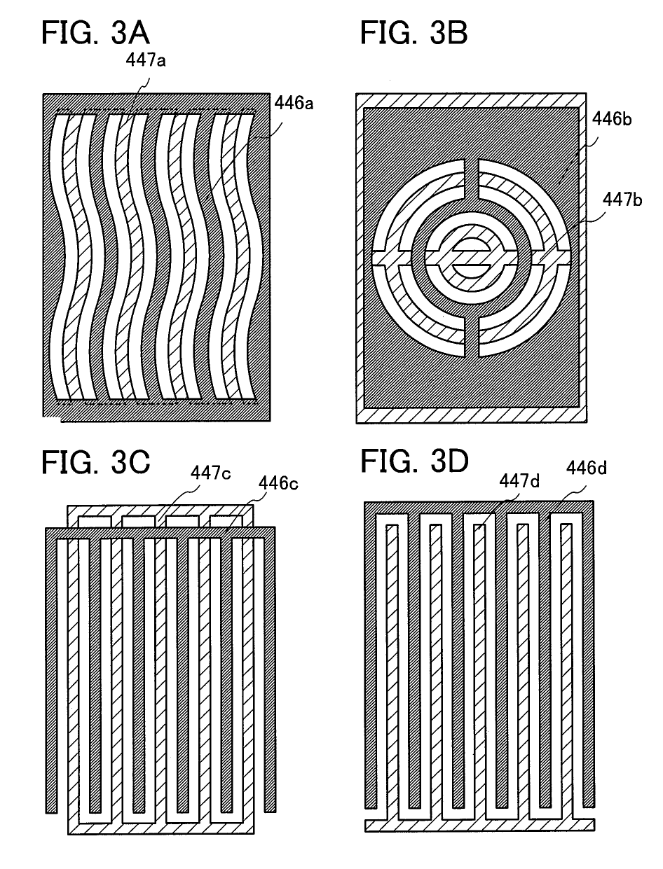

As a liquid crystal display device of one embodiment of the present invention, a passive matrix liquid crystal display device and an active matrix liquid crystal display device can be provided. In this embodiment, an example of the active matrix liquid crystal display device of one embodiment of the present invention will be described with reference to FIGS. 2A and 2B and FIGS. 3A to 3D.

FIG. 2A is a plan view of a liquid crystal display device and illustrates one pixel. FIG. 2B is a cross-sectional view taken along line X1-X2 in FIG. 2A.

In FIG. 2A, a plurality of source wiring layers (including a wiring layer 405a) is arranged so as to be parallel to (extend in a vertical direction in the drawing) and apart from each other. A plurality of gate wiring layers (including a gate electrode layer 401) are provided to be extended in a direction generally perpendicular to the source wiring layers (the horizontal direction in the drawing) and apart from each other. Common wiring layers 408 are provided adjacent to the respective plurality of gate wiring layers and extended in a direction generally parallel to the gate wiring layers, that is, in a direction generally perpendicular to the source wiring layers (a horizontal direction in the drawing). A roughly rectangular space is surrounded by the source wiring layers, the common wiring layers 408, and the gate wiring layers. In this space, a pixel electrode layer and a common electrode layer of the liquid crystal display device are provided. A transistor 420 for driving the pixel electrode layer is provided at an upper left corner of the drawing. A plurality of pixel electrode layers and a plurality of transistors are arranged in matrix.

In the liquid crystal display device of FIGS. 2A and 2B, a first electrode layer 447 which is electrically connected to the transistor 420 serves as a pixel electrode layer, while a second electrode layer 446 which is electrically connected to the common electrode layer 408 serves as a common electrode layer. Note that a capacitor is formed by the first electrode layer and the common wiring layer. Although a common electrode layer can operate in a floating state (an electrically isolated state), the potential of the common electrode layer may be set to a fixed potential, preferably to a potential around a common potential (an intermediate potential of an image signal which is transmitted as data) at a level that does not generate flickers.

A method in which the gray scale is controlled by generating an electric field generally parallel (i.e., in a lateral direction) to a substrate to move liquid crystal molecules in a plane parallel to the substrate can be used. For such a method, an electrode structure used in an IPS mode as illustrated in FIGS. 2A and 2B and FIGS. 3A to 3D can be employed.

In a lateral electric field mode such as an IPS mode, a first electrode layer (e.g., a pixel electrode layer with which a voltage is controlled in each pixel) and a second electrode layer (e.g., a common electrode layer with which a common voltage is applied to all pixels), which has an opening pattern, are located below a liquid crystal composition. Therefore, the first electrode layer 447 and the second electrode layer 446, one of which is a pixel electrode layer and the other of which is a common electrode layer, are formed over a first substrate 441, and at least one of the first electrode layer 447 and the second electrode layer 446 is formed over an insulating film.

The first electrode layer 447 and the second electrode layer 446 have not a plane shape but various opening patterns including a bent portion or a comb-shaped portion. An arrangement of the first electrode layer 447 and the second electrode layer 446, which complies with both conditions that they have the same shape and they completely overlap with each other, is avoided in order to generate an electric field between the electrodes.

The first electrode layer 447 and the second electrode layer 446 may have an electrode structure used in an FFS mode. In a lateral electric field mode such as an FFS mode, a first electrode layer (e.g., a pixel electrode layer with which a voltage is controlled in each pixel) having an opening pattern is located below a liquid crystal composition, and further, a second electrode layer (e.g., a common electrode layer with which a common voltage is applied to all pixels) having a flat shape is located below the opening pattern. In this case, the first electrode layer and the second electrode layer, one of which is a pixel electrode layer and the other of which is a common electrode layer, are formed over the first substrate 441, and the pixel electrode layer and the common electrode layer are stacked with an insulating film (or an interlayer insulating film) interposed therebetween. One of the pixel electrode layer and the common electrode layer is formed below the insulating film (or the interlayer insulating film), whereas the other is formed above the insulating film (or the interlayer insulating film) and has various opening patterns including a bent portion or a branched comb-like portion. An arrangement of the first electrode layer 447 and the second electrode layer 446, which complies with both conditions that they have the same shape and they completely overlap with each other, is avoided in order to generate an electric field between the electrodes.

The liquid crystal composition including the polymerizable monomer represented by General Formula (G1) or the polymerizable monomer represented by General Formula (H1), a nematic liquid crystal, and a chiral material, which is described in Embodiment 1, is used as a liquid crystal composition 444. The liquid crystal composition 444 may further contain an organic resin. In this embodiment, a liquid crystal composition which includes the polymerizable monomer represented by General Formula (G1) or the polymerizable monomer represented by General Formula (H1), nematic liquid crystal, a chiral material, a polymerizable monomer, and a polymerization initiator and exhibits a blue phase is used as the liquid crystal composition 444. The liquid crystal composition 444 is provided in a liquid crystal display device with a blue phase exhibited (with a blue phase shown) by being subjected to polymer stabilization treatment.

With an electric field generated between the first electrode layer 447 as the pixel electrode layer and the second electrode layer 446 as the common electrode layer, liquid crystal of the liquid crystal composition 444 is controlled. An electric field in a lateral direction is formed for the liquid crystal, so that liquid crystal molecules can be controlled using the electric field. Since the liquid crystal molecules aligned to exhibit a blue phase can be controlled in a direction parallel to the substrate, a wide viewing angle is obtained.

FIGS. 3A to 3D show other examples of the first electrode layer 447 and the second electrode layer 446. As illustrated in top views of FIGS. 3A to 3D, first electrode layers 447a to 447d and second electrode layers 446a to 446d are arranged alternately. In FIG. 3A, the first electrode layer 447a and the second electrode layer 446a have wavelike shapes with curves. In FIG. 3B, the first electrode layer 447b and the second electrode layer 446b have shapes with concentric circular openings. In FIG. 3C, the first electrode layer 447c and the second electrode layer 446c have comb-like shapes and partially overlap with each other. In FIG. 3D, the first electrode layer 447d and the second electrode layer 446d have comb-like shapes in which the electrode layers are engaged with each other. In the case where the first electrode layers 447a, 447b, and 447c overlap with the second electrode layers 446a, 446b, and 446c, respectively, as illustrated in FIGS. 3A to 3C, an insulating film is formed between the first electrode layer 447 and the second electrode layer 446 so that the first electrode layer 447 and the second electrode layer 446 are formed over different films.

Since the first electrode layer 447 and the second electrode layer 446 have an opening pattern, they are illustrated as divided plural electrode layers in the cross-sectional view of FIG. 2B. The same applies to the other drawings in this specification.

The transistor 420 is an inverted staggered thin film transistor in which the gate electrode layer 401, a gate insulating layer 402, a semiconductor layer 403, and wiring layers 405a and 405b which function as a source electrode layer and a drain electrode layer are formed over the first substrate 441 which has an insulating surface.

There is no particular limitation on the structure of a transistor which can be used for a liquid crystal display device disclosed in this specification; for example, a staggered type or a planar type having a top-gate structure or a bottom-gate structure can be employed. The transistor may have a single-gate structure in which one channel formation region is formed, a double-gate structure in which two channel formation regions are formed, or a triple-gate structure in which three channel formation regions are formed. Alternatively, the transistor may have a dual gate structure including two gate electrode layers positioned over and below a channel region with a gate insulating layer provided therebetween.

An insulating film 407 which is in contact with the semiconductor layer 403, and an insulating film 409 are provided to cover the transistor 420. An interlayer film 413 is stacked over the insulating film 409.

There is no particular limitation on the method for forming the interlayer film 413, and the following method can be employed depending on the material: spin coating, dip coating, spray coating, a droplet discharging method (such as an ink-jet method), a printing method (such as screen printing or offset printing), roll coating, curtain coating, knife coating, or the like.

The first substrate 441 and the second substrate 442 which is a counter substrate are firmly attached to each other with a sealant with the liquid crystal composition 444 interposed therebetween. The liquid crystal composition 444 can be formed by a dispenser method (a dropping method), or an injection method by which liquid crystal is injected using capillary action or the like after the first substrate 441 is attached to the second substrate 442.

As the sealant, typically, a visible light curable resin, a UV curable resin, or a thermosetting resin is preferably used. Typically, an acrylic resin, an epoxy resin, an amine resin, or the like can be used. Further, a photopolymerization initiator (typically, an ultraviolet light polymerization initiator), a thermosetting agent, a filler, or a coupling agent may be included in the sealant.

Since a liquid crystal composition including a photopolymerization initiator, the polymerizable monomer represented by General Formula (G 1) or the polymerizable monomer represented by General Formula (H1), a nematic liquid crystal, and a chiral material are used for the liquid crystal composition 444, polymer stabilization treatment can be performed by light irradiation.

After the space between the first substrate 441 and the second substrate 442 is filled with the liquid crystal composition, polymer stabilization treatment is performed by light irradiation, whereby the liquid crystal composition 444 is formed. The light has a wavelength at which the polymerizable monomer represented by General Formula (G1) or the polymerizable monomer represented by General Formula (H1) and the photopolymerization initiator, which are used for the liquid crystal composition 444, react. By such polymer stabilization treatment by light irradiation, the temperature range within which the liquid crystal composition 444 exhibits a blue phase can be broadened.

In the case where a photocurable resin such as a UV curable resin is used as a sealant and a liquid crystal composition is formed by a dropping method, for example, the sealant may be cured in the light irradiation step of the polymer stabilization treatment.

In this embodiment, a polarizing plate 443a is provided on the outer side (on the side opposite to the liquid crystal composition 444) of the first substrate 441, and a polarizing plate 443b is provided on the outer side (on the side opposite to the liquid crystal composition 444) of the second substrate 442. In addition to the polarizing plate, an optical film such as a retardation plate or an anti-reflection film may be provided. For example, circular polarization by the polarizing plate and the retardation plate may be used. Through the above-described process, a liquid crystal display device can be completed.

In the case of manufacturing a plurality of liquid crystal display devices using a large-sized substrate (a so-called multiple panel method), a division step can be performed before the polymer stabilization treatment is performed or before the polarizing plates are provided. In consideration of the influence of the division step on the liquid crystal composition (such as alignment disorder due to force applied in the division step), it is preferable that the division step be performed after the first substrate and the second substrate are attached to each other and before the polymer stabilization treatment is performed.

Although not illustrated, a backlight, a sidelight, or the like may be used as a light source. Light from the light source is emitted from the side of the first substrate 441 which is an element substrate so as to pass through the second substrate 442 on the viewing side.

The first electrode layer 447 and the second electrode layer 446 can be formed using a light-transmitting conductive material such as indium oxide containing tungsten oxide, indium zinc oxide containing tungsten oxide, indium oxide containing titanium oxide, indium tin oxide containing titanium oxide, indium tin oxide, indium zinc oxide, indium tin oxide to which silicon oxide is added, or graphene.

Alternatively, the first electrode layer 447 and the second electrode layer 446 can be formed using one or more materials selected from metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); an alloy of any of these metals; and a nitride of any of these metals.

The first electrode layer 447 and the second electrode layer 446 can be formed using a conductive composition including a conductive macromolecule (also referred to as a conductive polymer).

As the conductive high molecule, a so-called π-electron conjugated conductive polymer can be used. For example, polyaniline or a derivative thereof, polypyrrole or a derivative thereof, polythiophene or a derivative thereof, and a copolymer of two or more of aniline, pyrrole, and thiophene or a derivative thereof can be given.

An insulating film serving as a base film may be provided between the first substrate 441 and the gate electrode layer 401. The base film has a function of preventing diffusion of an impurity element from the first substrate 441, and can be formed to have a single-layer structure or a multi-layer structure using one or more of a silicon nitride film, a silicon oxide film, a silicon nitride oxide film, and a silicon oxynitride film. The gate electrode layer 401 can be formed to have a single-layer or stacked-layer structure using a metal material such as molybdenum, titanium, chromium, tantalum, tungsten, aluminum, copper, neodymium, or scandium, or an alloy material which contains any of these materials as its main component. A semiconductor film which is doped with an impurity element such as phosphorus and is typified by a polycrystalline silicon film, or a silicide film of nickel silicide or the like can also be used as the gate electrode layer 401. By using a light-blocking conductive film as the gate electrode layer 401, light from a backlight (light emitted through the first substrate 441) can be prevented from entering the semiconductor layer 403.

For example, as a two-layer structure of the gate electrode layer 401, the following structures are preferable: a two-layer structure of an aluminum layer and a molybdenum layer stacked thereover, a two-layer structure of a copper layer and a molybdenum layer stacked thereover, a two-layer structure of a copper layer and a titanium nitride layer or a tantalum nitride layer stacked thereover, and a two-layer structure of a titanium nitride layer and a molybdenum layer. As a three-layer structure, a layered structure in which a tungsten layer or a tungsten nitride layer, an alloy layer of aluminum and silicon or an alloy layer of aluminum and titanium, and a titanium nitride layer or a titanium layer are stacked is preferable.

For example, the gate insulating layer 402 can be formed by a plasma CVD method or a sputtering method, with the use of a silicon oxide film, a gallium oxide film, an aluminum oxide film, a silicon nitride film, a silicon oxynitride film, an aluminum oxynitride film, or a silicon nitride oxide film. Alternatively, a high-k material such as hafnium oxide, yttrium oxide, lanthanum oxide, hafnium silicate (HfSiₓO_{y} (x>0, y>0)), hafnium aluminate (HfAlₓO_{y} (x>0, y>0)), hafnium silicate to which nitrogen is added, or hafnium aluminate to which nitrogen is added may be used as a material for the gate insulating layer 402. The use of such a high-k material enables a reduction in gate leakage current.

Alternatively, the gate insulating layer 402 can be formed using a silicon oxide layer by a CVD method in which an organosilane gas is used. As an organosilane gas, a silicon-containing compound such as tetraethoxysilane (TEOS) (chemical formula: Si(OC₂H₅)₄), tetramethylsilane (TMS) (chemical formula: Si(CH₃)₄), tetramethylcyclotetrasiloxane (TMCTS), octamethylcyclotetrasiloxane (OMCTS), hexamethyldisilazane (HMDS), triethoxysilane (chemical formula: SiH(OC₂H₅)₃), or trisdimethylaminosilane (chemical formula: SiH(N(CH₃)₂)₃) can be used. Note that the gate insulating layer 402 may have a single layer structure or a stacked-layer structure.

A material of the semiconductor layer 403 is not limited to a particular material and may be determined in accordance with characteristics needed for the transistor 420, as appropriate. Examples of a material which can be used for the semiconductor layer 403 will be described.

The semiconductor layer 403 can be formed using the following material: an amorphous semiconductor formed by a chemical vapor deposition method using a semiconductor source gas typified by silane or germane or by a physical vapor deposition method such as a sputtering method; a polycrystalline semiconductor formed by crystallizing the amorphous semiconductor with the use of light energy or thermal energy; a microcrystalline semiconductor; or the like. The semiconductor layer can be formed by a sputtering method, an LPCVD method, a plasma CVD method, or the like.

A typical example of an amorphous semiconductor is hydrogenated amorphous silicon, while a typical example of a crystalline semiconductor is polysilicon and the like. Examples of polysilicon (polycrystalline silicon) are as follows: so-called high-temperature polysilicon which contains polysilicon formed at a process temperature of 800° C. or higher as its main component, so-called low-temperature polysilicon which contains polysilicon formed at a process temperature of 600° C. or lower as its main component, and polysilicon obtained by crystallizing amorphous silicon with the use of an element that promotes crystallization, or the like. Needless to say, as described above, a microcrystalline semiconductor or a semiconductor which includes a crystal phase in part of a semiconductor layer can also be used.

An oxide semiconductor film may also be used as the semiconductor layer 403. The oxide semiconductor preferably contains at least indium (In), particularly In and zinc (Zn). As a stabilizer for reducing the variation in electric characteristics of a transistor using the oxide semiconductor, gallium (Ga) is preferably contained in addition to In and Zn. Tin (Sn) is preferably contained as a stabilizer. Hafnium (Hf) is preferably contained as a stabilizer. Aluminum (Al) is preferably contained as a stabilizer. Zirconium (Zr) is preferably contained as a stabilizer.

As another stabilizer, one or plural kinds of lanthanoid such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu) may be contained.

As the oxide semiconductor, for example, any of the following can be used: indium oxide; tin oxide; zinc oxide; a two-component metal oxide such as an In—Zn-based oxide, an In—Mg-based oxide, or an In—Ga-based oxide; a three-component metal oxide such as an In—Ga—Zn-based oxide (also referred to as IGZO), an In—Al—Zn-based oxide, an In—Sn—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, or an In—Lu—Zn-based oxide; a four-component metal oxide such as an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide.

Note that here, for example, an “In—Ga—Zn—O-based oxide” means an oxide containing In, Ga, and Zn as its main component and there is no particular limitation on the ratio of In to Ga and Zn. The In—Ga—Zn-based oxide may contain a metal element other than In, Ga, and Zn.

Alternatively, a material represented by InMO₃(ZnO)ₘ (m>0 is satisfied, and m is not an integer) may be used as an oxide semiconductor. Note that M represents one or more metal elements selected from Ga, Fe, Mn, and Co. Alternatively, as the oxide semiconductor, a material expressed by a chemical formula, In₂SnO₅(ZnO)ₙ (n>0, n is a natural number) may be used.

For example, an In—Ga—Zn-based oxide with an atomic ratio of In:Ga:Zn=1:1:1 (=1/3:1/3:1/3), In:Ga:Zn=2:2:1 (=2/5:2/5:1/5), In:Ga:Zn=3:1:2 (=1/2:1/6:1/3), or any of oxides whose composition is in the neighborhood of the above compositions can be used. Alternatively, an In—Sn—Zn-based oxide with an atomic ratio of In:Sn:Zn=1:1:1 (=1/3:1/3:1/3), In:Sn:Zn=2:1:3 (=1/3:1/6:1/2), or In:Sn:Zn=2:1:5 (=1/4:1/8:5/8), or any of oxides whose composition is in the neighborhood of the above compositions may be used.

However, without limitation to the materials given above, a material with an appropriate composition may be used as the oxide semiconductor depending on needed semiconductor characteristics and electrical characteristics (e.g., mobility, threshold voltage, and variation). In order to obtain the needed semiconductor characteristics, it is preferable that the carrier density, the impurity concentration, the defect density, the atomic ratio between a metal element and oxygen, the interatomic distance, the density, and the like be set to appropriate values.

For example, high mobility can be obtained relatively easily in the case of using an In—Sn—Zn-based oxide. However, mobility can be increased by reducing the defect density in a bulk also in the case of using an In—Ga—Zn-based oxide.

For example, in the case where the composition of an oxide containing In, Ga, and Zn at the atomic ratio, In:Ga:Zn=a:b:c (a+b+c=1), is in the neighborhood of the composition of an oxide containing In, Ga, and Zn at the atomic ratio, In:Ga:Zn=A:B:C (A+B+C=1), a, b, and c satisfy the following relation: (a−A)²+(b−B)²+(c−C)²≦r², and r may be 0.05, for example. For example, r may be 0.05. The same applies to other oxides.

An oxide semiconductor film may be in a non-single-crystal state, for example. The non-single-crystal state is, for example, structured by at least one of c-axis aligned crystal (CAAC), polycrystal, microcrystal, and an amorphous part. The density of defect states of an amorphous part is higher than those of microcrystal and CAAC. The density of defect states of microcrystal is higher than that of CAAC. Note that an oxide semiconductor including CAAC is referred to as a CAAC-OS (c-axis aligned crystalline oxide semiconductor). For example, an oxide semiconductor film may include a CAAC-OS. In the CAAC-OS, for example, c-axes are aligned, and a-axes and/or b-axes are not macroscopically aligned. For example, an oxide semiconductor film may include microcrystal. Note that an oxide semiconductor including microcrystal is referred to as a microcrystalline oxide semiconductor. A microcrystalline oxide semiconductor film includes microcrystal (also referred to as nanocrystal) with a size greater than or equal to 1 nm and less than 10 nm, for example.

For example, an oxide semiconductor film may include an amorphous part. Note that an oxide semiconductor including an amorphous part is referred to as an amorphous oxide semiconductor. An amorphous oxide semiconductor film, for example, has disordered atomic arrangement and no crystalline component. Alternatively, an amorphous oxide semiconductor film is, for example, absolutely amorphous and has no crystal part.

Note that an oxide semiconductor film may be a mixed film including any of a CAAC-OS, a microcrystalline oxide semiconductor, and an amorphous oxide semiconductor. The mixed film, for example, includes a region of an amorphous oxide semiconductor, a region of a microcrystalline oxide semiconductor, and a region of a CAAC-OS. Further, the mixed film may have a stacked structure including a region of an amorphous oxide semiconductor, a region of a microcrystalline oxide semiconductor, and a region of a CAAC-OS, for example.

Note that an oxide semiconductor film may be in a single-crystal state, for example.

An oxide semiconductor film preferably includes a plurality of crystal parts. In each of the crystal parts, a c-axis is preferably aligned in a direction parallel to a normal vector of a surface where the oxide semiconductor film is formed or a normal vector of a surface of the oxide semiconductor film. Note that, among crystal parts, the directions of the a-axis and the b-axis of one crystal part may be different from those of another crystal part. An example of such an oxide semiconductor film is a CAAC-OS film. Note that in most cases, a crystal part in the CAAC-OS film fits inside a cube whose one side is less than 100 nm. In an image obtained with a transmission electron microscope (TEM), a boundary between crystal parts in the CAAC-OS film is not clearly detected. Further, with the TEM, a grain boundary in the CAAC-OS film is not clearly found. Thus, in the CAAC-OS film, a reduction in electron mobility due to the grain boundary is suppressed.

In each of the crystal parts included in the CAAC-OS film, for example, a c-axis is aligned in a direction parallel to a normal vector of a surface where the CAAC-OS film is formed or a normal vector of a surface of the CAAC-OS film. Further, in each of the crystal parts, metal atoms are arranged in a triangular or hexagonal configuration when seen from the direction perpendicular to the a-b plane, and metal atoms are arranged in a layered manner or metal atoms and oxygen atoms are arranged in a layered manner when seen from the direction perpendicular to the c-axis. Note that, among crystal parts, the directions of the a-axis and the b-axis of one crystal part may be different from those of another crystal part. In this specification, a term “perpendicular” includes a range from 80° to 100°, preferably from 85° to 95°. In addition, a term “parallel” includes a range from −10° to 10°, preferably from −5° to 5°. In the CAAC-OS film, distribution of crystal parts is not necessarily uniform. For example, in the formation process of the CAAC-OS film, in the case where crystal growth occurs from a surface side of the oxide semiconductor film, the proportion of crystal parts in the vicinity of the surface of the oxide semiconductor film is higher than that in the vicinity of the surface where the oxide semiconductor film is formed in some cases. Further, when an impurity is added to the CAAC-OS film, crystallinity of the crystal part in a region to which the impurity is added is lowered in some cases.

Since the c-axes of the crystal parts included in the CAAC-OS film are aligned in the direction parallel to a normal vector of a surface where the CAAC-OS film is formed or a normal vector of a surface of the CAAC-OS film, the directions of the c-axes may be different from each other depending on the shape of the CAAC-OS film (the cross-sectional shape of the surface where the CAAC-OS film is formed or the cross-sectional shape of the surface of the CAAC-OS film). Note that the film deposition is accompanied with the formation of the crystal parts or followed by the formation of the crystal parts through crystallization treatment such as heat treatment. Hence, the c-axes of the crystal parts are aligned in the direction parallel to a normal vector of the surface where the CAAC-OS film is formed or a normal vector of the surface of the CAAC-OS film. In a transistor using the CAAC-OS film, change in electric characteristics due to irradiation with visible light or ultraviolet light is small. Thus, the transistor has high reliability.

Note that part of oxygen included in the oxide semiconductor film may be substituted with nitrogen.

In an oxide semiconductor having a crystal portion such as the CAAC-OS, defects in the bulk can be further reduced and when the surface flatness of the oxide semiconductor is improved, mobility higher than that of an oxide semiconductor in an amorphous state can be obtained. In order to improve the surface flatness, the oxide semiconductor is preferably formed over a flat surface. Specifically, the oxide semiconductor may be formed over a surface with the average surface roughness (Ra) of less than or equal to 1 nm, preferably less than or equal to 0.3 nm, more preferably less than or equal to 0.1 nm.

In a process of forming the semiconductor layer and the wiring layer, an etching step is used to process thin films into desired shapes. Dry etching or wet etching can be used for the etching step.

The etching conditions (an etchant, etching time, temperature, and the like) are adjusted as appropriate in accordance with the material so that the films can be etched into desired shapes.

As a material of the wiring layers 405a and 405b serving as source and drain electrode layers, an element selected from Al, Cr, Ta, Ti, Mo, and W; an alloy containing any of the above elements as its component; an alloy film containing a combination of any of these elements; and the like can be given. Further, in the case where heat treatment is performed, the conductive film preferably has heat resistance against the heat treatment. Since use of Al alone brings disadvantages such as low heat resistance and a tendency to be corroded, aluminum is used in combination with a conductive material having heat resistance. As the conductive material having heat resistance, which is combined with Al, it is possible to use an element selected from titanium (Ti), tantalum (Ta), tungsten (W), molybdenum (Mo), chromium (Cr), neodymium (Nd), and scandium (Sc); an alloy containing any of these elements as its component; an alloy containing a combination of any of these elements; or a nitride containing any of these elements as its component.

The gate insulating layer 402, the semiconductor layer 403, and the wiring layers 405a and 405b serving as source and drain electrode layers may be successively formed without being exposed to the air. When the gate insulating layer 402, the semiconductor layer 403, and the wiring layers 405a and 405b are formed successively without being exposed to the air, an interface between the layers can be formed without being contaminated with atmospheric components or impurity elements contained in the air. Thus, variations in characteristics of thin film transistors can be reduced.

Note that the semiconductor layer 403 is partly etched so as to have a groove (a depressed portion).

As the insulating film 407 and the insulating film 409 which cover the transistor 420, an inorganic insulating film or an organic insulating film formed by a dry method or a wet method can be used. For example, it is possible to use a silicon nitride film, a silicon oxide film, a silicon oxynitride film, an aluminum oxide film, or a tantalum oxide film, which is formed by a CVD method, a sputtering method, or the like. Alternatively, an organic material such as polyimide, acrylic, a benzocyclobutene-based resin, polyamide, or epoxy can be used. Other than such organic materials, it is also possible to use a low-dielectric constant material (a low-k material), a siloxane-based resin, PSG (phosphosilicate glass), BPSG (borophosphosilicate glass), or the like. A gallium oxide film can also be used as the insulating film 407.

Note that the siloxane-based resin corresponds to a resin including a Si—O—Si bond formed using a siloxane-based material as a starting material. The siloxane-based resin may include as a substituent an organic group (e.g., an alkyl group or an aryl group) or a fluoro group. In addition, the organic group may include a fluoro group. A siloxane-based resin is applied by a coating method and baked; thus, the insulating film 407 can be formed.

Alternatively, the insulating film 407 and the insulating film 409 may be formed by stacking a plurality of insulating films formed using any of these materials. For example, a structure in which an organic resin film is stacked over an inorganic insulating film may be employed.

Further, with the use of a resist mask having a plurality of regions with different thicknesses (typically, two kinds of thicknesses), which is formed using a multi-tone mask, the number of resist masks can be reduced, resulting in a simplified process and lower cost.

As described above, the use of the liquid crystal composition including the polymerizable monomer represented by General Formula (G1) or the polymerizable monomer represented by General Formula (H1), a nematic liquid crystal, and a chiral material makes it possible to provide a liquid crystal element and a liquid crystal display device with lower driving voltage. Consequently, a liquid crystal display device with lower power consumption can be provided.

Since the liquid crystal composition including the polymerizable monomer represented by General Formula (G1) or the polymerizable monomer represented by General Formula (H1), a nematic liquid crystal, and a chiral material and exhibiting a blue phase is capable of quick response, a high-performance liquid crystal display device can be achieved.

This embodiment can be implemented in appropriate combination with any of the structures described in the other embodiments.

### Embodiment 3

A transistor is manufactured, and a liquid crystal display device having a display function can be manufactured using the transistor in a pixel portion and further in a driver circuit. Further, part or the whole of the driver circuit can be formed over the same substrate as the pixel portion, using the transistor, whereby a system-on-panel can be obtained.

The liquid crystal display device includes a liquid crystal element (also referred to as a liquid crystal display element) as a display element.

Further, a liquid crystal display device includes a panel in which a liquid crystal display element is sealed, and a module in which an IC or the like including a controller is mounted to the panel. One embodiment of the present invention also relates to an element substrate, which corresponds to one mode before the display element is completed in a manufacturing process of the liquid crystal display device, and the element substrate is provided with a means for supplying current to the display element in each of a plurality of pixels. Specifically, the element substrate may be in a state where it is provided only with a pixel electrode of the display element, in a state where a conductive film to be a pixel electrode has been formed and the conductive film has not yet been etched to form the pixel electrode, or in any other state.

Note that a liquid crystal display device in this specification means an image display device, a display device, or a light source (including a lighting device). Further, a liquid crystal display device also refers to all the following modules: a module to which a connector, for example, a flexible printed circuit (FPC), a tape automated bonding (TAB) tape, or a tape carrier package (TCP) is attached, a module in which a printed wiring board is provided at an end of a TAB tape or a TCP, and a module in which an integrated circuit (IC) is directly mounted on a display element by a chip on glass (COG) method.

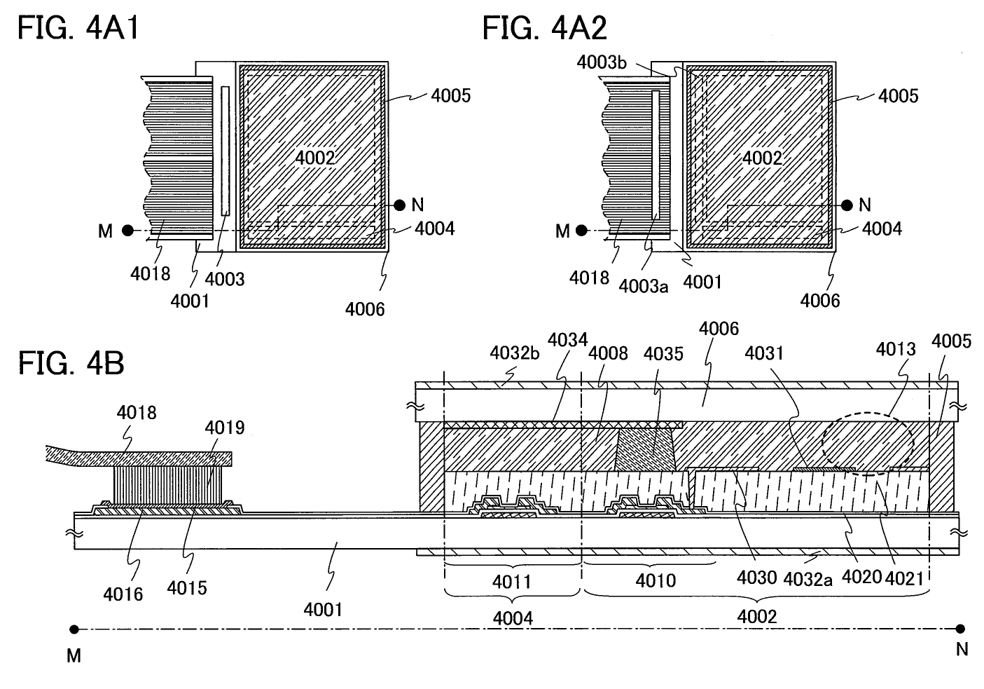

The appearance and a cross section of a liquid crystal display panel which corresponds to a liquid crystal display device of one embodiment of the present invention is described with reference to FIGS. 4A1, 4A2, and 4B. FIGS. 4A1 and 4A2 are top views of a panel in which transistors 4010 and 4011 and a liquid crystal element 4013 which are formed over a first substrate 4001 are sealed between the first substrate 4001 and a second substrate 4006 with a sealant 4005. FIG. 4B is a cross-sectional view taken along M-N in FIGS. 4A1 and 4A2.

The sealant 4005 is provided so as to surround a pixel portion 4002 and a scan line driver circuit 4004 which are provided over the first substrate 4001. The second substrate 4006 is provided over the pixel portion 4002 and the scan line driver circuit 4004. Thus, the pixel portion 4002 and the scan line driver circuit 4004 are sealed together with a liquid crystal composition 4008, by the first substrate 4001, the sealant 4005, and the second substrate 4006.

In FIG. 4A1, a signal line driver circuit 4003 that is formed using a single crystal semiconductor film or a polycrystalline semiconductor film over a substrate separately prepared is mounted in a region that is different from the region surrounded by the sealant 4005 over the first substrate 4001. FIG. 4A2 illustrates an example in which part of a signal line driver circuit is formed with use of a transistor which is provided over the first substrate 4001. A signal line driver circuit 4003b is formed over the first substrate 4001 and a signal line driver circuit 4003a which is formed using a single crystal semiconductor film or a polycrystalline semiconductor film is mounted on a substrate separately prepared.

Note that the connection method of a driver circuit which is separately formed is not particularly limited, and a COG method, a wire bonding method, a TAB method, or the like can be used. FIG. 4A1 illustrates an example of mounting the signal line driver circuit 4003 by a COG method, and FIG. 4A2 illustrates an example of mounting the signal line driver circuit 4003 by a TAB method.

The pixel portion 4002 and the scan line driver circuit 4004 provided over the first substrate 4001 include a plurality of transistors. FIG. 4B illustrates the transistor 4010 included in the pixel portion 4002 and the transistor 4011 included in the scan line driver circuit 4004, as an example. An insulating layer 4020 and an interlayer film 4021 are provided over the transistors 4010 and 4011.

As the transistors 4010 and 4011, the transistor described in Embodiment 2 or 3 can be employed.

Further, a conductive layer may be provided over the interlayer film 4021 or the insulating layer 4020 so as to overlap with a channel formation region of a semiconductor layer of the transistor 4011 for the driver circuit. The conductive layer may have the same potential as or a potential different from that of a gate electrode layer of the transistor 4011 and can function as a second gate electrode layer. Further, the potential of the conductive layer may be GND or 0 V, or the conductive layer may be in a floating state.

A pixel electrode layer 4030 and a common electrode layer 4031 are provided over the interlayer film 4021, and the pixel electrode layer 4030 is electrically connected to the transistor 4010. The liquid crystal element 4013 includes the pixel electrode layer 4030, the common electrode layer 4031, and the liquid crystal composition 4008. Note that a polarizing plate 4032a and a polarizing plate 4032b are provided on the outer sides of the first substrate 4001 and the second substrate 4006, respectively.

The liquid crystal composition including the polymerizable monomer represented by General Formula (G1) or the polymerizable monomer represented by General Formula (H1), a nematic liquid crystal, and a chiral material, which is described in Embodiment 1, is used as the liquid crystal composition 4008. The structures of the pixel electrode layer and the common electrode layer described in Embodiment 1 or 2 can be used for the pixel electrode layer 4030 and the common electrode layer 4031.

In this embodiment, a liquid crystal composition which includes the polymerizable monomer represented by General Formula (G1) or the polymerizable monomer represented by General Formula (H1), a nematic liquid crystal, and a chiral material and exhibits a blue phase is used as the liquid crystal composition 4008. The liquid crystal composition 4008 is provided in a liquid crystal display device with a blue phase exhibited (with a blue phase shown) by being subjected to polymer stabilization treatment. Therefore, in this embodiment, the pixel electrode layer 4030 and the common electrode layer 4031 have opening patterns illustrated in FIG. 1A described in Embodiment 1 or FIGS. 3A to 3D described in Embodiment 2.

With an electric field generated between the pixel electrode layer 4030 and the common electrode layer 4031, liquid crystal of the liquid crystal composition 4008 is controlled. An electric field in a lateral direction is formed for the liquid crystal, so that liquid crystal molecules can be controlled using the electric field. Since the liquid crystal molecules aligned to exhibit a blue phase can be controlled in a direction parallel to the substrate, a wide viewing angle is obtained.

As the first substrate 4001 and the second substrate 4006, glass, plastic, or the like having a light-transmitting property can be used. As plastic, a fiberglass-reinforced plastics (FRP) plate, a polyvinyl fluoride (PVF) film, a polyester film, or an acrylic resin film can be used. In addition, a sheet with a structure in which an aluminum foil is sandwiched between PVF films or polyester films can be used.

A columnar spacer denoted by reference numeral 4035 is obtained by selective etching of an insulating film and is provided in order to control the thickness (a cell gap) of the liquid crystal composition 4008. Alternatively, a spherical spacer may be used. In the liquid crystal display device including the liquid crystal composition 4008, the cell gap which is the thickness of the liquid crystal composition is preferably greater than or equal to 1 μm and less than or equal to 20 In this specification, the thickness of a cell gap refers to the length (film thickness) of a thickest part of a liquid crystal composition.

Although FIGS. 4A1, 4A2, and 4B illustrate examples of transmissive liquid crystal display devices, one embodiment of the present invention can also be applied to a transflective liquid crystal display device and a reflective liquid crystal display device.

FIGS. 4A1, 4A2, and 4B illustrate an example in which the polarizing plate is provided on the outer side (the viewing side) of the substrate; however, the polarizing plate may be provided on the inner side of the substrate. The position of the polarizing plate may be determined as appropriate depending on the material of the polarizing plate and conditions of the manufacturing process. Furthermore, a light-blocking layer serving as a black matrix may be provided.

A color filter layer or a light-blocking layer may be formed as part of the interlayer film 4021. In FIGS. 4A1, 4A2, and 4B, a light-blocking layer 4034 is provided on the second substrate 4006 side so as to cover the transistors 4010 and 4011. By providing the light-blocking layer 4034, the contrast can be increased and the transistors can be stabilized.

The thin film transistors may be, but is not necessarily, covered with the insulating layer 4020 which functions as a protective film of the thin film transistors.

Note that the protective film is provided to prevent entry of contaminant impurities such as organic substance, metal, or moisture existing in the air and is preferably a dense film. The protective film may be formed by a sputtering method to have a single-layer structure or a stacked-layer structure including any of a silicon oxide film, a silicon nitride film, a silicon oxynitride film, a silicon nitride oxide film, an aluminum oxide film, an aluminum nitride film, an aluminum oxynitride film, and an aluminum nitride oxide film.

Further, in the case of further forming a light-transmitting insulating layer as a planarizing insulating film, the light-transmitting insulating layer can be formed using an organic material having heat resistance, such as polyimide, acrylic, a benzocyclobutene-based resin, polyamide, or epoxy. Other than such organic materials, it is also possible to use a low-dielectric constant material (a low-k material), a siloxane-based resin, phosphosilicate glass (PSG), borophosphosilicate glass (BPSG), or the like. The insulating layer may be formed by stacking a plurality of insulating films formed using these materials.

There is no particular limitation on the method for forming the insulating layer having a stacked-layer structure, and the following method can be employed depending on the material: a sputtering method, a spin coating method, a dip coating method, a spray coating method, a droplet discharge method (such as an ink-jet method), a printing method (such as a screen printing method or an offset printing method), a roll coating method, a curtain coating method, a knife coating method, or the like.

The pixel electrode layer 4030 and the common electrode layer 4031 can be formed using a light-transmitting conductive material such as indium oxide containing tungsten oxide, indium zinc oxide containing tungsten oxide, indium oxide containing titanium oxide, indium tin oxide containing titanium oxide, indium tin oxide, indium zinc oxide, indium tin oxide to which silicon oxide is added, or graphene.

Alternatively, the pixel electrode layer 4030 and the common electrode layer 4031 can also be formed using one or more materials selected from metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and nitrides thereof.

Alternatively, the pixel electrode layer 4030 and the common electrode layer 4031 can be formed using a conductive composition containing a conductive high molecule (also referred to as a conductive polymer).

Further, a variety of signals and potentials are supplied from an FPC 4018 to the signal line driver circuit 4003 which is separately formed, the scan line driver circuit 4004, or the pixel portion 4002.

Further, since the transistor is easily broken by static electricity or the like, a protective circuit for protecting the driver circuits is preferably provided over the same substrate as a gate line or a source line. The protection circuit is preferably formed using a nonlinear element.

In FIGS. 4A1, 4A2, and 4B, a connection terminal electrode 4015 is formed using the same conductive film as the pixel electrode layer 4030, and a terminal electrode 4016 is formed using the same conductive film as source electrode layers and drain electrode layers of the transistors 4010 and 4011.

The connection terminal electrode 4015 is electrically connected to a terminal included in the FPC 4018 via an anisotropic conductive film 4019.

Although FIGS. 4A1, 4A2, and 4B illustrate an example in which the signal line driver circuit 4003 is formed separately and mounted on the first substrate 4001, one embodiment of the present invention is not limited to this structure. The scan line driver circuit may be separately formed and then mounted, or only part of the signal line driver circuit or part of the scan line driver circuit may be separately formed and then mounted.

As described above, the use of the liquid crystal composition including the polymerizable monomer represented by General Formula (G1) or the polymerizable monomer represented by General Formula (H1), a nematic liquid crystal, and a chiral material makes it possible to provide a liquid crystal element and a liquid crystal display device with lower driving voltage. Consequently, a liquid crystal display device with lower power consumption can be provided.

Since the liquid crystal composition which includes the polymerizable monomer represented by General Formula (G1) or the polymerizable monomer represented by General Formula (H1), a nematic liquid crystal, and a chiral material and exhibits a blue phase is capable of quick response, a high-performance liquid crystal display device can be achieved.

This embodiment can be implemented in appropriate combination with any of the structures described in the other embodiments.

### Embodiment 4

A liquid crystal display device disclosed in this specification can be applied to a variety of electronic appliances (including game machines). Examples of such electronic appliances are a television set (also referred to as a television or a television receiver), a monitor of a computer or the like, a camera such as a digital camera or a digital video camera, a digital photo frame, a mobile phone handset (also referred to as a mobile phone or a mobile phone device), a portable game machine, a portable information terminal, an audio reproducing device, a large game machine such as a pachinko machine, and the like.

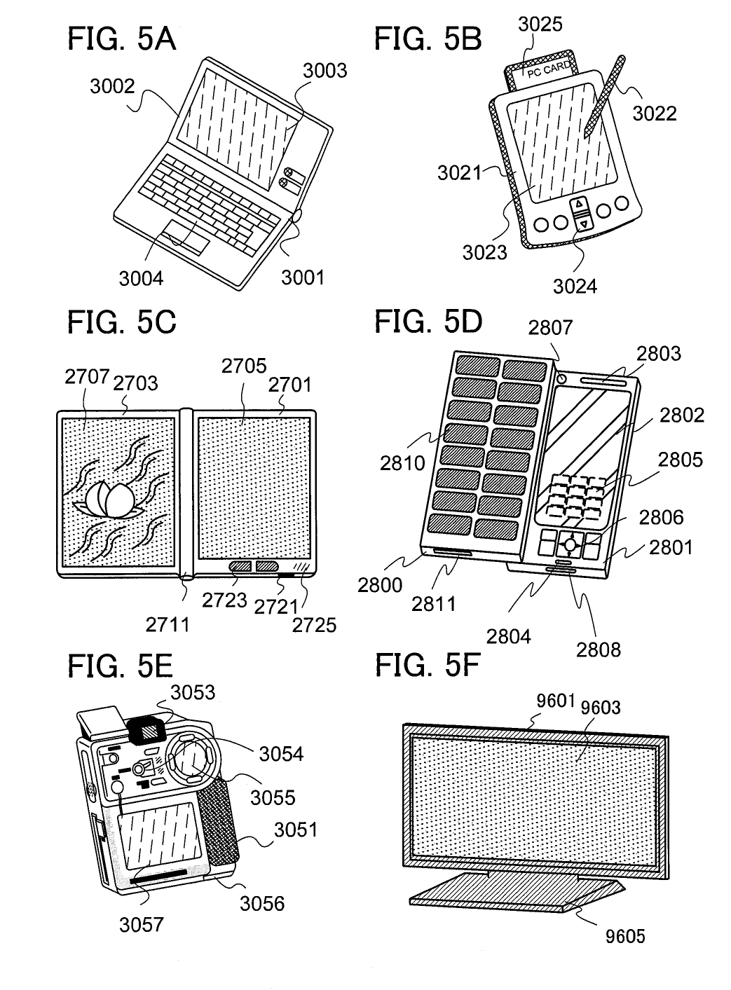

FIG. 5A illustrates a laptop personal computer, which includes a main body 3001, a housing 3002, a display portion 3003, a keyboard 3004, and the like. The liquid crystal display device described in any of Embodiments 1 to 3 is used for the display portion 3003, whereby a laptop personal computer with low power consumption can be provided.

FIG. 5B illustrates a personal digital assistant (PDA), which includes a main body 3021 provided with a display portion 3023, an external interface 3025, operation buttons 3024, and the like. A stylus 3022 is included as an accessory for operation. The liquid crystal display device described in any of Embodiments 1 to 3 is used for the display portion 3023, whereby a personal digital assistant (PDA) with low power consumption can be provided.

FIG. 5C illustrates an e-book reader, which includes two housings, a housing 2701 and a housing 2703. The housing 2701 and the housing 2703 are combined with a hinge 2711 so that the e-book reader can be opened and closed with the hinge 2711 as an axis. With such a structure, the e-book reader can operate like a paper book.

A display portion 2705 and a display portion 2707 are incorporated in the housing 2701 and the housing 2703, respectively. The display portion 2705 and the display portion 2707 may display one image or different images. In the structure where different images are displayed in the above display portions, for example, the right display portion (the display portion 2705 in FIG. 5C) can display text and the left display portion (the display portion 2707 in FIG. 5C) can display images. The liquid crystal display device described in any of Embodiments 1 to 3 is used for the display portions 2705 and 2707, whereby an e-book reader with low power consumption can be provided. In the case of using a transflective or reflective liquid crystal display device as the display portion 2705, the e-book reader may be used in a comparatively bright environment; therefore, a solar cell may be provided so that power generation by the solar cell and charge by a battery can be performed. When a lithium ion battery is used as the battery, there are advantages of downsizing and the like.

FIG. 5C illustrates an example in which the housing 2701 is provided with an operation portion and the like. For example, the housing 2701 is provided with a power switch 2721, operation keys 2723, a speaker 2725, and the like. Pages can be turned with the operation keys 2723. Note that a keyboard, a pointing device, or the like may also be provided on the surface of the housing, on which the display portion is provided. Furthermore, an external connection terminal (an earphone terminal, a USB terminal, or the like), a recording medium insertion portion, and the like may be provided on the back surface or the side surface of the housing. Further, the electronic book device may have a function of an electronic dictionary.

The e-book reader device may transmit and receive data wirelessly. Through wireless communication, desired book data or the like can be purchased and downloaded from an e-book server.

FIG. 5D illustrates a mobile phone, which includes two housings, a housing 2800 and a housing 2801. The housing 2801 includes a display panel 2802, a speaker 2803, a microphone 2804, a pointing device 2806, a camera lens 2807, an external connection terminal 2808, and the like. The housing 2800 includes a solar cell 2810 for charging the mobile phone, an external memory slot 2811, and the like. Further, an antenna is incorporated in the housing 2801. The liquid crystal display device described in any of Embodiments 1 to 3 is used for the display panel 2802, whereby a mobile phone with low power consumption can be provided.

Further, the display panel 2802 is provided with a touch panel. A plurality of operation keys 2805 which is displayed as images is illustrated by dashed lines in FIG. 5D. Note that a boosting circuit by which a voltage output from the solar cell 2810 is increased to be sufficiently high for each circuit is also included.

In the display panel 2802, the display direction can be changed as appropriate depending on the usage pattern. Further, the display device is provided with the camera lens 2807 on the same surface as the display panel 2802, so that the mobile phone can be used as a video phone. The speaker 2803 and the microphone 2804 can be used for videophone calls, recording and playing sound, and the like as well as voice calls. Furthermore, the housings 2800 and 2801 which are developed as illustrated in FIG. 5D can overlap with each other by sliding; thus, the size of the mobile phone can be decreased, which makes the mobile phone suitable for being carried.

The external connection terminal 2808 can be connected to an AC adapter and various types of cables such as a USB cable, and charging and data communication with a personal computer are possible. Moreover, a large amount of data can be stored by inserting a storage medium into the external memory slot 2811 and can be moved.

Further, in addition to the above functions, an infrared communication function, a television reception function, or the like may be provided.

FIG. 5E illustrates a digital video camera, which includes a main body 3051, a display portion A 3057, an eyepiece 3053, an operation switch 3054, a display portion B 3055, a battery 3056, and the like. The liquid crystal display device described in any of Embodiments 1 to 3 is used for the display portion A 3057 and the display portion B 3055, whereby a digital video camera with low power consumption can be provided.

FIG. 5F illustrates a television set, which includes in which a display portion 9603 and the like are incorporated in a housing 9601. The display portion 9603 can display images. Here, the housing 9601 is supported by a stand 9605. The liquid crystal display device described in any of Embodiments 1 to 3 is used for the display portion 9603, whereby a television set with low power consumption can be provided.

The television set can be operated by an operation switch of the housing 9601 or a separate remote controller. Further, the remote controller may be provided with a display portion for displaying data output from the remote controller.

Note that the television set is provided with a receiver, a modem, and the like. With the receiver, a general television broadcast can be received. Furthermore, when the television set is connected to a communication network by wired or wireless connection via the modem, one-way (from a transmitter to a receiver) or two-way (between a transmitter and a receiver, between receivers, or the like) data communication can be performed.

This embodiment can be implemented in appropriate combination with any of the structures described in the other embodiments.

### Example 1

In this example, an example of synthesizing 1,4-bis-[4-(3-acryloyloxy-n-propyl-1-oxy)benzoyloxy]-2,3-difluorobenzene (abbreviation: o2F-RM257-O3) represented by Structural Formula (102) in Embodiment 1 will be described.

Synthesis method of 1,4-bis-[4-(3-acryloyloxy-n-propyl-1-oxy)benzoyloxy]-2,3-difluorobenzene (abbreviation: o2F-RM257-O3)

A synthesis scheme of o2F-RM257-O3 (abbreviation) represented by Structural Formula (102) is shown in (A-1) given below.

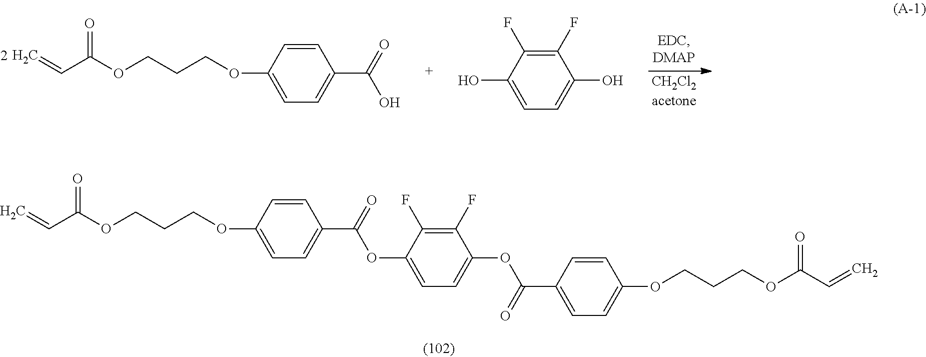

In a 300-mL recovery flask were put 2.0 g (8.0 mmol) of 4-(3-acryloyloxy-n-propyl-1-oxy)benzoic acid, 0.53 g (3.6 mmol) of 2,3-difluoro-1,4-benzenediol, 0.29 g (2.4 mmol) of 4-dimethylaminopyridine (DMAP), 1.5 g (8.0 mmol) of 1-ethyl-3-(3-dimethylaminopropyl)carbodiimide hydrochloride (EDC), 80 mL of acetone, and 40 mL of dichloromethane. This solution was stirred at room temperature in the air for 18 hours. After that, completion of the reaction was confirmed by silica-gel thin layer chromatography (TLC). The obtained solution was concentrated, dichloromethane, a saturated aqueous solution of sodium hydrogen carbonate, and saturated saline were added to extract an organic layer, and an aqueous layer was extracted with dichloromethane three times. The organic layer and the extracted solution were mixed and dried with magnesium sulfate, and this mixture was gravity-filtered. The filtrate was concentrated, and the obtained solid was purified by silica gel column chromatography (developing solvent: chloroform). The obtained fraction was concentrated to give a white solid substance. The obtained white solid substance was purified by high-performance liquid chromatography (HPLC) to give 0.87 g of a white solid in a yield of 40%.

This compound was identified by a nuclear magnetic resonance (NMR) spectroscopy as 1,4-bis-[4-(3-acryloyloxy-n-propyl-1-oxy)benzoyloxy]-2,3-difluorobenzene (abbreviation: o2F-RM257-O3) which was a target substance.

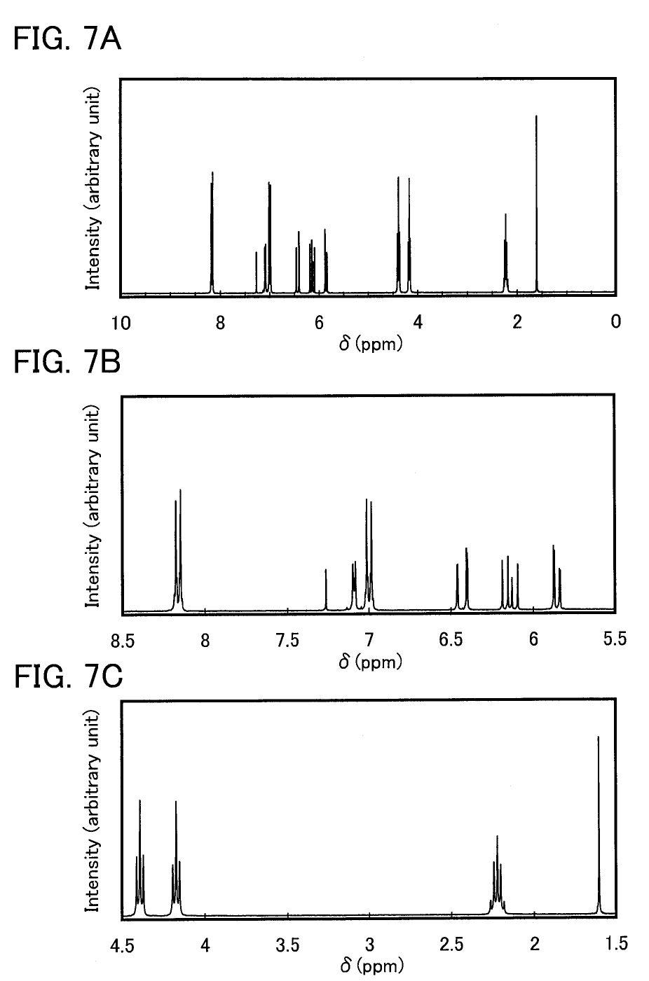

¹H NMR data of the obtained substance are as follows: ¹H NMR (CDCl₃, 300 MHz): δ (ppm)=2.18-2.27 (m, 4H), 4.17 (t, J=6.0 Hz, 4H), 4.39 (t, J=6.2 Hz, 4H), 5.86 (dd, J1=10.5 Hz, J2=1.8 Hz, 2H), 6.14 (dd, J1=10.5 Hz, J2=17.4 Hz, 2H), 6.43 (dd, J1=1.5 Hz, J2=17.1 Hz, 2H), 7.00 (d, J=8.7 Hz, 4H), 7.09 (d, J=4.5 Hz, 2H), 8.16 (d, J=8.7 Hz, 4H). FIGS. 7A to 7C are ¹H-NMR charts. Note that FIG. 7B is a chart in which the range of 5.5 ppm to 8.5 ppm in FIG. 7A is enlarged. Note that FIG. 7C is a chart in which the range of 1.5 ppm to 4.5 ppm in FIG. 7A is enlarged.

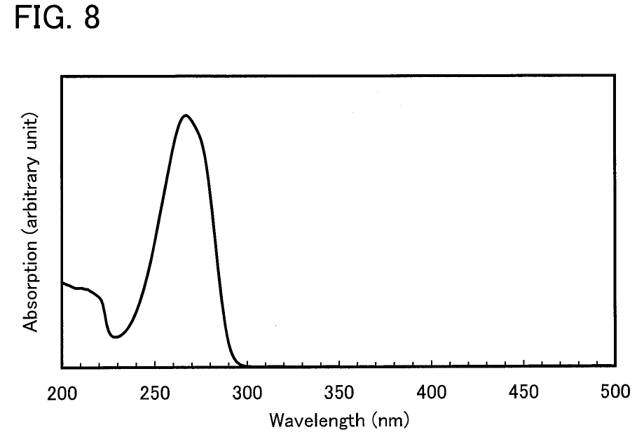

FIG. 8 shows an absorption spectrum of o2F-RM257-O3 in a dichloromethane solution of o2F-RM257-O3. The absorption spectrum was measured with a UV-visible spectrophotometer (V-550, manufactured by JASCO Corporation). In the measurement, the solution was put in a quartz cell. The absorption spectrum was obtained by subtracting the absorption spectra of the quartz cell and dichloromethane from the absorption spectra of the quartz cell and the solution. In FIG. 8, the horizontal axis represents wavelength (nm) and the vertical axis represents absorbance (arbitrary unit). In the absorption spectrum, an absorption peak is observed at around 267 nm.

### Example 2

In this example, an example of synthesizing 1,4-bis-[4-(6-acryloyloxy-n-hexyl-1-oxy)benzoyloxy]-2,3-difluorobenzene (abbreviation: o2F-RM257-O6) represented by Structural Formula (105) in Embodiment 1 will be described.

Synthesis method of 1,4-bis-[4-(6-acryloyloxy-n-hexyl-1-oxy)benzoyloxy]-2,3-difluorobenzene (abbreviation: o2F-RM257-O6)

A synthesis scheme of o2F-RM257-O6 (abbreviation) represented by Structural Formula (105) is shown in (A-2) given below.

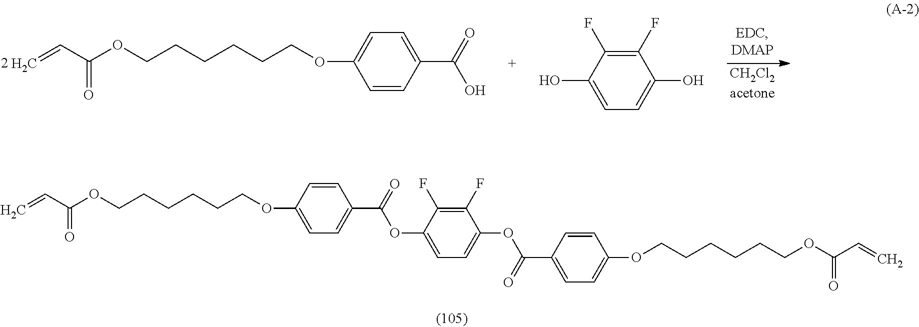

In a 300-mL recovery flask were put 2.2 g (7.5 mmol) of 4-(6-acryloyloxy-n-hexyl-1-oxy)benzoic acid, 0.53 g (3.6 mmol) of 2,3-difluoro-1,4-benzenediol, 0.14 g (1.1 mmol) of 4-dimethylaminopyridine (DMAP), 1.4 g (7.5 mmol) of 1-ethyl-3-(3-dimethylaminopropyl)carbodiimide hydrochloride (EDC), 100 mL of acetone, and 50 mL of dichloromethane. This solution was stirred at room temperature in the air for 115 hours. After that, completion of the reaction was confirmed by silica-gel thin layer chromatography (TLC). The obtained solution was concentrated, chloroform, a saturated aqueous solution of sodium hydrogen carbonate, and saturated saline were added to extract an organic layer, and an aqueous layer was extracted with chloroform three times. The organic layer and the extracted solution were mixed and dried with magnesium sulfate, and this mixture was gravity-filtered. The filtrate was concentrated, and the obtained solid was purified by silica gel column chromatography (developing solvent: chloroform). The obtained fraction was concentrated to give a white solid substance. The obtained white solid substance was purified by high-performance liquid chromatography (HPLC) to give 1.6 g of a white solid in a yield of 65%.

This compound was identified by a nuclear magnetic resonance (NMR) spectroscopy as 1,4-bis-[4-(6-acryloyloxy-n-hexyl-1-oxy)benzoyloxy]-2,3-difluorobenzene (abbreviation: o2F-RM257-O6) which was a target substance.

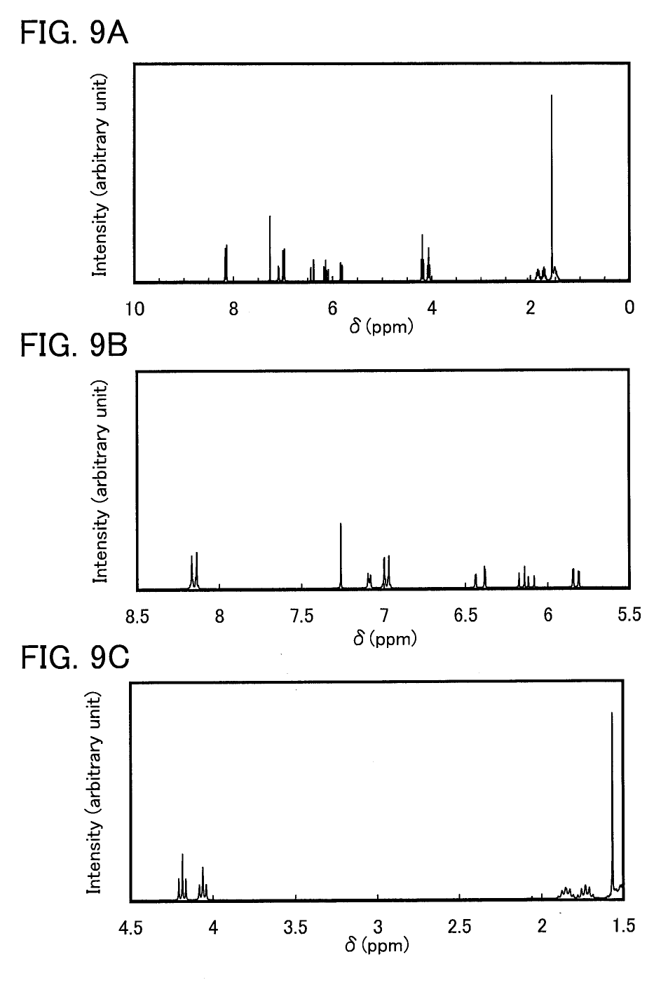

¹H NMR data of the obtained substance are as follows: ¹H NMR (CDCl₃, 300 MHz): δ (ppm)=1.43-1.61 (m, 8H), 1.69-1.78 (m, 4H), 1.81-1.90 (m, 4H), 4.06 (t, J=6.5 Hz, 4H), 4.19 (t, J=6.6 Hz, 4H), 5.83 (dd, J1=10.4 Hz, J2=1.4 Hz, 2H), 6.13 (dd, J1=10.2 Hz, J2=17.1 Hz, 2H), 6.41 (dd, J1=1.5 Hz, J2=17.1 Hz, 2H), 6.98 (d, J=6.9 Hz, 4H), 7.09 (d, J=4.5 Hz, 2H), 8.15 (d, J=8.7 Hz, 4H). FIGS. 9A to 9C are ¹H-NMR charts. Note that FIG. 9B is a chart in which the range of 5.5 ppm to 8.5 ppm in FIG. 9A is enlarged. Note that FIG. 9C is a chart in which the range of 1.5 ppm to 4.5 ppm in FIG. 9A is enlarged.

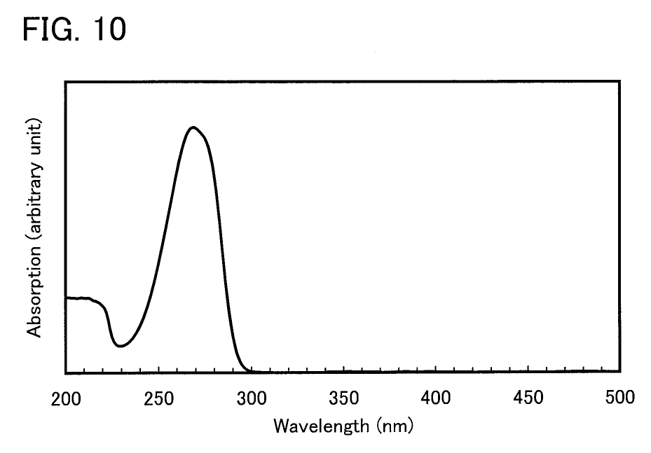

FIG. 10 shows an absorption spectrum of o2F-RM257-O6 in a dichloromethane solution of o2F-RM257-O6. The absorption spectrum was measured with a UV-visible spectrophotometer (V-550, manufactured by JASCO Corporation). In the measurement, the solution was put in a quartz cell. The absorption spectrum was obtained by subtracting the absorption spectra of the quartz cell and dichloromethane from the absorption spectra of the quartz cell and the solution. In FIG. 10, the horizontal axis represents wavelength (nm) and the vertical axis represents absorbance (arbitrary unit). In the absorption spectrum, an absorption peak is observed at around 269 nm.

### Example 3

In this example, an example of synthesizing 1,4-bis-[4-(3-acryloyloxy-n-propyl-1-oxy)benzoyloxy]-2,5-difluorobenzene (abbreviation: p2F-RM257-O3) represented by Structural Formula (305) in Embodiment 1 will be described.

Synthesis method of 1,4-bis-[4-(3-acryloyloxy-n-propyl-1-oxy)benzoyloxy]-2,5-difluorobenzene (abbreviation: p2F-RM257-O3)

A synthesis scheme of p2F-RM257-O3 (abbreviation) represented by Structural Formula (302) is shown in (B-1) given below.

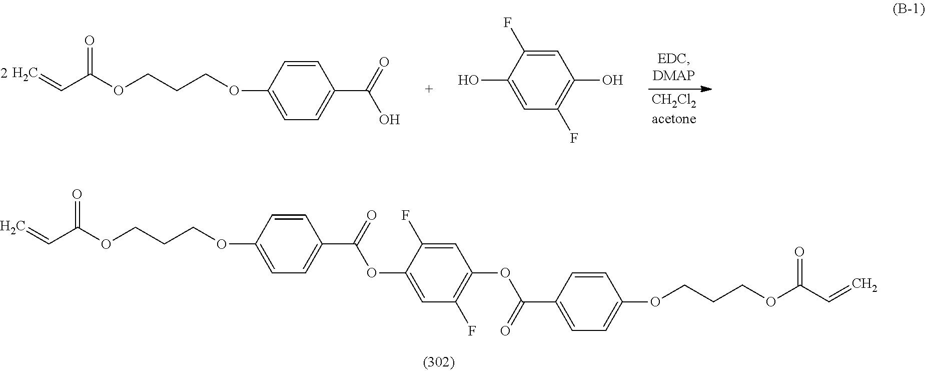

In a 500-mL recovery flask were put 1.5 g (6.0 mmol) of 4-(3-acryloyloxy-n-propyl-1-oxy)benzoic acid, 0.44 g (3.0 mmol) of 2,5-difluoro-1,4-benzenediol, 0.22 g (1.8 mmol) of 4-dimethylaminopyridine (DMAP), 1.2 g (6.0 mmol) of 1-ethyl-3-(3-dimethylaminopropyl)carbodiimide hydrochloride (EDC), 100 mL of acetone, and 50 mL of dichloromethane. This solution was stirred at room temperature in the air for 67 hours. After that, completion of the reaction was confirmed by silica-gel thin layer chromatography (TLC). The obtained solution was concentrated, chloroform, a saturated aqueous solution of sodium hydrogen carbonate, and saturated saline were added to extract an organic layer, and an aqueous layer was extracted with chloroform three times. The organic layer and the extracted solution were mixed and dried with magnesium sulfate, and this mixture was gravity-filtered. The filtrate was concentrated, and the obtained solid was purified by silica gel column chromatography (developing solvent: chloroform). The obtained fraction was concentrated to give a white solid substance. The obtained white solid substance was purified by high-performance liquid chromatography (HPLC) to give 0.36 g of a white solid in a yield of 20%.

This compound was identified by a nuclear magnetic resonance (NMR) spectroscopy as 1,4-bis-[4-(3-acryloyloxy-n-propyl-1-oxy)benzoyloxy]-2,5-difluorobenzene (abbreviation: p2F-RM257-O3) which was a target substance.

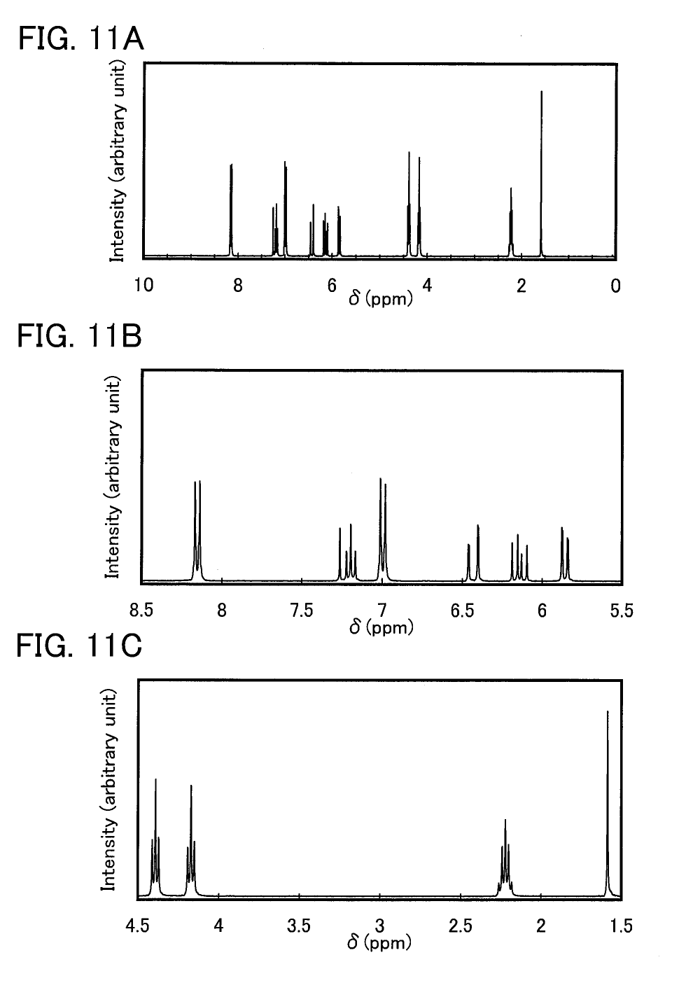

¹H NMR data of the obtained substance are as follows: ¹H NMR (CDCl₃, 300 MHz): δ (ppm)=2.18-2.27 (m, 4H), 4.17 (t, J=6.3 Hz, 4H), 4.39 (t, J=6.2 Hz, 4H), 5.86 (dd, J1=10.2 Hz, J2=1.5 Hz, 2H), 6.14 (dd, J1=10.5 Hz, J2=17.4 Hz, 2H), 6.43 (dd, J1=1.5 Hz, J2=17.1 Hz, 2H), 7.00 (d, J=9.0 Hz, 4H), 7.19 (t, J=8.6 Hz, 2H), 8.15 (d, J=8.7 Hz, 4H). FIGS. 11A to 11C are ¹H-NMR charts. Note that FIG. 11B is a chart in which the range of 5.5 ppm to 8.5 ppm in FIG. 11A is enlarged. Note that FIG. 11C is a chart in which the range of 1.5 ppm to 4.5 ppm in FIG. 11A is enlarged.

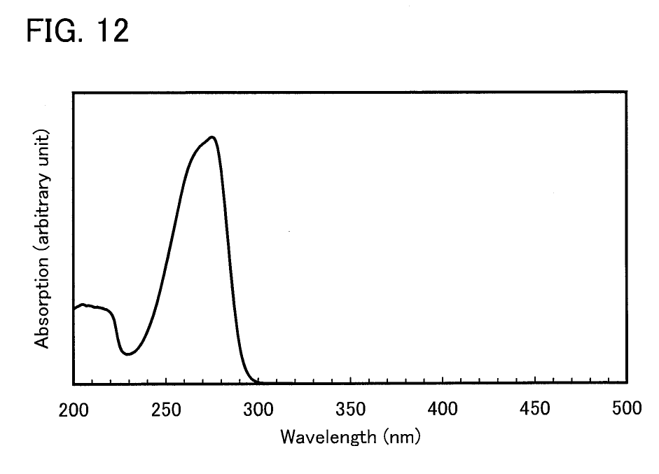

FIG. 12 shows an absorption spectrum of p2F-RM257-O3 in a dichloromethane solution of p2F-RM257-O3. The absorption spectrum was measured with a UV-visible spectrophotometer (V-550, manufactured by JASCO Corporation). In the measurement, the solution was put in a quartz cell. The absorption spectrum was obtained by subtracting the absorption spectra of the quartz cell and dichloromethane from the absorption spectra of the quartz cell and the solution. In FIG. 12, the horizontal axis represents wavelength (nm) and the vertical axis represents absorbance (arbitrary unit). In the absorption spectrum, an absorption peak is observed at around 275 nm.

### Example 4

In this example, an example of synthesizing 1,4-bis-[4-(6-acryloyloxy-n-hexyl-1-oxy)benzoyloxy]-2,5-difluorobenzene (abbreviation: p2F-RM257-O6) represented by Structural Formula (305) in Embodiment 1 will be described.

Synthesis method of 1,4-bis-[4-(6-acryloyloxy-n-hexyl-1-oxy)benzoyloxy]-2,5-difluorobenzene (abbreviation: p2F-RM257-O6)

A synthesis scheme of p2F-RM257-O6 (abbreviation) represented by Structural Formula (305) is shown in (B-2) given below.

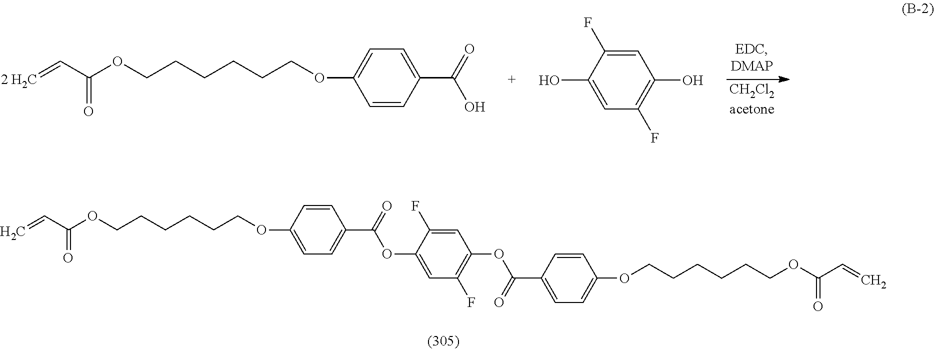

In a 500-mL recovery flask were put 2.0 g (6.8 mmol) of 4-(6-acryloyloxy-n-hexyl-1-oxy)benzoic acid, 0.45 g (3.1 mmol) of 2,5-difluoro-1,4-benzenediol, 0.13 g (1.0 mmol) of 4-dimethylaminopyridine (DMAP), 1.3 g (6.8 mmol) of 1-ethyl-3-(3-dimethylaminopropyl)carbodiimide hydrochloride (EDC), 80 mL of acetone, and 40 mL of dichloromethane. This solution was stirred at room temperature in the air for 18 hours. After that, completion of the reaction was confirmed by silica-gel thin layer chromatography (TLC). The obtained solution was concentrated, chloroform, a saturated aqueous solution of sodium hydrogen carbonate, and saturated saline were added to extract an organic layer, and an aqueous layer was extracted with chloroform three times. The organic layer and the extracted solution were mixed and dried with magnesium sulfate, and this mixture was gravity-filtered. The filtrate was concentrated, and the obtained solid was purified by silica gel column chromatography (developing solvent: chloroform). The obtained fraction was concentrated to give a white solid substance. The obtained white solid substance was purified by high-performance liquid chromatography (HPLC) to give 0.20 g of a white solid in a yield of 9.3%.

This compound was identified by a nuclear magnetic resonance (NMR) spectroscopy as 1,4-bis-[4-(6-acryloyloxy-n-hexyl-1-oxy)benzoyloxy]-2,5-difluorobenzene (abbreviation: p2F-RM257-O6) which was a target substance.

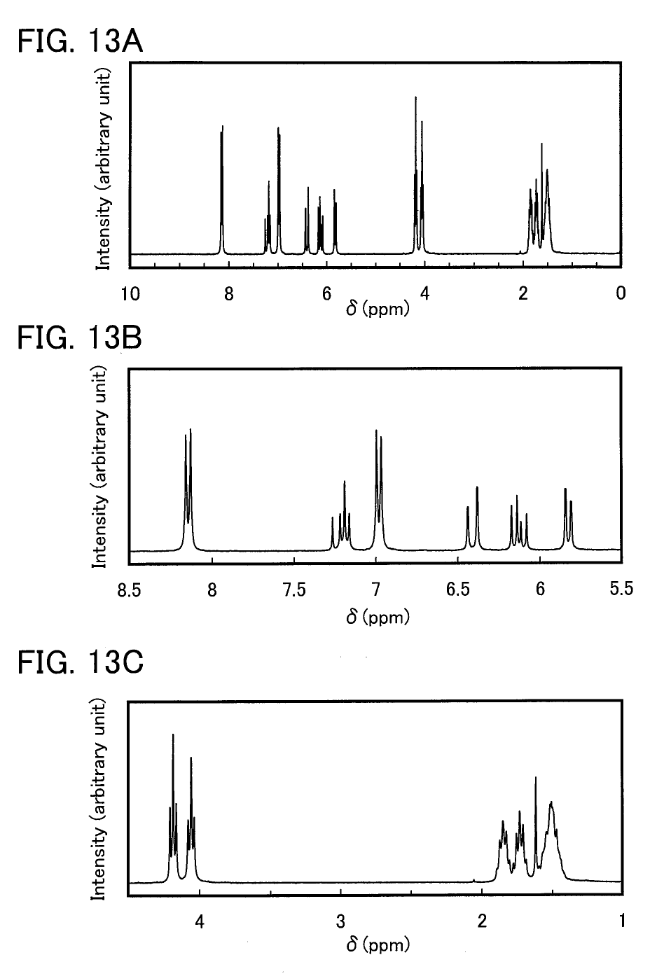

¹H NMR data of the obtained substance are as follows: ¹H NMR (CDCl₃, 300 MHz): δ (ppm)=1.47-1.54 (m, 8H), 1.69-1.76 (m, 4H), 1.71-1.87 (m 4H), 4.06 (t, J=6.3 Hz, 4H), 4.19 (t, J=6.6 Hz, 4H), 5.83 (dd, J1=10.5 Hz, J2=1.2 Hz, 2H), 6.13 (dd, J1=10.5 Hz, J2=17.4 Hz, 2H), 6.41 (dd, J1=1.4 Hz, J2=17.3 Hz, 2H), 6.98 (d, J=8.7 Hz, 4H), 7.19 (t, J=8.3 Hz, 2H), 8.14 (d, J=8.7 Hz, 4H). FIGS. 13A to 13C are ¹H-NMR charts. Note that FIG. 13B is a chart in which the range of 5.5 ppm to 8.5 ppm in FIG. 13A is enlarged. Note that FIG. 13C is a chart in which the range of 1.5 ppm to 4.5 ppm in FIG. 13A is enlarged.

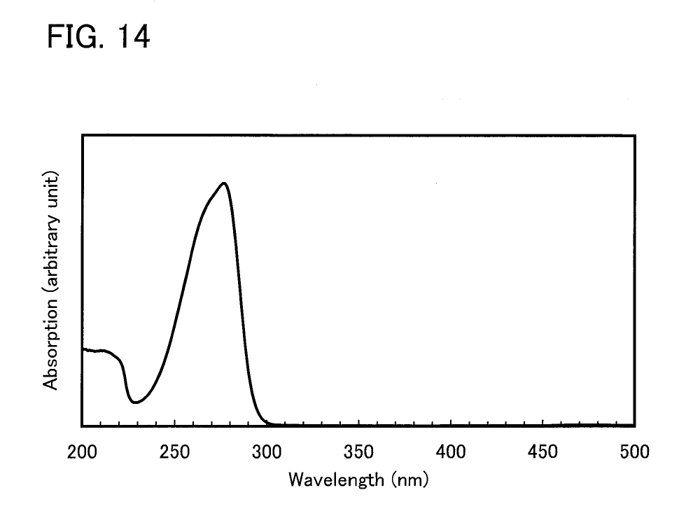

FIG. 14 shows an absorption spectrum of p2F-RM257-O6 in a dichloromethane solution of p2F-RM257-O6. The absorption spectrum was measured with a UV-visible spectrophotometer (V-550, manufactured by JASCO Corporation). In the measurement, the solution was put in a quartz cell. The absorption spectrum was obtained by subtracting the absorption spectra of the quartz cell and dichloromethane from the absorption spectra of the quartz cell and the solution. In FIG. 14, the horizontal axis represents wavelength (nm) and the vertical axis represents absorbance (arbitrary unit). In the absorption spectrum, an absorption peak is observed at around 276 nm.

### Example 5

In this example, an example of synthesizing 1,4-bis-[4-(8-acryloyloxy-n-octyl-1-oxy)benzoyloxy]-2,5-difluorobenzene (abbreviation: p2F-RM257-O8) represented by Structural Formula (307) in Embodiment 1 will be described.

Synthesis method of 1,4-bis-[4-(8-acryloyloxy-n-octyl-1-oxy)benzoyloxy]-2,5-difluorobenzene (abbreviation: p2F-RM257-O8)

A synthesis scheme of p2F-RM257-O8 (abbreviation) represented by Structural Formula (309) is shown in (B-3) given below.

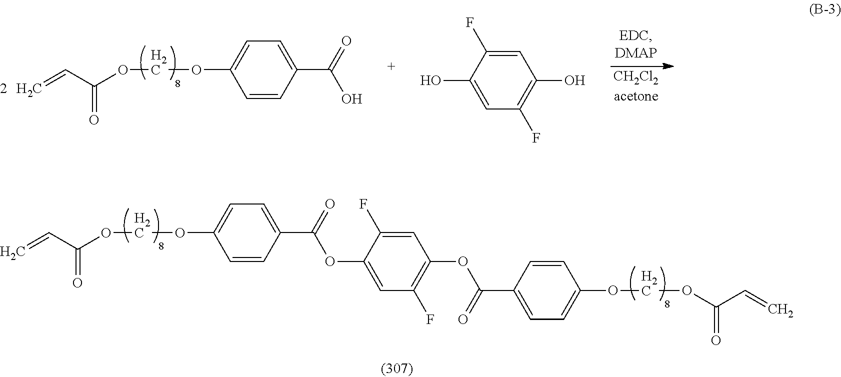

In a 300-mL recovery flask were put 1.5 g (4.7 mmol) of 4-(8-acryloyloxy-n-octyl-1-oxy)benzoic acid, 0.68 g (2.3 mmol) of 2,5-difluoro-1,4-benzenediol, 0.17 g (1.4 mmol) of 4-dimethylaminopyridine (DMAP), 0.90 g (4.7 mmol) of 1-ethyl-3-(3-dimethylaminopropyl)carbodiimide hydrochloride (EDC), 100 mL of acetone, and 50 mL of dichloromethane. This solution was stirred at room temperature in the air for 24 hours. After that, completion of the reaction was confirmed by silica-gel thin layer chromatography (TLC). The obtained solution was concentrated, and chloroform, a saturated aqueous solution of sodium hydrogen carbonate, and saturated saline were added to extract an organic layer, and an aqueous layer was extracted with chloroform three times. The organic layer and the extracted solution were mixed and dried with magnesium sulfate, and this mixture was gravity-filtered. The filtrate was concentrated, and the obtained solid was purified by silica gel column chromatography (developing solvent: chloroform). The obtained fraction was concentrated to give a white solid substance. The obtained white solid substance was purified by high-performance liquid chromatography (HPLC) to give 0.63 g of a white solid in a yield of 36%.

This compound was identified by a nuclear magnetic resonance (NMR) spectroscopy as 1,4-bis-[4-(8-acryloyloxy-n-octyl-1-oxy)benzoyloxy]-2,5-difluorobenzene (abbreviation: p2F-RM257-O8) which was a target substance.

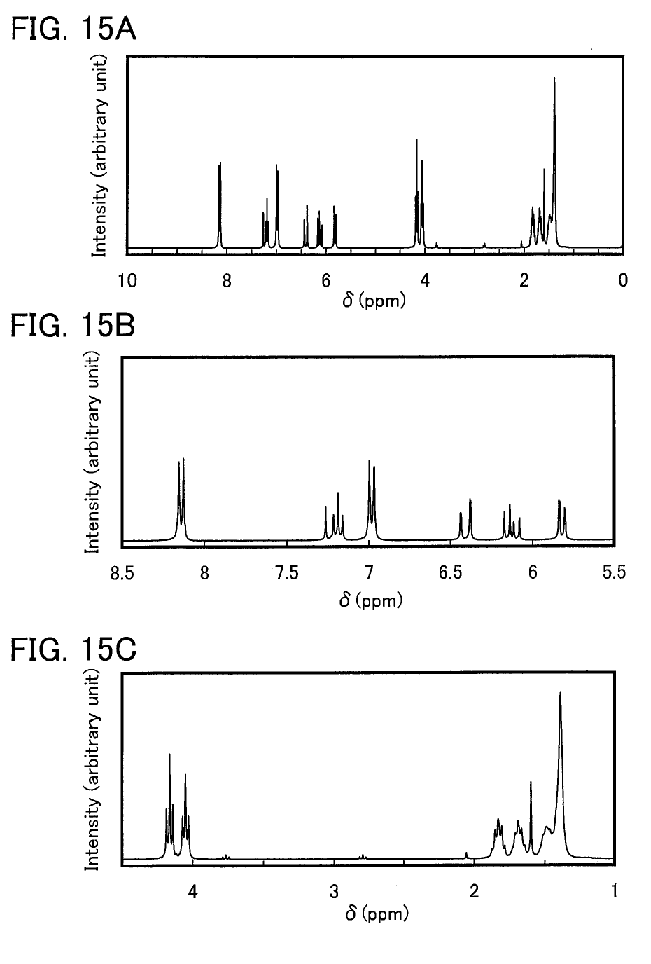

¹H NMR data of the obtained substance are as follows: ¹H NMR (CDCl₃, 300 MHz): δ (ppm)=1.39-1.48 (m, 16H), 1.64-1.71 (m, 4H), 1.78-1.87 (m, 4H), 4.05 (t, J=6.3 Hz, 4H), 4.16 (t, J=6.9 Hz, 4H), 5.82 (dd, J1=10.2 Hz, J2=1.5 Hz, 2H), 6.13 (dd, J1=10.5 Hz, J2=17.1 Hz, 2H), 6.41 (dd, J1=1.5 Hz, J2=17.7 Hz, 2H), 6.98 (d, J=8.7 Hz, 4H), 7.19 (t, J=8.3 Hz, 2H), 8.14 (d, J=8.7 Hz, 4H). FIGS. 15A and 15B are ¹H NMR charts. Note that FIG. 15B is a chart in which the range of 5.5 ppm to 8.5 ppm in FIG. 15A is enlarged. Note that FIG. 15C is a chart in which the range of 1.0 ppm to 4.5 ppm in FIG. 15A is enlarged.

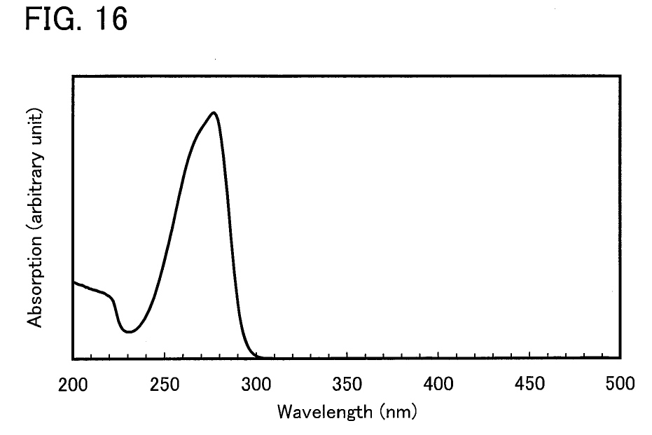

FIG. 16 shows an absorption spectrum of p2F-RM257-O8 in a dichloromethane solution of p2F-RM257-O8. The absorption spectrum was measured with a UV-visible spectrophotometer (V-550, manufactured by JASCO Corporation). In the measurement, the solution was put in a quartz cell. The absorption spectrum was obtained by subtracting the absorption spectra of the quartz cell and dichloromethane from the absorption spectra of the quartz cell and the solution. In FIG. 16, the horizontal axis represents wavelength (nm) and the vertical axis represents absorbance (arbitrary unit). In the absorption spectrum, an absorption peak is observed at around 269 nm.

### Example 6

In this example, liquid crystal elements (Liquid Crystal Elements 1 to 5) which included the liquid crystal compositions of one embodiment of the present invention described in Examples 1 to 5 and Comparative Liquid Crystal Element 1 for comparison which did not include the liquid crystal composition of one embodiment of the present invention were manufactured, and characteristics of the elements were evaluated.

Table 1 shows structures of liquid crystal compositions used in Liquid Crystal Elements 1 to 5 and Comparative Liquid Crystal Element 1 manufactured in this example. In Table 1, the mixture proportions are all represented by weight percent (wt %).

TABLE 1

| | Components | | | | | | |
|---|---|---|---|---|---|---|---|
| | | | | | | Comparative | |
| | Liquid | Liquid | Liquid | Liquid | Liquid | Liquid | |
| | crystal | crystal | crystal | crystal | crystal | Crystal | ratio |
| | element 1 | element 2 | element 3 | element 4 | element 5 | Element 1 | (wt %) |
| Liquid crystal 1 | E-8 | | | | | | 33.97 |
| Liquid crystal 2 | CPP-3FF | | | | | | 25.48 |
| Liquid crystal 3 | PEP-5CNF | | | | | | 25.48 |
| Chiral agent | ISO-(6OBA)₂ | | | | | | 6.89 |
| Polymerizable | DMeAc | | | | | | 3.99 |
| monomer | 2pF-RM257- | 2pF-RM257- | 2pF-RM257- | 2oF-RM257- | 2oF-RM257- | RM257 | 3.99 |
| | O3 | O6 | O8 | O3 | O6 | | |

| | | |
|---|---|---|
| Polymerization | DMPAP | 0.20 |
| initiator | | |
| Total | | 100.00 |

In Liquid Crystal Elements 1 to 5 and Comparative Liquid Crystal Element 1, the following components were used: liquid crystal mixture E-8 (produced by LCC Corporation) as Liquid Crystal 1; 4-(trans-4-n-propylcyclohexyl)-3′,4′-difluoro-1,1′-biphenyl (abbreviation: CPP-3FF) (produced by Daily Polymer Corporation) as Liquid Crystal 2; 4-n-pentylbenzoic acid 4-cyano-3-fluorophenyl (abbreviation: PEP-5CNF) (produced by Daily Polymer Corporation) as Liquid Crystal 3; 1,4:3,6-dianhydro-2,5-bis[4-(n-hexyl-1-oxy)benzoic acid]sorbitol (abbreviation: ISO-(6OBA)₂) (produced by Midori Kagaku Co., Ltd.) as a chiral material; dodecyl methacrylate (abbreviation: DMeAc) (produced by Tokyo Chemical Industry Co., Ltd.) which is a non-liquid-crystalline UV polymerizable monomer as a polymerizable monomer; and DMPAP (abbreviation) (produced by Tokyo Chemical Industry Co., Ltd.) as a polymerization initiator.

The structural formulae of CPP-3FF (abbreviation) as Liquid Crystal 2, PEP-5CNF (abbreviation) as Liquid Crystal 3, ISO-(6OBA)₂ (abbreviation) as the chiral material, dodecyl methacrylate (DMeAc) (abbreviation), and DMPAP (abbreviation) as the polymerization initiator, which were used in this example, are shown below.

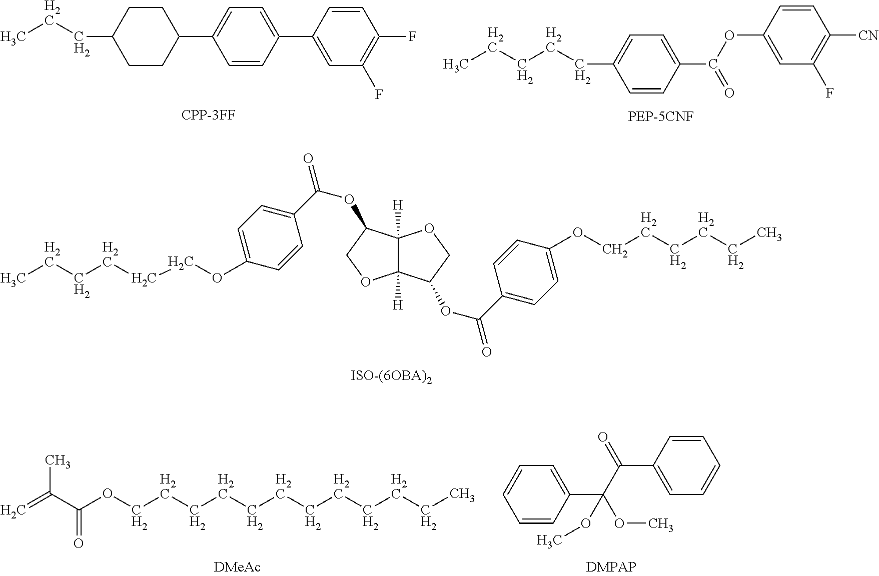

The liquid crystal compositions in Liquid Crystal Elements 1, 2, 3, 4, and 5 and Comparative Liquid Crystal Element 1 shown in Table 1 further include the following respective polymerizable monomers: p2F-RM257-O3 (abbreviation) represented by Structural Formula (302) given below; p2F-RM257-O6 (abbreviation) represented by Structural Formula (305) given below; p2F-RM257-O8 (abbreviation) represented by Structural Formula (307) given below; o2F-RM257-O3 (abbreviation) represented by Structural Formula (102) given below; o2F-RM257-O6 (abbreviation) represented by Structural Formula (105) given below; and RM257 (abbreviation) (produced by Merck Ltd., Japan) given below.

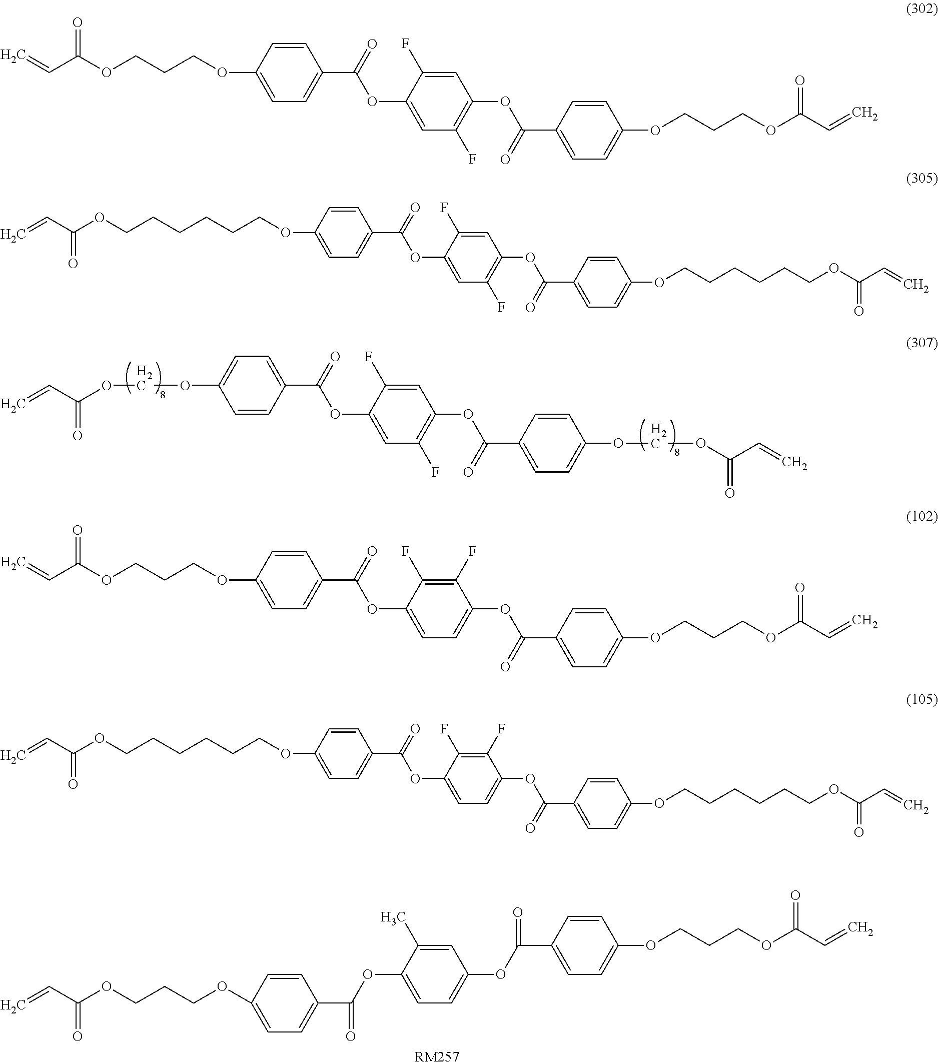

Liquid Crystal Elements 1 to 5 and Comparative Liquid Crystal Element 1 were each manufactured in the following manner: a glass substrate serving as a counter substrate and a glass substrate over which a pixel electrode layer and a common electrode layer were formed in comb-like shapes as illustrated in FIG. 3D were bonded to each other using sealant with a space (4 μm) provided therebetween; and then each of liquid crystal compositions in which the materials shown in Table 1 had been mixed in the proportions shown in Table 1 and which had been stirred was injected in an isotropic phase between the substrates by an injection method.

The pixel electrode layer and the common electrode layer were formed using indium tin oxide containing silicon oxide by a sputtering method. The thickness of each of the pixel electrode layer and the common electrode layer was 110 nm, the width of each of the pixel electrode layer and the common electrode layer was 5 μM, and the distance between the pixel electrode layer and the common electrode layer was 5 μM. Further, ultraviolet and heat curable sealing material was used as the sealant. As curing treatment, ultraviolet light irradiation treatment (irradiance: 100 mW/cm²) was performed for 90 seconds, and then heat treatment was performed at 120° C. for one hour.

Further, polymer stabilization treatment was performed on each of Liquid Crystal Elements 1 to 5 and Comparative Liquid Crystal Element 1 in the following manner: each of Liquid Crystal Elements 1 to 5 and Comparative Liquid Crystal Element 1 was set at a given constant temperature within the range of temperatures at which a blue phase is exhibited and was irradiated with ultraviolet light (light source: metal halide lamp, wavelength: 365 nm, irradiance: 9 mW/cm²) for 6 minutes.

Voltage was applied to Liquid Crystal Elements 1 to 5 and Comparative Liquid Crystal Element 1, and the transmittance with respect to the applied voltage was evaluated. The characteristic evaluation was performed with Liquid Crystal Elements 1 to 5 and Comparative Liquid Crystal Element 1 interposed between polarizers in crossed nicols under the conditions that a halogen lamp was used as a light source and the temperature was room temperature.

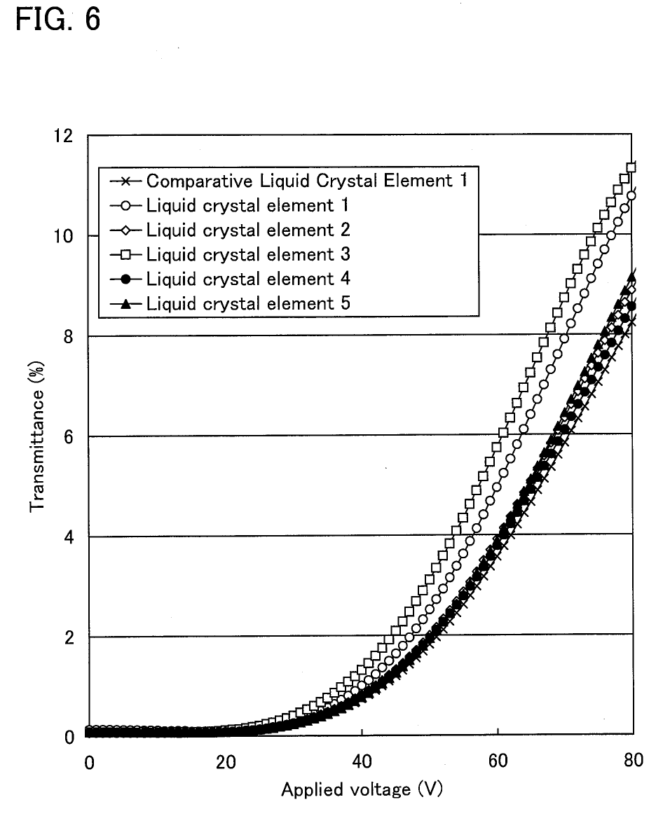

FIG. 6 shows the relation between applied voltage and transmittance of Liquid Crystal Elements 1 to 5 and Comparative Liquid Crystal Element 1. Note that in FIG. 6, white circles represent Liquid Crystal Element 1, white rhombuses represent Liquid Crystal Element 2, white squares represent Liquid Crystal Element 3, black circles represent Liquid Crystal Element 4, black triangles represent Liquid Crystal Element 5, and crosses represent Comparative Liquid Crystal Element 1.

FIG. 6 shows that each of Liquid Crystal Elements 1 to 5 has high transmittance at lower applied voltage than in the case of Comparative Liquid Crystal Element 1, so that Liquid Crystal Elements 1 to 5 are capable of low voltage driving.

Consequently, the liquid crystal element in which the liquid crystal composition including the novel polymerizable monomer of this example is capable of low voltage driving; thus, a reduction in power consumption of a liquid crystal display device and an electronic appliance including the liquid crystal element can be achieved.

### Example 7

In this example, an example of synthesizing 1,4-bis-[4-(3-acryloyloxy-n-propyl-1-oxy)benzoyloxy]-2,3,5,6-tetrafluorobenzene (abbreviation: 4F-RM257-O3) represented by Structural Formula (502) in Embodiment 1 will be described.

Synthesis method of 1,4-bis-[4-(3-acryloyloxy-n-propyl-1-oxy)benzoyloxy]-2,3,5,6-tetrafluorobenzene (abbreviation: 4F-RM257-O3)

A synthesis scheme of 4F-RM257-O3 (abbreviation) represented by Structural Formula (502) is shown in (G-1) given below.

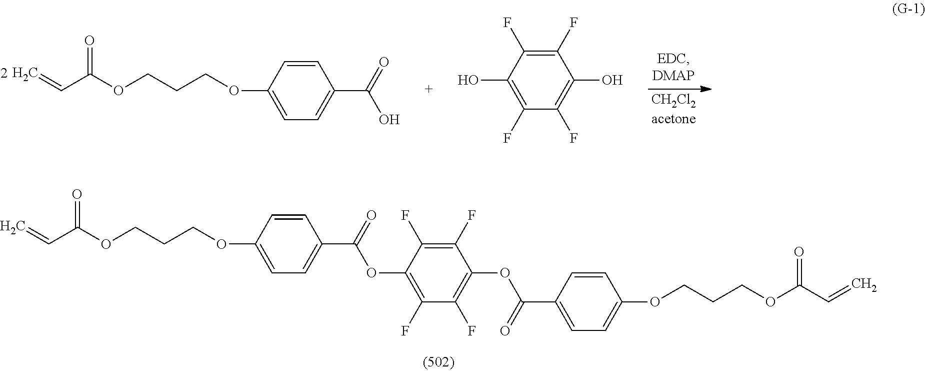

In a 300-mL recovery flask were put 2.0 g (8.0 mmol) of 4-(3-acryloyloxy-n-propyl-1-oxy)benzoic acid, 0.66 g (3.6 mmol) of tetrafluoro-1,4-benzenediol, 0.29 g (2.4 mmol) of 4-dimethylaminopyridine (DMAP), 1.5 g (8.0 mmol) of 1-ethyl-3-(3-dimethylaminopropyl)carbodiimide hydrochloride (EDC), 80 mL of acetone, and 40 mL of dichloromethane. This solution was stirred at room temperature in the air for 21 hours. After that, completion of the reaction was confirmed by silica-gel thin layer chromatography (TLC). The obtained solution was concentrated, and dichloromethane, a saturated aqueous solution of sodium hydrogen carbonate, and saturated saline were added to extract an organic layer, and an aqueous layer was extracted with dichloromethane three times. The organic layer and the extracted solution were mixed and dried with magnesium sulfate, and this mixture was gravity-filtered. The filtrate was concentrated, and the obtained solid was purified by silica gel column chromatography (developing solvent: chloroform). The obtained fraction was concentrated to give a white solid substance. The obtained white solid substance was purified by high-performance liquid chromatography (HPLC) to give 0.79 g of a white solid in a yield of 34%.

This compound was identified by a nuclear magnetic resonance (NMR) spectroscopy as 1,4-bis-[4-(3-acryloyloxy-n-propyl-1-oxy)benzoyloxy]-2,3,5,6-tetrafluorobenzene (abbreviation: 4F-RM257-O3) which was a target substance.

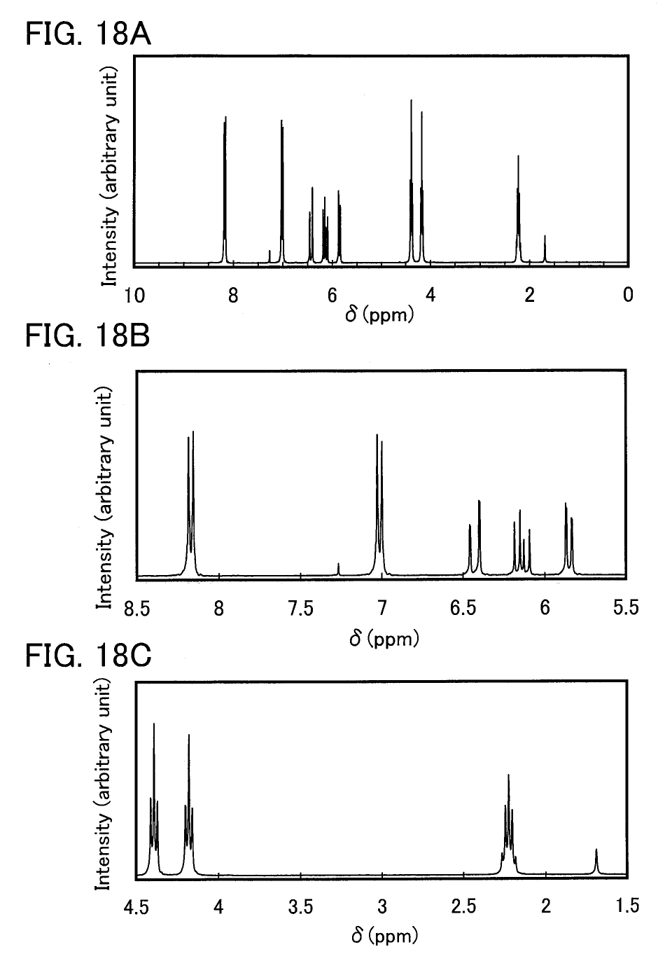

¹H NMR data of the obtained substance are as follows: ¹H NMR (CDCl₃, 300 MHz): δ (ppm)=2.19-2.27 (m, 4H), 4.18 (t, J=6.2 Hz, 4H), 4.39 (t, J=6.3 Hz, 4H), 5.85 (dd, J1=10.5 Hz, J2=1.2 Hz, 2H), 6.14 (dd, J1=10.7 Hz, J2=17.3 Hz, 2H), 6.43 (dd, J1=1.5 Hz, J2=17.1 Hz, 2H), 7.01 (d, J=9.0 Hz, 4H), 8.17 (d, J=8.7 Hz, 4H). FIGS. 18A to 18C are ¹H-NMR charts. Note that FIG. 18B is a chart in which the range of 5.5 ppm to 8.5 ppm in FIG. 18A is enlarged. Note that FIG. 18C is a chart in which the range of 1.5 ppm to 4.5 ppm in FIG. 18A is enlarged.

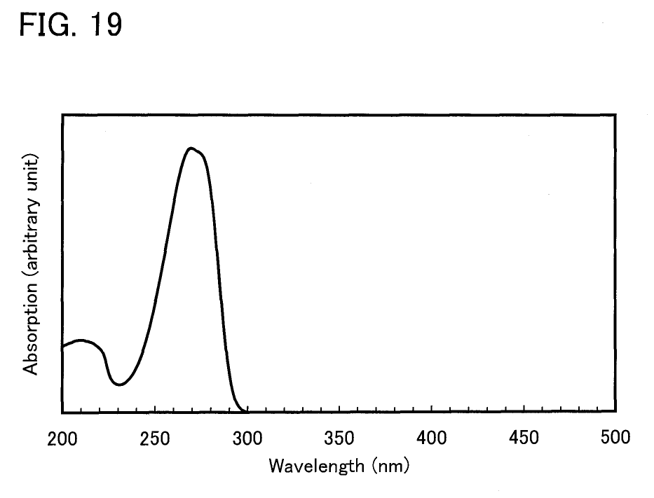

FIG. 19 shows an absorption spectrum of 4F-RM257-O3 in a dichloromethane solution of 4F-RM257-O3. The absorption spectrum was measured with a UV-visible spectrophotometer (V-550, manufactured by JASCO Corporation). In the measurement, the solution was put in a quartz cell. The absorption spectrum was obtained by subtracting the absorption spectra of the quartz cell and dichloromethane from the absorption spectra of the quartz cell and the solution. In FIG. 19, the horizontal axis represents wavelength (nm) and the vertical axis represents absorbance (arbitrary unit). In the absorption spectrum, an absorption peak is observed at around 269 nm.

### Example 8

In this example, an example of synthesizing 1,4-bis-[4-(6-acryloyloxy-n-hexyl-1-oxy)benzoyloxy]-2,3,5,6-tetrafluorobenzene (abbreviation: 4F-RM257-O6) represented by Structural Formula (505) in Embodiment 1 will be described.

Synthesis method of 1,4-bis-[4-(6-acryloyloxy-n-hexyl-1-oxy)benzoyloxy]-2,3,5,6-tetrafluorobenzene (abbreviation: 4F-RM257-O6)

A synthesis scheme of 4F-RM257-O6 (abbreviation) represented by Structural Formula (505) is shown in (G-4) given below.

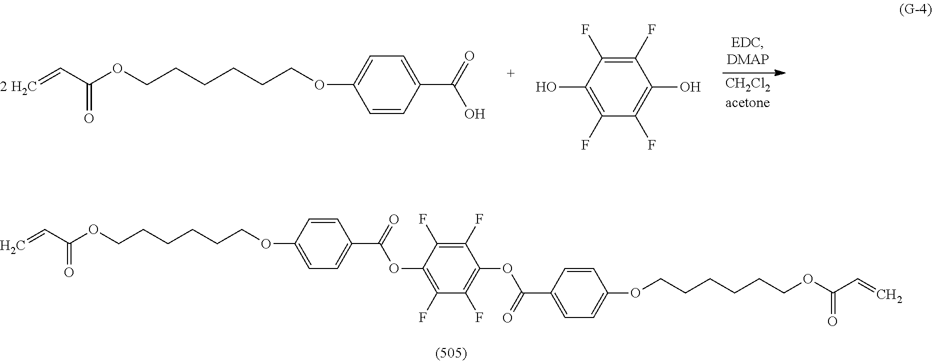

In a 300-mL recovery flask were put 2.0 g (6.8 mmol) of 4-(6-acryloyloxy-n-hexyl-1-oxy)benzoic acid, 0.53 g (3.2 mmol) of tetrafluoro-1,4-benzenediol, 0.15 g (1.2 mmol) of 4-dimethylaminopyridine (DMAP), 1.5 g (8.0 mmol) of 1-ethyl-3-(3-dimethylaminopropyl)carbodiimide hydrochloride (EDC), 100 mL of acetone, and 50 mL of dichloromethane. This solution was stirred at room temperature in the air for 23 hours. After that, completion of the reaction was confirmed by silica-gel thin layer chromatography (TLC). The obtained solution was concentrated, chloroform, a saturated aqueous solution of sodium hydrogen carbonate, and saturated saline were added to extract an organic layer, and an aqueous layer was extracted with chloroform three times. The organic layer and the extracted solution were mixed and dried with magnesium sulfate, and this mixture was gravity-filtered.

The filtrate was concentrated, and the obtained solid was purified by silica gel column chromatography (developing solvent: chloroform). The obtained fraction was concentrated to give a white solid substance. The obtained white solid substance was purified by high-performance liquid chromatography (HPLC) to give 1.1 g of a white solid in a yield of 56%.

This compound was identified by a nuclear magnetic resonance (NMR) spectroscopy as 1,4-bis-[4-(6-acryloyloxy-n-hexyl-1-oxy)benzoyloxy]-2,3,5,6-tetrafluorobenzene (abbreviation: 4F-RM257-O6) which was a target substance.

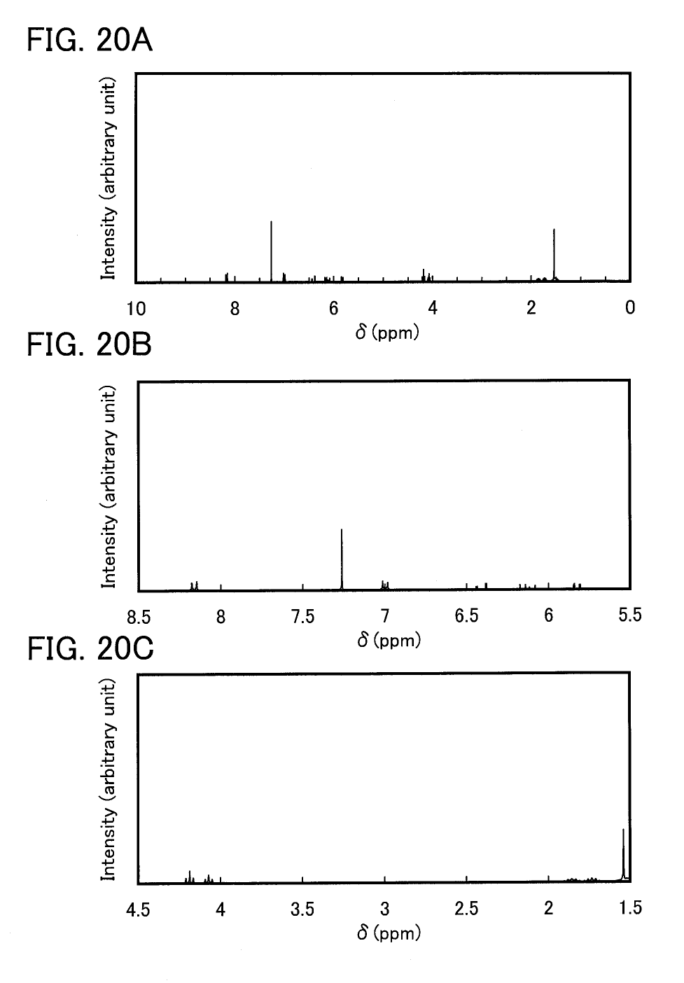

¹H NMR data of the obtained substance are as follows: ¹H NMR (CDCl₃, 300 MHz): δ (ppm)=1.48-1.51 (m, 8H), 1.69-1.88 (m, 8H), 4.07 (t, J=6.5 Hz, 4H), 4.19 (t, J=6.8 Hz, 4H), 5.83 (dd, J1=10.2 Hz, J2=1.5 Hz, 2H), 6.13 (dd, J1=10.4 Hz, J2=17.6 Hz, 2H), 6.41 (dd, J1=1.7 Hz, J2=17.3 Hz, 2H), 7.00 (d, J=9.3 Hz, 4H), 8.16 (d, J=9.3 Hz, 4H). FIGS. 20A to 20C are ¹H-NMR charts. Note that FIG. 20B is a chart in which the range of 5.5 ppm to 8.5 ppm in FIG. 20A is enlarged. Note that FIG. 20C is a chart in which the range of 1.5 ppm to 4.5 ppm in FIG. 20A is enlarged.

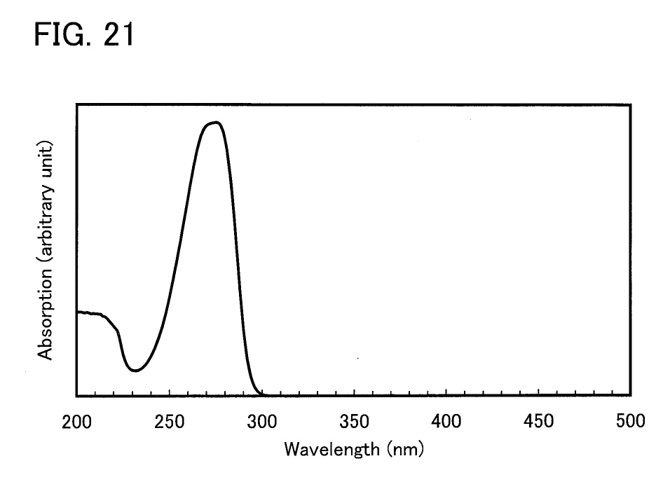

FIG. 21 shows an absorption spectrum of 4F-RM257-O6 in a dichloromethane solution of 4F-RM257-O6. The absorption spectrum was measured with a UV-visible spectrophotometer (V-550, manufactured by JASCO Corporation). In the measurement, the solution was put in a quartz cell. The absorption spectrum was obtained by subtracting the absorption spectra of the quartz cell and dichloromethane from the absorption spectra of the quartz cell and the solution. In FIG. 21, the horizontal axis represents wavelength (nm) and the vertical axis represents absorbance (arbitrary unit). In the absorption spectrum, an absorption peak is observed at around 275 nm.

### Example 9

In this example, an example of synthesizing 1,4-bis-[4-(10-acryloyloxy-n-decyl-1-oxy)benzoyloxy]-2,3,5,6-tetrafluorobenzene (abbreviation: 4F-RM257-O10) represented by Structural Formula (509) in Embodiment 1 will be described.

Synthesis method of 1,4-bis-[4-(10-acryloyloxy-n-decyl-1-oxy)benzoyloxy]-2,3,5,6-tetrafluorobenzene (abbreviation: 4F-RM257-O 10)

A synthesis scheme of 4F-RM257-O10 (abbreviation) represented by Structural Formula (509) is shown in (G-5) given below.

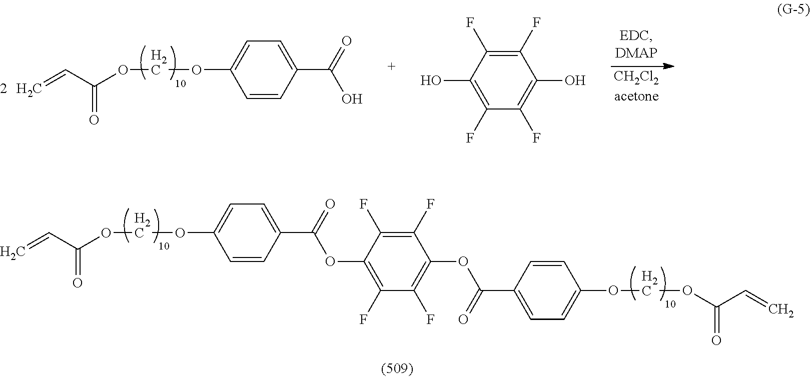

In a 200-mL recovery flask were put 1.0 g (2.9 mmol) of 4-(10-acryloyloxy-n-decyl-1-oxy)benzoic acid, 0.24 g (1.3 mmol) of tetrafluoro-1,4-benzenediol, 0.11 g (0.86 mmol) of 4-dimethylaminopyridine (DMAP), 0.55 g (2.9 mmol) of 1-ethyl-3-(3-dimethylaminopropyl)carbodiimide hydrochloride (EDC), 80 mL of acetone, and 40 mL of dichloromethane. This solution was stirred at room temperature in the air for 19 hours. After that, completion of the reaction was confirmed by silica-gel thin layer chromatography (TLC). The obtained solution was concentrated, and chloroform, a saturated aqueous solution of sodium hydrogen carbonate, and saturated saline were added to extract an organic layer, and an aqueous layer was extracted with chloroform three times. The organic layer and the extracted solution were mixed and dried with magnesium sulfate, and this mixture was gravity-filtered. The filtrate was concentrated, and the obtained solid was purified by silica gel column chromatography (developing solvent: chloroform). The obtained fraction was concentrated to give a white solid substance. The obtained white solid substance was purified by high-performance liquid chromatography (HPLC) to give 0.65 g of a white solid in a yield of 59%.

This compound was identified by a nuclear magnetic resonance (NMR) spectroscopy as 1,4-bis-[4-(10-acryloyloxy-n-decyl-1-oxy)benzoyloxy]-2,3,5,6-tetrafluorobenzene (abbreviation: 4F-RM257-O10) which was a target substance.

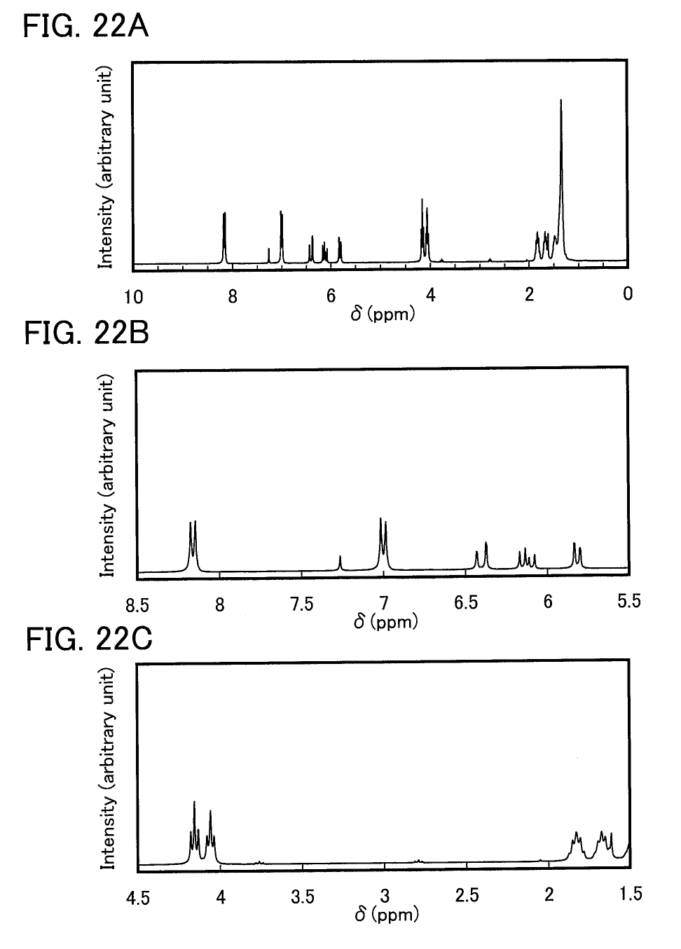

¹H NMR data of the obtained substance are as follows: ¹H NMR (CDCl₃, 300 MHz): δ (ppm)=1.26-1.48 (m, 24H), 1.63-1.70 (m, 4H), 1.78-1.87 (m, 4H), 4.06 (t, J=6.3 Hz, 4H), 4.16 (t, J=6.6 Hz, 4H), 5.82 (dd, J1=10.5 Hz, J2=1.2 Hz, 2H), 6.12 (dd, J1=10.2 Hz, J2=17.7 Hz, 2H), 6.40 (dd, J1=1.2 Hz, J2=17.4 Hz, 2H), 7.00 (d, J=9.0 Hz, 4H), 8.16 (d, J=9.0 Hz, 4H). FIGS. 22A to 22C are ¹H-NMR charts. Note that FIG. 22B is a chart in which the range of 5.5 ppm to 8.5 ppm in FIG. 22A is enlarged. Note that FIG. 22C is a chart in which the range of 1.5 ppm to 4.5 ppm in FIG. 22A is enlarged.

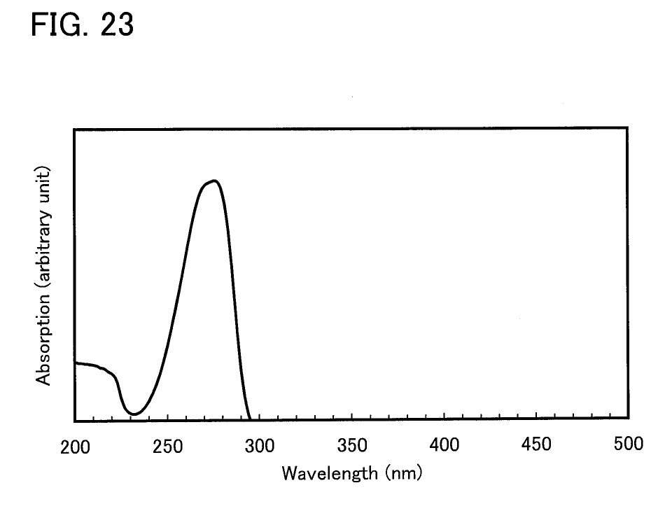

FIG. 23 shows an absorption spectrum of 4F-RM257-O10 in a dichloromethane solution of 4F-RM257-O10. The absorption spectrum was measured with a UV-visible spectrophotometer (V-550, manufactured by JASCO Corporation). In the measurement, the solution was put in a quartz cell. The absorption spectrum was obtained by subtracting the absorption spectra of the quartz cell and dichloromethane from the absorption spectra of the quartz cell and the solution. In FIG. 23, the horizontal axis represents wavelength (nm) and the vertical axis represents absorbance (arbitrary unit). In the absorption spectrum, an absorption peak is observed at around 276 nm.

### Example 10

In this example, an example of synthesizing 1,4-bis-[4-(12-acryloyloxy-n-dodecyl-1-oxy)benzoyloxy]-2,3,5,6-tetrafluorobenzene (abbreviation: 4F-RM257-O12) represented by Structural Formula (511) in Embodiment 1 will be described.

Synthesis method of 1,4-bis-[4-(12-acryloyloxy-n-dodecyl-1-oxy)benzoyloxy]-2,3,5,6-tetrafluorobenzene (abbreviation: 4F-RM257-O12)

A synthesis scheme of 4F-RM257-O12 (abbreviation) represented by Structural Formula (511) is shown in (G-6) given below.

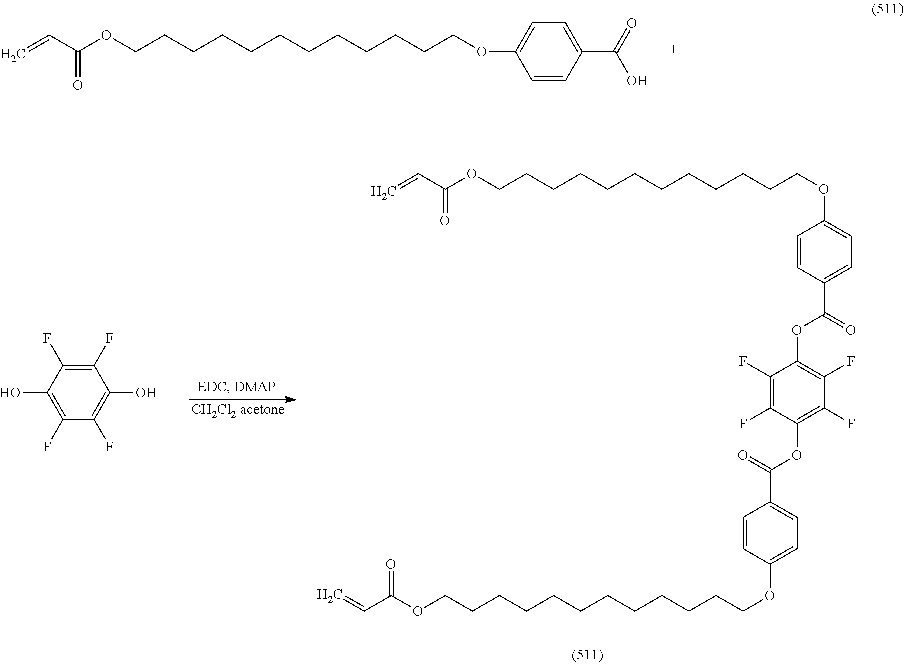 [SMILES: C=CC(=O)OCCCCCCCCCCCCOc1ccc(C(=O)O)cc1 ; Oc1c(F)c(F)c(O)c(F)c1F ; "CH2Cl2 acetone" ; C=CC(=O)OCCCCCCCCCCCCOc1ccc(C(=O)Oc2c(F)c(F)c(OC(=O)c3ccc(OCCCCCCCCCCCCOC(=O)C=C)cc3)c(F)c2F)cc1]

In a 200-mL recovery flask were put 1.5 g (4.0 mmol) of 4-(12-acryloyloxy-n-dodecyl-1-oxy)benzoic acid, 0.35 g (1.9 mmol) of tetrafluoro-1,4-benzenediol, 0.15 g (1.2 mmol) of 4-dimethylaminopyridine (DMAP), 0.76 g (4.0 mmol) of 1-ethyl-3-(3-dimethylaminopropyl)carbodiimide hydrochloride (EDC), 100 mL of acetone, and 40 mL of dichloromethane. This solution was stirred at room temperature in the air for 24 hours. After that, completion of the reaction was confirmed by silica-gel thin layer chromatography (TLC). The obtained solution was concentrated, and chloroform, a saturated aqueous solution of sodium hydrogen carbonate, and saturated saline were added to extract an organic layer, and an aqueous layer was extracted with chloroform three times. The organic layer and the extracted solution were mixed and dried with magnesium sulfate, and this mixture was gravity-filtered. The filtrate was concentrated, and the obtained solid was purified by silica gel column chromatography (developing solvent: chloroform). The obtained fraction was concentrated to give a white solid substance. The obtained white solid substance was purified by high-performance liquid chromatography (HPLC) to give 1.2 g of a white solid in a yield of 70%.

This compound was identified by a nuclear magnetic resonance (NMR) spectroscopy as 1,4-bis-[4-(12-acryloyloxy-n-dodecyl-1-oxy)benzoyloxy]-2,3,5,6-tetrafluorobenzene (abbreviation: 4F-RM257-O12) which was a target substance.

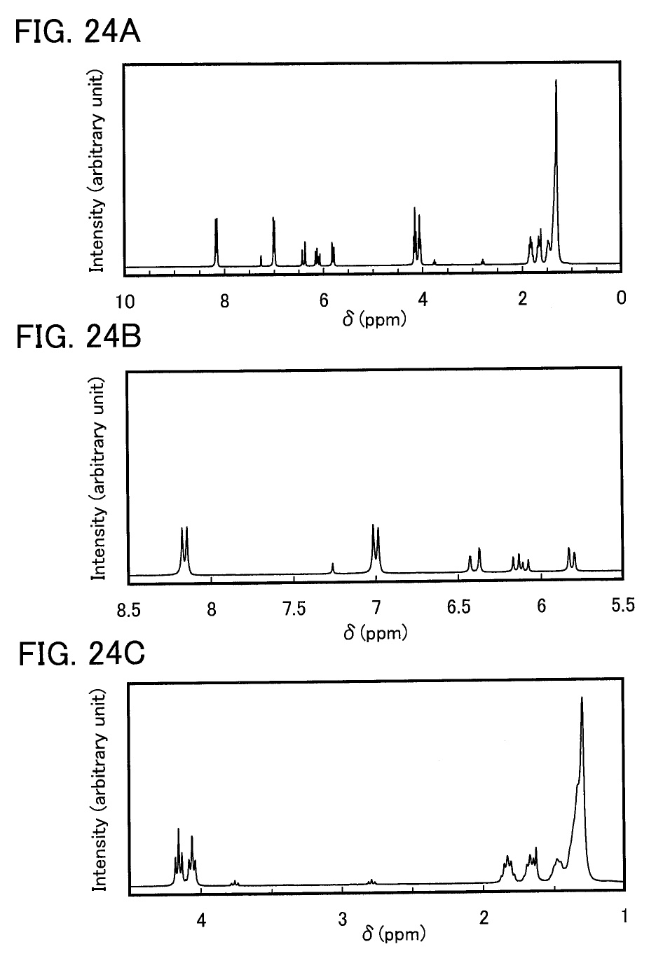

¹H NMR data of the obtained substance are as follows: ¹H NMR (CDCl₃, 300 MHz): δ (ppm)=1.12-1.48 (m, 32H), 1.63-1.69 (m, 4H), 1.78-1.88 (m, 4H), 4.06 (t, J=6.6 Hz, 4H), 4.15 (t, J=6.6 Hz, 4H), 5.82 (dd, J1=10.2 Hz, J2=1.2 Hz, 2H), 6.12 (dd, J1=10.2 Hz, J2=17.4 Hz, 2H), 6.40 (dd, J1=1.2 Hz, J2=17.4 Hz, 2H), 6.73 (d, J=8.4 Hz, 4H), 8.16 (d, J=9.0 Hz, 4H). Note that FIG. 24B is a chart in which the range of 5.5 ppm to 8.5 ppm in FIG. 24A is enlarged. Note that FIG. 24C is a chart in which the range of 1.0 ppm to 4.5 ppm in FIG. 24A is enlarged.

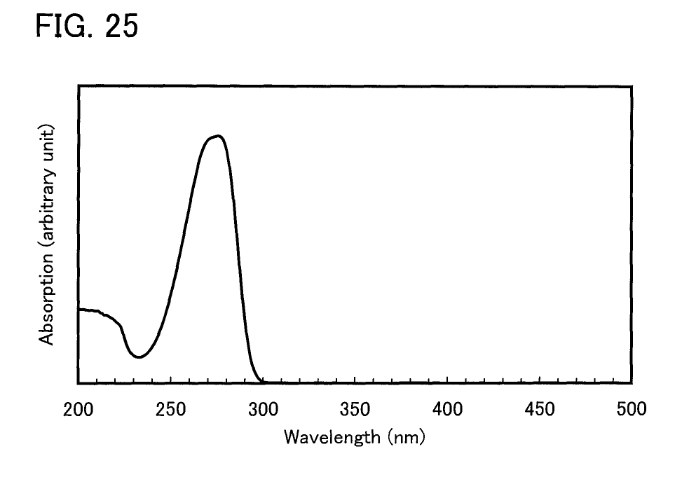

FIG. 25 shows an absorption spectrum of 4F-RM257-O12 in a dichloromethane solution of 4F-RM257-O12. The absorption spectrum was measured with a UV-visible spectrophotometer (V-550, manufactured by JASCO Corporation). In the measurement, the solution was put in a quartz cell. The absorption spectrum was obtained by subtracting the absorption spectra of the quartz cell and dichloromethane from the absorption spectra of the quartz cell and the solution. In FIG. 25, the horizontal axis represents wavelength (nm) and the vertical axis represents absorbance (arbitrary unit). In the absorption spectrum, an absorption peak is observed at around 275 nm.

### Example 11

In this example, liquid crystal elements (Liquid Crystal Elements 6 to 8) which included the liquid crystal compositions of one embodiment of the present invention described in Examples 8 to 10 and Comparative Liquid Crystal Element 2 for comparison which did not include the liquid crystal composition of one embodiment of the present invention were manufactured, and characteristics of the elements were evaluated.

Table 2 and Table 3 show structures of the liquid crystal compositions used in Liquid Crystal Elements 6 to 8, and Comparative Liquid Crystal Element 2 manufactured in this example. In each of Table 2 and Table 3, the mixture proportions are all represented by weight percent.

TABLE 2

| | Components | | | |
|---|---|---|---|---|
| | | Liquid | Comparative | |
| | Liquid crystal | crystal | Liquid Crystal | ratio |
| | element 6 | element 7 | Element 2 | (wt %) |
| Liquid crystal 1 | E-8 | | | 33.97 |
| Liquid crystal 2 | CPP-3FF | | | 25.48 |
| Liquid crystal 3 | PEP-5CNF | | | 25.48 |
| Chiral agent | ISO-(6OBA)₂ | | | 6.89 |
| Polymerizable | DMeAc | | | 3.99 |
| monomer | 4F-RM257-O6 | 4F- | RM257 | 3.99 |
| | | RM257-O10 | | |

| | | |
|---|---|---|
| Polymerization | DMPAP | 0.20 |
| initiator | | |
| Total | | 100.00 |

In each of Liquid Crystal Elements 6 and 7, and Comparative Liquid Crystal Element 2, the following components were used: liquid crystal mixture E-8 (produced by LCC Corporation) as Liquid Crystal 1; 4-(trans-4-n-propylcyclohexyl)-3′,4′-difluoro-1,1′-biphenyl (abbreviation: CPP-3FF) (produced by Daily Polymer Corporation) as Liquid Crystal 2; 4-n-pentylbenzoic acid 4-cyano-3-fluorophenyl (abbreviation: PEP-5CNF) (produced by Daily Polymer Corporation) as Liquid Crystal 3; 1,4:3,6-dianhydro-2,5-bis[4-(n-hexyl-1-oxy)benzoic acid]sorbitol (abbreviation: ISO-(6OBA)₂) (produced by Midori Kagaku Co., Ltd.) as a chiral material.

TABLE 3

| | Components | |
|---|---|---|
| | Liquid crystal | |
| | element 8 | ratio (wt %) |
| Liquid crystal 1 | MDA-00-3506 | 32.8 |
| Liquid crystal 2 | CPEP-3FCNF | 16.4 |
| Liquid crystal 3 | PEP-3FCNF | 24.6 |
| Liquid crystal 4 | PEP-2FCNF | 8.2 |
| Chiral agent | R-DOL-Pn | 6.7 |
| Polymerizable | DMeAc | 5.5 |
| monomer | 4F-RM257-O12 | 5.5 |
| Polymerization initiator | DMPAP | 0.3 |
| Total | | 100.0 |

In Liquid Crystal Element 8, the following components were used: MDA-00-3506 (produced by Merck Ltd., Japan) as Liquid Crystal 1; 4-(trans-4-n-propylcyclohexyl)benzoic acid 4-cyano-3,5-difluorophenyl (abbreviation: CPEP-3FCNF) as Liquid Crystal 2; 4-n-propyl benzoic acid 4-cyano-3,5-difluorophenyl (abbreviation: PEP-3FCNF) as Liquid Crystal 3; 4-n-ethyl benzoic acid 4-cyano-3,5-difluorophenyl (abbreviation: PEP-2FCNF) as Liquid Crystal 4; and (4R,5R)-4,5-bis[hydroxy-di(phenanthren-9-yl)methyl]-2,2-dimethyl-1,3-dioxolane (abbreviation: R-DOL-Pn) as a chiral material.

In each of Liquid Crystal Elements 6 to 8 and Comparative Liquid Crystal Element 2, dodecyl methacrylate (abbreviation: DMeAc) (produced by Tokyo Chemical Industry Co., Ltd.) which is a non-liquid-crystalline UV polymerizable monomer was used as a polymerizable monomer, and DMPAP (abbreviation) (produced by Tokyo Chemical Industry Co., Ltd.) was used as a polymerization initiator.

Note that shown below are structural formulae of CPP-3FF (abbreviation), PEP-5CNF (abbreviation), CPEP-3FCNF (abbreviation), PEP-3FCNF (abbreviation), PEP-2FCNF (abbreviation), ISO-(6OBA)₂ (abbreviation), R-DOL-Pn (abbreviation), DMeAc (abbreviation), and DMPAP (abbreviation).

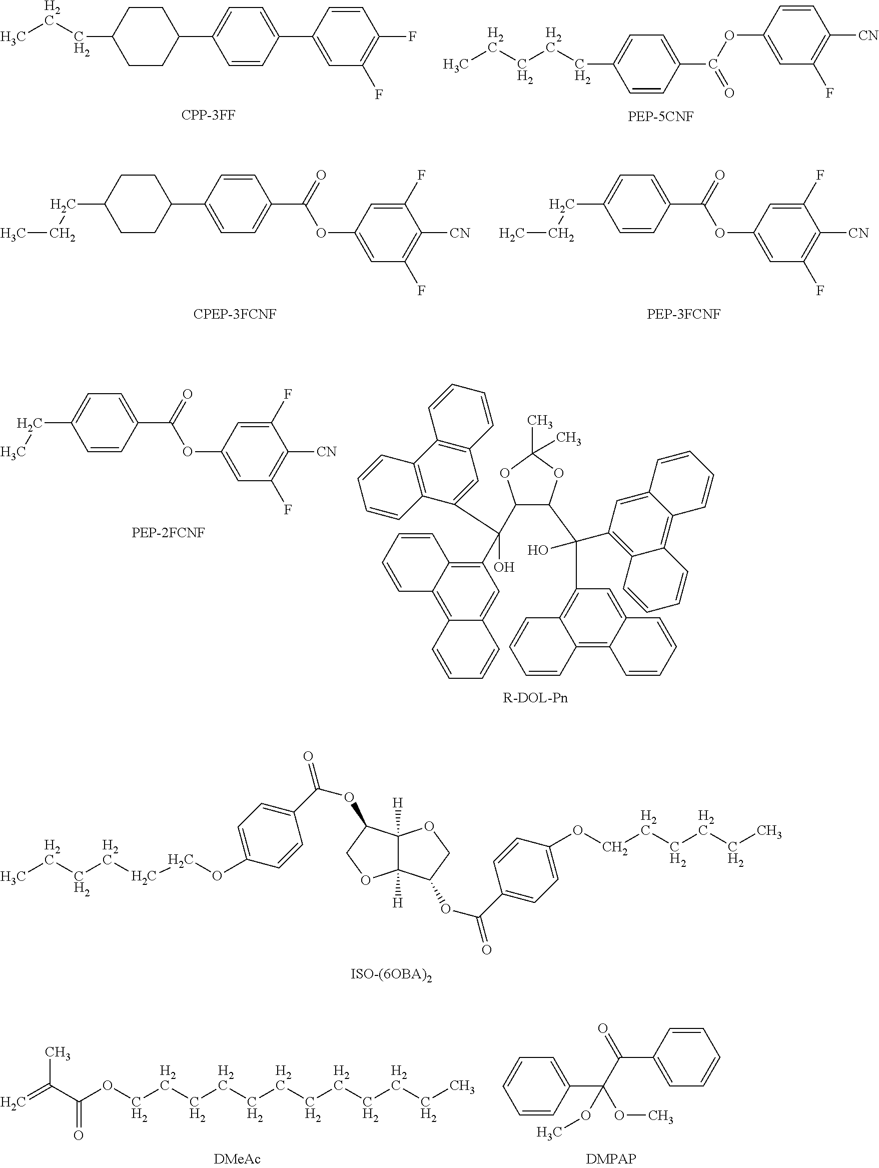

The liquid crystal compositions in Liquid Crystal Elements 6, 7, and 8 and Comparative Liquid Crystal Element 2 shown in Table 2 further include the following respective polymerizable monomers: 4F-RM257-O6 (abbreviation) represented by Structural Formula (505) given below; 4F-RM257-O10 (abbreviation) represented by Structural Formula (509) given below; 4F-RM257-O12 (abbreviation) represented by Structural Formula (511) given below; and RM257 (abbreviation) (produced by Merck Ltd., Japan) given below.

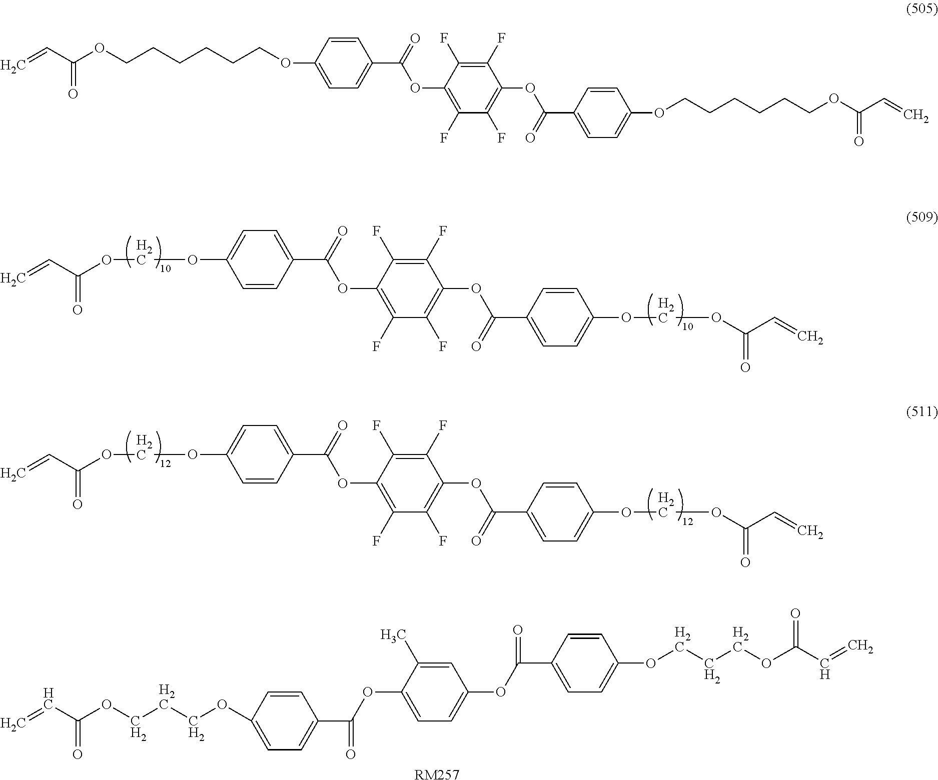

Liquid Crystal Elements 6 to 8 and Comparative Liquid Crystal Element 2 were each manufactured in the following manner: a glass substrate serving as a counter substrate and a glass substrate over which a pixel electrode layer and a common electrode layer were formed in comb-like shapes as illustrated in FIG. 3D were bonded to each other using sealant with a space (4 μm) provided therebetween; and then a liquid crystal composition in which the materials shown in each of Tables 2 and 3 had been mixed in the proportions shown in each of Tables 2 and 3 and which had been stirred was injected in an isotropic phase between the substrates by an injection method.

The pixel electrode layer and the common electrode layer were formed using indium tin oxide containing silicon oxide by a sputtering method. The thickness of each of the pixel electrode layer and the common electrode layer was 110 nm, the width of each of the pixel electrode layer and the common electrode layer was 5 μm, and the distance between the pixel electrode layer and the common electrode layer was 5 μm. Further, ultraviolet and heat curable sealing material was used as the sealant. As curing treatment, ultraviolet light irradiation treatment (irradiance: 100 mW/cm²) was performed for 90 seconds, and then heat treatment was performed at 120° C. for one hour.

Further, polymer stabilization treatment was performed on each of Liquid Crystal Elements 6 to 8 and Comparative Liquid Crystal Element 2 in the following manner: each of Liquid Crystal Elements 6 to 8 and Comparative Liquid Crystal

Element 2 was set at a given constant temperature within the range of temperatures at which a blue phase is exhibited, and was irradiated with ultraviolet light (light source: metal halide lamp, wavelength: 365 nm, irradiance: 8 mW/cm²) for 30 minutes.

Voltage was applied to Liquid Crystal Elements 6 to 8 and Comparative Liquid Crystal Element 2, and the transmittance with respect to the applied voltage was evaluated. The characteristic evaluation was performed with Liquid Crystal Elements 6 to 8 and Comparative Liquid Crystal Element 2 interposed between polarizers in crossed nicols under the conditions that a halogen lamp was used as a light source and the temperature was room temperature.

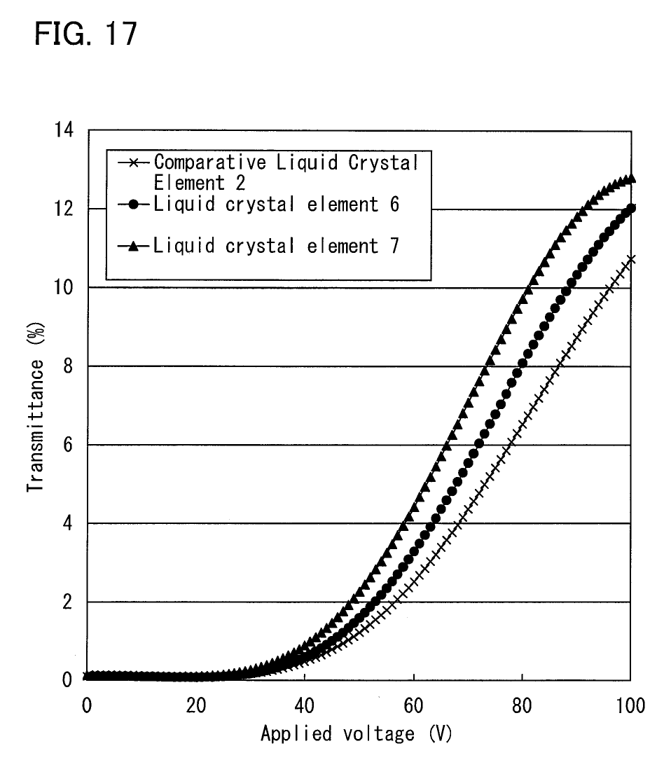

FIG. 17 shows the relation between applied voltage and transmittance of Liquid Crystal Elements 6 and 7 and Comparative Liquid Crystal Element 2. Note that in FIG. 17, circles represent Liquid Crystal Element 6, triangles represent Liquid Crystal Element 7, and crosses represent Comparative Liquid Crystal Element 2.

FIG. 17 shows that each of Liquid Crystal Elements 6 and 7 has high transmittance at lower applied voltage than in the case of Comparative Liquid Crystal Element 2, so that Liquid Crystal Elements 6 and 7 are capable of low voltage driving.

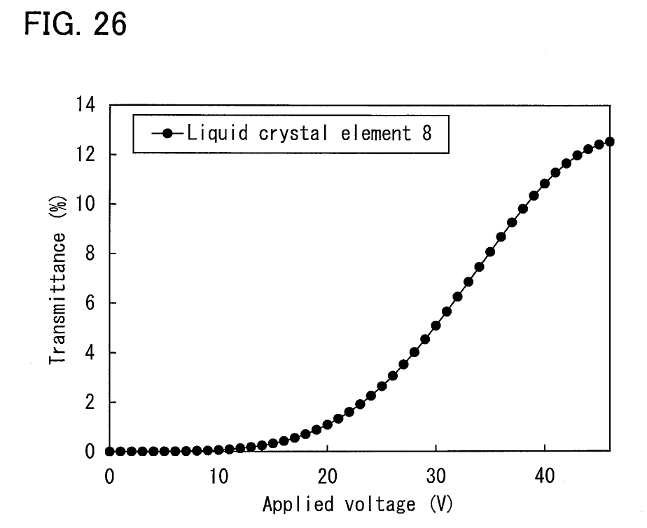

FIG. 26 shows the relation between applied voltage and transmittance of Liquid Crystal Element 8. Note that in FIG. 26, circles represent Liquid Crystal Element 8. FIG. 26 shows that Liquid Crystal Element 8 also has high transmittance at low applied voltage, so that Liquid Crystal Element 8 is capable of low voltage driving.

Consequently, the liquid crystal element in which the novel liquid crystal composition of this example is used is capable of low voltage driving; thus, a reduction in power consumption of a liquid crystal display device and an electronic appliance including the liquid crystal element can be achieved.

### Example 12

Synthesis methods of CPEP-3FCNF (abbreviation), PEP-3FCNF (abbreviation), PEP-2FCNF (abbreviation), and R-DOL-Pn (abbreviation) which are used in Example 11 will be shown below.

Synthesis Method of 4-(trans-4-n-propylcyclohexyl)benzoic acid 4-cyano-3,5-difluorophenyl (abbreviation: CPEP-3FCNF)

A synthesis scheme of CPEP-3FCNF (abbreviation) is shown in (J-1) given below.

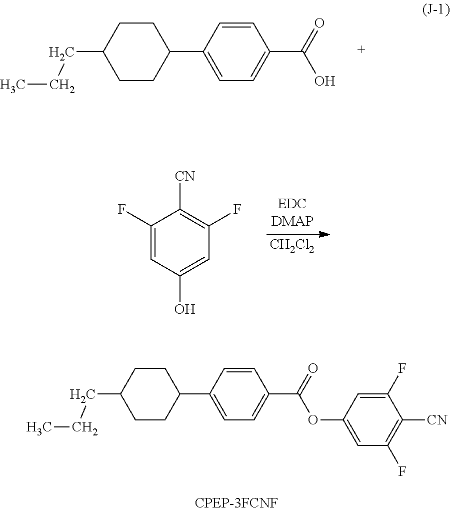

Synthesis Method of 4-n-propyl benzoic acid 4-cyano-3,5-difluorophenyl (abbreviation: PEP-3FCNF)

A synthesis scheme of PEP-3FCNF (abbreviation) is shown in (K-1) given below.

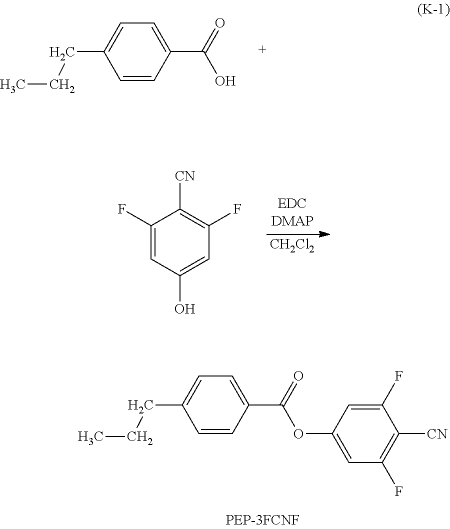

Synthesis Method of 4-n-ethyl benzoic acid 4-cyano-3,5-difluorophenyl (abbreviation: PEP-2FCNF)

A synthesis scheme of PEP-2FCNF (abbreviation) is shown in (K-2) given below.

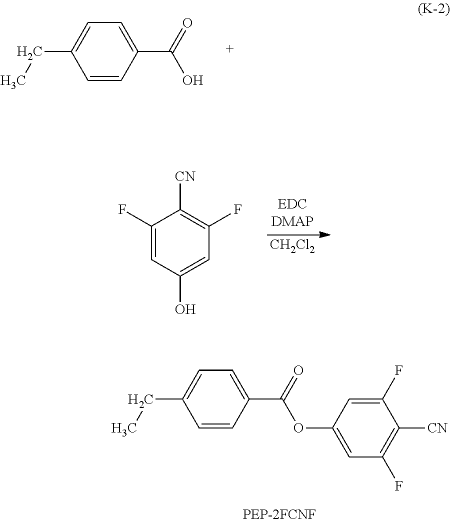

Synthesis method of (4R,5R)-4,5-bis[hydroxy-di(phenanthren-9-yl)methyl]-2,2-dimethyl-1,3-dioxolane (abbreviation: R-DOL-Pn)

A synthetic scheme of R-DOL-Pn (abbreviation) is shown in (L-1) given below.

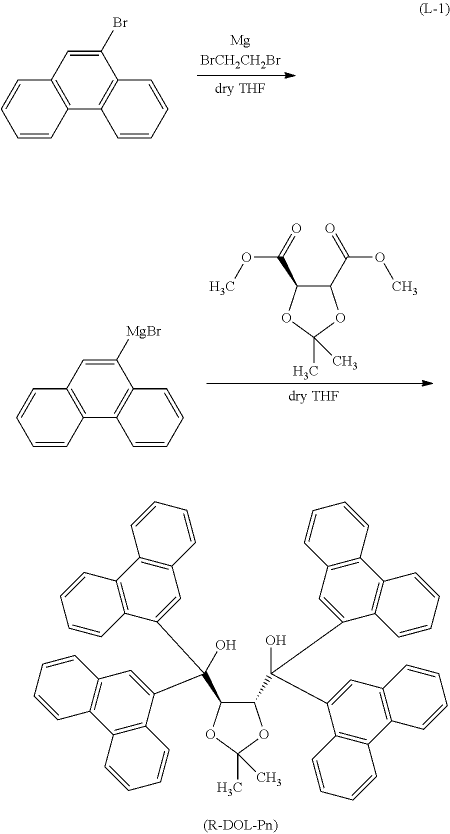

This application is based on Japanese Patent Application serial no. 2012-O81529 filed with the Japan Patent Office on Mar. 30, 2012 and Japanese Patent Application serial no. 2012-O81601 filed with the Japan Patent Office on Mar. 30, 2012, the entire contents of which are hereby incorporated by reference.

What is claimed is:

1. A compound represented by General Formula (G1) given below: 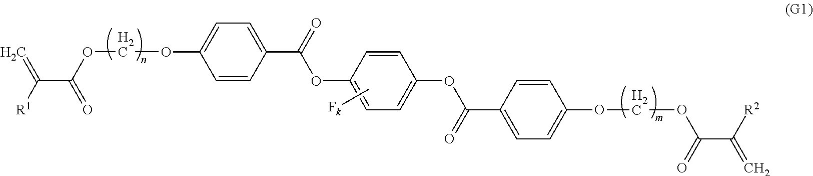
wherein k is 2 or 3,
wherein n and m are individually an integer from 1 to 20, and
wherein R¹ and R² individually represent hydrogen or a methyl group.

2. The compound according to claim 1,
wherein R¹ and R² individually represent hydrogen.

3. The compound according to claim 1,
wherein n=m.

4. The compound according to claim 1,
wherein n=m, and
wherein R¹ and R² individually represent hydrogen.

5. A compound represented by General Formula (G11), General Formula (G12), General Formula (G13), or General Formula (G14) given below: 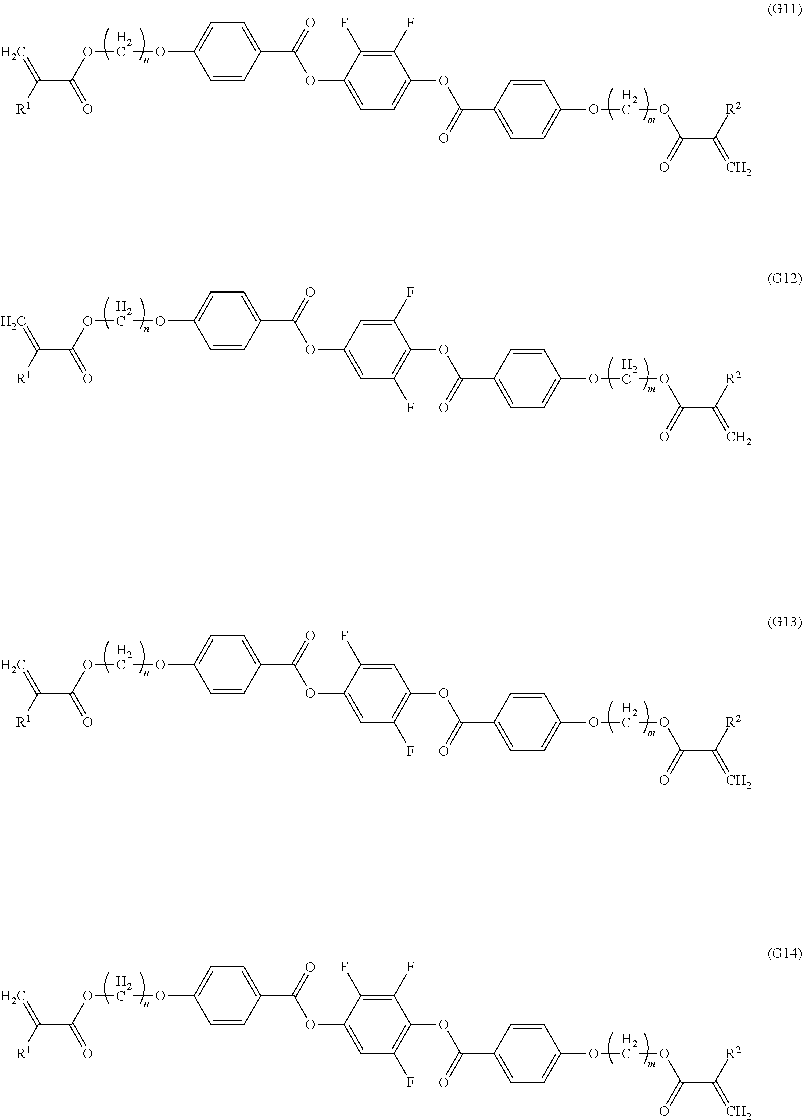
wherein n and m are individually an integer from 1 to 20, and
wherein R¹ and R² individually represent hydrogen or a methyl group.

6. The compound according to claim 5,
wherein R¹ and R² individually represent hydrogen.

7. The compound according to claim 5,
wherein n=m.

8. The compound according to claim 5,
wherein n=m, and
wherein R¹ and R² individually represent hydrogen.

9. A liquid crystal composition comprising:
the compound according to claim 1;
a nematic liquid crystal; and
a chiral material.

10. The liquid crystal composition according to claim 9,
wherein the liquid crystal composition exhibits a blue phase.

11. A liquid crystal element comprising the liquid crystal composition according to claim 9.

12. A liquid crystal display device comprising the liquid crystal composition according to claim 9.

13. A liquid crystal composition comprising:
a compound represented by General Formula (H1) given below;
a nematic liquid crystal; and
a chiral material, 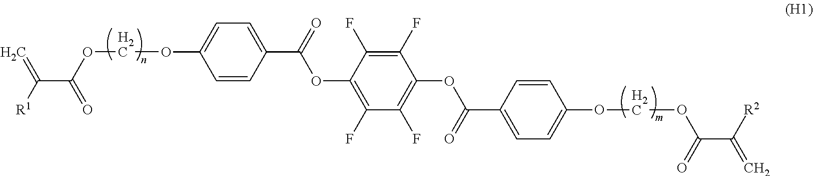
wherein n and m are individually an integer from 1 to 20, and
wherein R¹ and R² individually represent hydrogen or a methyl group.

14. The liquid crystal composition according to claim 13,
wherein R¹ and R² individually represent hydrogen.

15. The liquid crystal composition according to claim 13,
wherein n=m.

16. The liquid crystal composition according to claim 13,
wherein n=m, and
wherein R¹ and R² individually represent hydrogen.

17. The liquid crystal composition according to claim 13,
wherein the liquid crystal composition exhibits a blue phase.

18. A liquid crystal element comprising the liquid crystal composition according to claim 13.

19. A liquid crystal display device comprising the liquid crystal composition according to claim 13.
